(19) United States
(12) Patent Application Publication
(10) Pub. No.: US 2010/0330515 A1
(43) Pub. Date: Dec. 30, 2010

(54) GAS SHUTOFF DEVICE AND ALARM-COMPATIBLE SYSTEM METER

(75) Inventors: Kouichi Ueki, Nara (JP); Kazutaka Asano, Nara (JP); Tadanori Shirasawa, Nara (JP); Mitsuo Yokohata, Osaka (JP); Hirozumi Nakamura, Nara (JP); Kazuo Kubo, Hyogo (JP); Mitsuo Namba, Tokyo (JP); Hisashi Saito, Tokyo (JP)

Correspondence Address: Brinks Hofer Gilson & Lione/Panasonic, P.O. Box 10395, Chicago, IL, 60610, US

(73) Assignee: Panasonic Corporation, Kadoma-shi (JP)

(21) Appl. No.: 12/919,589

(22) PCT Filed: Feb. 24, 2009
(86) PCT No.: PCT/JP2009/000814

§ 371 Date: Aug. 26, 2010

(30) Foreign Application Priority Data
Feb. 26, 2008 (JP) 2008-044968
Feb. 26, 2008 (JP) 2008-044970
Feb. 26, 2008 (JP) 2008-044972
Feb. 26, 2008 (JP) 2008-44973
Feb. 26, 2008 (JP) 2008-044974

(51) Int. Cl. F23N 5/24; G08B 17/10

(52) U.S. Cl. 431/22; 340/632

(57) ABSTRACT

An object of the invention is to appropriately control the use limit function of an appliance according to the concentration level of CO gas. A gas shutoff device is made up of a flow rate registration unit 28 for registering as an appliance flow rate, an average flow rate found by classifying and storing in a flow rate storage unit 26 after flow rate detection, a CO gas leakage determination unit 29 for inputting an output signal responsive to the concentration level of CO gas from a CO alarm 20, an appliance estimation unit 30, when a signal is output by the CO gas leakage determination unit 29 and the flow rate is registered in the flow rate registration unit 28, for storing a flow rate pattern group stored in the flow rate storage unit 26 and the registered flow rate and estimating a CO gas leakage appliance, an appliance flow rate storage unit 31 for storing the flow rate pattern group, and a communication unit 35 for reporting appliance information.

### TECHNICAL FIELD

This invention relates to a gas shutoff device for controlling so as to limit use of a gas appliance at the CO occurring time using a CO alarm and a gas meter and in particular to a gas shutoff device for determining the CO gas leakage appliance according to an output signal from a CO alarm and securing safety.

The invention relates to a CO alarm and a gas shutoff device and relates to a gas shutoff device for determining a carbon monoxide gas leakage appliance according to an output signal from a CO alarm and securing safety.

The invention relates to a gas shutoff device for controlling so as to limit use of a gas appliance at the CO occurring time using a CO alarm and a gas meter and in particular to a gas shutoff device for determining the CO gas leakage appliance according to an output signal from a CO alarm and securing safety.

The invention relates to an alarm-compatible system meter for taking steps to prevent an accident as a gas meter for measuring a gas use flow rate and an emergency alarm installed indoors are in cooperation with each other.

### BACKGROUND ART

### First Conventional Example

In a first conventional example, a gas shutoff device of a configuration as shown in FIG. 27, for example, is known as a gas shutoff device for controlling so as to limit use of a gas appliance at the CO occurring time using a CO alarm and a gas meter (refer to patent document 1). The gas shutoff device of patent document 1 will be briefly discussed with FIG. 27.

Numeral 801 denotes an alarm and numeral 802 denotes a microcomputer gas meter; they are connected through a signal line. The microcomputer meter 802 is connected to an NCU 803 and is connected to a monitoring center not shown through a telephone line 804.

In the alarm 801, a methane gas sensor 811 detects methane. Numeral 805 denotes a CO sensor, which is a gas sensor for detecting CO. Numeral 806 denotes a CPU for detecting a signal of the methane gas sensor 811 or the CO sensor 805 as detection gas occurs. Sensor information is detected as a continuous gas concentration value. Numeral 807 denotes a sound LSI for providing notification of a sound for the surroundings through a loudspeaker 808 upon detection of a gas leakage situation. Numeral 809 denotes an LED for displaying and providing notification for the surroundings upon detection of a gas leakage situation. Numeral 810 denotes a power supply circuit and when initial power is applied to the alarm 801, the operation of the function described above is started.

Next, the operation of the configuration described above will be discussed. This kind of alarm 801 often is placed in a home kitchen. Generally, in town gas, methane gas of combustible gas may be detected and CO gas occurring at incomplete combustion time may be detected. In the methane gas sensor 811 or the CO sensor 805, using combustibility, combustible gas to be detected is burnt in the coil vicinity at a high temperature, whereby the sensor temperature rises and gas is detected due to resistance value change, etc. When gas is detected, the methane gas sensor 811 or the CO sensor 805 outputs gas detection to the CPU 806 and gas leakage is detected. When the alarm 801 detects occurrence of a gas leakage situation, it notifies neighboring persons of the gas leakage occurrence by display or a sound via the loudspeaker 808 through the sound LSI 807 or the LED 809.

When the alarm 801 detects gas, it sends information to the microcomputer meter 802 and further the microcomputer meter 802 informs the monitoring center through the NCU 803 via the telephone line 804. As in various documents, when the alarm 801 detects gas leakage and a signal is sent to the microcomputer meter 802, the microcomputer meter 802 stops gas supply and shuts off the gas passage. When the gas concentration rises, the alarm 801 transmits an alarm. When the gas concentration further rises, the alarm 801 transmits an alarm in response to a rise or a decline in the gas concentration at given intervals of 1.5 times, 2 times, 2.5 times, 3 times, etc.

### Second Conventional Example

In a second conventional example, an alarm-compatible system meter described in patent document 2, for example, is known as the alarm-compatible system meter. The configuration will be discussed with reference to FIG. 28.

As shown in FIG. 28, a gas meter 901 includes an integration display section 902, a measuring section 903, and a flow rate sensor 904. The integration display section 902 produces count display (integration display) of the flow rate of gas supplied from a gas vessel of a gas supply source (not shown) to a gas appliance (not shown). The integration display section 902 is connected to the flow rate sensor 904 through the measuring section 903.

The gas meter 901 includes a shutoff valve 905 for shutting off gas supply from the gas vessel to the gas appliance by closing a valve, a terminal block 907 to which a gas leakage alarm 906 is connected, and a terminal block 909 to which a transmission controller (NCU) 908 is connected.

The NCU 908 includes a modem (not shown) connected to a telephone line network through a telephone line for communicating with a management center at a remote location and an automatic switch (not shown) for switching connection of the telephone line between a subscriber telephone and the gas meter 901.

The gas meter 901 further includes a control circuit 910. The control circuit 910 is made up of a microcomputer (μCOM) 911 of a main control section, a battery 912 functioning as an operation power supply, an interface 913, etc. Here, numeral 914 denotes ROM of read-only memory storing a program, fixed-data, etc., numeral 915 denotes a central processing unit (CPU) for performing various processing computations in accordance with the program stored in the ROM 914, and numeral 916 denotes RAM of readable and writable memory having a work area used for processing in the CPU 915 and a data storage area for storing the processing computation result. A pulse output end of the flow rate sensor 904, a control end of the shutoff valve 905, the terminal blocks 907 and 909, etc., are connected to the interface 913.

In the configuration, the CPU 915 in the gas meter 901 performs measuring processing of detecting the flow rate of gas flowing from the gas vessel into the gas appliance, integrating the detected gas flow rates, and detecting the result as the gas use amount and gas leakage informing processing of controlling the NCU 908 and informing management center at a remote location of gas leakage when the gas leakage alarm 906 detects gas leakage.

Patent document 1: Japanese Patent Laid-Open No. 306463/1999

Patent document 2: Japanese Patent No. 3976624

### PROBLEMS TO BE SOLVED BY THE INVENTION

In the configuration of the first conventional example described above, however, if a gas appliance being used falls into an incomplete combustion state for some reason and the alarm detects carbon monoxide gas (hereinafter, described as CO gas) at an early stage, the microcomputer meter detects the flow rate in an ordinary appliance use state and the CO gas occurrence appliance cannot be determined and when the microcomputer meter stops gas supply, if a plurality of gas appliances are used, which appliance discharges CO gas cannot be known and consequently repair, patching of the appliance is delayed; particularly if a stove, a bath boiler, a water heater, etc., is used in a sealed room, since the CO gas is colorless, odorless, the user may be placed long in a state in which the life, etc., of the user is dangerous and there is a problem in safety.

In the configuration of the first conventional example described above, if the alarm detects gas leakage and the microcomputer meter 1 stops gas supply, the gas supply may be shut off when a state of considerably high gas concentration is entered; if a stove, etc., is used in a sealed room, the user may be placed long in a state in which the life, etc., of the user is dangerous and there is a problem in safety.

In the configuration of the second conventional example described above, gas is shut off according to information of gas leakage detection of the gas leakage alarm; however, there is a problem in that no steps are taken if no gas is used, for example, if CO gas occurs when an oil appliance is used, etc.

### SUMMARY OF THE INVENTION

To solve the problem in the first conventional example described above, it is an object of the invention to provide a gas shutoff device for operating based on a CO gas detection signal at a low concentration from a CO alarm and determining the use gas appliance at the CO gas occurrence time using a gas meter capable of determining the use appliance according to the flow rate data, whereby a measure of appliance repair, etc., can be taken at an early stage and the reliability and safety of the gas shutoff device are high.

To solve the problem in the first conventional example described above, it is another object of the invention to provide a highly reliable and highly safe gas shutoff device capable of determining a carbon monoxide occurrence appliance from carbon monoxide gas at a low concentration from an alarm and taking a measure of appliance repair, etc., at an early stage.

To solve the problem in the first conventional example described above, it is another object of the invention to provide a gas shutoff device for operating based on a CO detection signal at a low concentration from a CO alarm and determining the CO leakage appliance using a gas meter capable of determining the use appliance according to the flow rate data, whereby a measure of appliance repair, etc., can be taken at an early stage and the reliability and safety of the gas shutoff device are high.

To solve the problem in the first conventional example described above, it is another object of the invention to provide a highly safe gas shutoff device with no erroneous shutoff for receiving signals at multiple stages from low-concentration gas leakage to high-concentration gas leakage detection from an alarm and stopping gas supply at an early stage.

To solve the problem in the second conventional example described above, it is another object of the invention to provide an alarm-compatible system meter for monitoring a signal from a CO alarm including a communication unit and the presence or absence of gas use and determining whether CO occurrence is caused by a gas appliance or any other appliance than a gas appliance and notifying.

The invention provides a gas shutoff device for monitoring the use state of a gas appliance connected to piping after passing through a gas meter and limiting the use condition of the gas appliance in accordance with a signal from a CO alarm, wherein the gas meter includes a flow rate detection unit for measuring the gas flow rate, a flow rate computation unit for finding an instantaneous flow rate value from the detection value of the flow rate detection unit, a flow rate storage unit for storing the instantaneous flow rate values found by the flow rate computation unit in association with each other in time series as a flow rate pattern, an average flow rate computation unit for averaging the instantaneous flow rate values found by the flow rate computation unit to find an average flow rate value, a flow rate registration unit for registering the flow rate value when it is determined that the flow rate is the appliance flow rate from the average flow rate value found by the average flow rate computation unit, a CO gas leakage determination unit for making a determination in accordance with a detection signal from the CO alarm and outputting a determination signal responsive to the CO concentration level, an appliance estimation unit for reading the flow rate pattern in the flow rate storage unit, estimating a CO leakage appliance, and outputting a signal for setting the limit value of the continuously usable time in a shortening direction when the appliance flow rate is registered in the flow rate registration unit and the CO gas leakage determination unit outputs the determination signal, an appliance flow rate storage unit for storing the data in the flow rate storage unit read by the appliance estimation unit together with the appliance flow rate, an anomaly determination unit for changing the limit value of the continuously usable time of the appliance and determining whether or not an anomaly exists according to the signals from the flow rate registration unit, the appliance estimation unit, and the CO gas leakage determination unit, a shutoff unit for shutting off gas supply when an anomaly occurs, and a communication unit for reporting various pieces of appliance information, and wherein the gas shutoff device has a monitor mode of limiting the use condition of the appliance and monitoring and a shutoff mode of outputting a shutoff signal in an instant in response to the determination signal of the CO gas leakage determination unit.

In the gas shutoff device described above, when a CO gas leakage signal is first detected, unconditionally the appliance estimation unit executes the monitor mode and stores various pieces of data in the appliance flow rate storage unit.

In the gas shutoff device described above, the appliance estimation unit sets the limit value of the continuously usable time of the appliance in the shortening direction in response to the determination signal output as the CO concentration increases from a first-stage signal where the CO concentration is low to the maximum nth-stage signal where the CO concentration is high, output by the CO gas leakage determination unit.

In the gas shutoff device described above, when the maximum nth-stage determination signal where the CO concentration is high is output from the CO gas leakage determination unit, the appliance estimation unit outputs a signal for closing the shutoff unit through the anomaly determination unit.

In the gas shutoff device described above, if the CO leakage appliance repeats use and stop, the appliance estimation unit sets the limit value of the continuously usable time of the appliance in the shortening direction in response to the number of repetitions.

The invention provides a program for causing a computer to function as all or some of the units of the gas shutoff device described above.

The invention provides a gas shutoff device including a CO alarm for monitoring the presence or absence of carbon monoxide gas occurrence, a flow rate detection unit for measuring the gas flow rate, a flow rate computation unit for computing the flow rate value from the detection value of the flow rate detection unit, a flow rate storage unit for classifying the flow rates found by the flow rate computation unit and storing the flow rates, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a CO gas leakage determination unit for inputting an output signal responsive to the concentration level of carbon monoxide gas from the CO alarm, an appliance estimation unit for storing a signal output by the CO gas leakage determination unit, a flow rate pattern group stored in the flow rate storage unit when the flow rate is registered in the flow rate registration unit and the registered flow rate, and for outputting a signal for shortening and setting the use time limit time by estimating a CO gas leakage appliance, an appliance flow rate storage unit for storing, when said appliance estimation unit determines that the appliance is a CO leakage appliance, the output signal of said CO gas leakage determination unit and the flow rate pattern group stored in said flow rate storage unit when the flow rate is registered in said flow rate registration unit, an anomaly determination unit for monitoring an abnormal state of the use appliance and determining whether or not an anomaly exists according to the registered flow rate from the flow rate registration unit and the signal from the CO gas leakage determination unit, a shutoff unit for shutting off gas supply when the anomaly determination unit determines that an anomaly exists, and a communication unit for reporting appliance information if the appliance estimation unit determines the CO leakage appliance.

The invention provides a gas shutoff device including a CO alarm for monitoring the presence or absence of carbon monoxide gas occurrence, a flow rate detection unit for measuring the gas flow rate, a flow rate computation unit for computing the flow rate value from the detection value of the flow rate detection unit, a flow rate storage unit for classifying the flow rates found by the flow rate computation unit and storing the flow rates, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a CO gas leakage determination unit for inputting an output signal responsive to the concentration level of carbon monoxide gas from the CO alarm, an appliance estimation unit for storing a signal output by the CO gas leakage determination unit, a flow rate pattern group stored in the flow rate storage unit when the flow rate is registered in the flow rate registration unit and the registered flow rate, and for outputting a signal for shortening and setting the use time limit time by estimating a CO gas leakage appliance, an occurrence frequency measurement unit for measuring the occurrence frequency of a flow rate data group corresponding to the appliance estimated by the appliance estimation unit, determining the CO gas leakage appliance, and outputting, an appliance flow rate storage unit for storing, when said appliance estimation unit determines that the appliance is a CO leakage appliance, the output signal of said CO gas leakage determination unit and the flow rate pattern group stored in said flow rate storage unit when the flow rate is registered in said flow rate registration unit, an anomaly determination unit for monitoring an abnormal state of the use appliance and determining whether or not an anomaly exists according to the registered flow rate from the flow rate registration unit and the signal from the CO gas leakage determination unit, a shutoff unit for shutting off gas supply when the anomaly determination unit determines that an anomaly exists, and a communication unit for reporting appliance information if the appliance estimation unit determines the CO leakage appliance.

The invention provides a program for causing a computer to function as all or some of the units of the gas shutoff device described above.

The invention provides a gas shutoff device including a CO alarm for monitoring the presence or absence of carbon monoxide gas occurrence, a flow rate detection unit for measuring the gas flow rate, a flow rate computation unit for computing the flow rate value from the detection value of the flow rate detection unit, a flow rate storage unit for classifying the flow rates found by the flow rate computation unit and storing the flow rates, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, an anomaly determination unit for monitoring the use time of the flow rate registered in the flow rate registration unit and the total flow rate, a CO gas leakage determination unit for inputting an output signal responsive to the concentration level of carbon monoxide gas from the CO alarm, an appliance estimation unit for storing a signal output by the CO gas leakage determination unit, a flow rate pattern group stored in the flow rate storage unit when the flow rate is registered in the flow rate registration unit and the registered flow rate, and for outputting a signal for shortening and setting the use time limit time by estimating a CO gas leakage appliance, an appliance flow rate storage unit for storing, when said appliance estimation unit determines that the appliance is a CO leakage appliance, the output signal of said CO gas leakage determination unit and the flow rate pattern group stored in said flow rate storage unit when the flow rate is registered in said flow rate registration unit, a CO anomaly determination unit for monitoring an abnormal state of the use appliance and determining whether or not an anomaly exists according to the registered flow rate from the flow rate registration unit and the signal from the CO gas leakage determination unit concurrently with the anomaly determination unit, a shutoff unit for shutting off gas supply when the anomaly determination unit or the CO anomaly determination unit determines that an anomaly exists, and a communication unit for reporting appliance information if the appliance estimation unit determines the CO leakage appliance.

The invention provides a program for causing a computer to function as all or some of the units of the gas shutoff device described above.

The invention provides a gas shutoff device for monitoring the use state of a gas appliance connected to piping after passing through a gas meter and limiting the use condition of the gas appliance in accordance with a signal from a CO alarm, the gas shutoff device including a flow rate detection unit for measuring the gas flow rate, a flow rate computation unit for finding an instantaneous flow rate value from the detection value of the flow rate detection unit, a flow rate storage unit for storing the instantaneous flow rate values found by the flow rate computation unit in association with each other in time series as a flow rate pattern, an average flow rate computation unit for averaging the instantaneous flow rate values found by the flow rate computation unit to find an average flow rate value, a flow rate registration unit for registering the flow rate value when it is determined that the flow rate is the appliance flow rate from the average flow rate value found by the average flow rate computation unit, a CO gas leakage determination unit for making a determination in accordance with a detection signal from the CO alarm and outputting a determination signal responsive to the CO concentration level, an appliance estimation unit for reading the flow rate pattern in the flow rate storage unit, estimating a CO leakage appliance, and outputting a signal for setting the limit value of the continuously usable time in a shortening direction when the appliance flow rate is registered in the flow rate registration unit and the CO gas leakage determination unit outputs the determination signal, an occurrence frequency measurement unit for counting the number of estimation processing times of a CO leakage appliance executed when a CO gas leakage determination signal is output, and issuing a command for executing estimation processing of a CO leakage appliance using a flow rate pattern regardless of whether or not the CO gas leakage determination signal exists when the number of estimation processing times exceeds a predetermined number of times, an appliance flow rate storage unit for storing the data in the flow rate storage unit read by the appliance estimation unit together with the appliance flow rate, an anomaly determination unit for changing the limit value of the continuously usable time of the appliance and determining whether or not an anomaly exists according to the signals from the flow rate registration unit, the appliance estimation unit, and the CO gas leakage determination unit, a shutoff unit for shutting off gas supply when an anomaly occurs, and a communication unit for reporting various pieces of appliance information, the gas shutoff device for changing a condition when the CO leakage appliance is determined in response to the presence or absence of a signal from the occurrence frequency measurement unit; executing estimating processing of a CO leakage appliance in response to the determination signal of the CO gas leakage determination unit when a signal from the occurrence frequency measurement unit does not exist; executing estimating processing of a CO leakage appliance regardless of the determination signal of the CO gas leakage determination unit when a signal from the occurrence frequency measurement unit exists; and when the CO leakage appliance is determined, executing a monitor mode of limiting the use condition of the appliance and monitoring.

In the gas shutoff device described above, the appliance estimation unit executes the monitor mode unconditionally when a CO gas leakage signal is first detected, and stores various pieces of data in the appliance flow rate storage unit.

In the gas shutoff device described above, from a first-stage signal where the CO concentration is low to the maximum nth-stage signal where the CO concentration is high, output by the CO gas leakage determination unit, the appliance estimation unit sets the limit value of the continuously usable time of the appliance in the shortening direction in response to the determination signal output as the CO concentration increases.

In the gas shutoff device described above, when the maximum nth-stage determination signal where the CO concentration is high is output from the CO gas leakage determination unit, the appliance estimation unit outputs a signal for closing the shutoff unit through the anomaly determination unit.

In the gas shutoff device described above, if the CO leakage appliance repeats use and stop, the appliance estimation unit sets the limit value of the continuously usable time of the appliance in the shortening direction in response to the number of repetitions.

The invention provides a program for causing a computer to function as all or some of the units of the gas shutoff device as claimed in any one of claims 12 to 16.

The invention provides a gas shutoff device connected to an alarm for monitoring the presence or absence of gas leakage, the gas shutoff device for monitoring the use state of more than one gas appliance and shutting off gas supply when an anomaly occurs, the gas shutoff device including a flow rate detection unit for measuring the gas flow rate, a flow rate computation unit for computing the flow rate value from the detection value of the flow rate detection unit, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a gas leakage determination unit for inputting an output signal responsive to the concentration level of gas leakage from the alarm, an anomaly determination unit for monitoring an abnormal state of the use appliance and determining whether or not an anomaly exists according to the flow rate from the average computation unit, the registered flow rate from the flow rate registration unit and the signal from the gas leakage determination unit, a use time adjustment unit, upon reception of an alarm signal responsive to the concentration from the alarm, for changing the use time limit time corresponding to the registered flow rate and outputting to the anomaly determination unit for monitoring, and a shutoff unit for shutting off gas supply when the anomaly determination unit determines that an anomaly exists.

The invention provides a gas shutoff device connected to an alarm for monitoring the presence or absence of gas leakage and transmitting a signal through wireless transmission unit, the gas shutoff device for monitoring the use state of more than one gas appliance and shutting off gas supply when an anomaly occurs, the gas shutoff device including a flow rate detection unit for measuring the gas flow rate, a flow rate computation unit for computing the flow rate value from the detection value of the flow rate detection unit, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a gas leakage determination unit for inputting an output signal responsive to the concentration level of gas leakage from the alarm, an anomaly determination unit for monitoring an abnormal state of the use appliance and determining whether or not an anomaly exists according to the flow rate from the average computation unit, the registered flow rate from the flow rate registration unit and the signal from the gas leakage determination unit, a wireless unit for receiving the alarm signal from the alarm, a use time adjustment unit, upon reception of the alarm signal responsive to the concentration from the alarm through the wireless unit, for changing the use time limit time corresponding to the registered flow rate and outputting to the anomaly determination unit for monitoring, and a shutoff unit for shutting off gas supply when the anomaly determination unit determines that an anomaly exists.

The invention provides a gas supply system using the gas shutoff device described above.

The invention provides an alarm-compatible system meter including a communication unit for conducting information communications with at least any one or more alarms of a fire alarm, a gas alarm, and a CO alarm, a gas meter including an external communication unit capable of communicating with an external system, an identification unit for identifying a signal of the alarm, and a measure selection unit for selecting a measure by the gas meter in response to the identification result from the identification unit, characterized in that upon reception of a signal from the CO alarm, the measure selection unit determines the presence or absence of gas use amount and when no gas is used, outputs to the external communication unit for communicating with the external system.

In the alarm-compatible system meter described above, upon reception of the signal from the CO alarm, the measure selection unit determines the presence or absence of gas use amount and when no gas is used, outputs a signal for displaying CO occurrence on a customer display.

In the alarm-compatible system meter described above, upon reception of the signal from the CO alarm, the measure selection unit determines the presence or absence of gas use amount and when no gas is used, outputs a signal for producing a special notification sound different from an alarm at the anomaly detecting time to at least any one or more alarms of the fire alarm, the gas alarm, and the CO alarm.

In the alarm-compatible system meter described above, the measure selection unit outputs installation location information of the alarm contained in the identification result from the identification unit to the external system when a measure is taken.

In the alarm-compatible system meter described above, the measure selection unit outputs a signal for displaying the installation location information of the alarm contained in the identification result from the identification unit on the customer display when a measure is taken.

In the alarm-compatible system meter described above, the measure selection unit adds appliance installation location information from an appliance including a communication unit to a signal to be output when a measure is taken, and outputs.

The invention provides a program for causing a computer to function as all or some of the alarm-compatible system meter described above.

### ADVANTAGES OF THE INVENTION

The gas shutoff device of the invention calculates the instantaneous flow rate by the flow rate computation unit when use of an appliance is started, classifies the instantaneous flow rate in the flow rate storage unit in sequence as an appliance flow rate pattern and gives the appliance number, etc., for storage, and on the other hand, finds the average flow rate by the average flow rate computation unit to monitor total flow rate shutoff, increment flow rate shutoff, use time shutoff, or the like, and monitors by the anomaly determination unit, wherein the flow rate is registered in the flow rate registration unit as the flow rate for appliance monitor and the CO alarm detects CO gas leakage during monitoring and the CO gas leakage determination unit determines CO gas leakage in a low concentration state and outputs an alarm signal to the appliance estimation unit, which then assumes that an appliance involving the possibility of CO gas leakage is used and stores the flow rate pattern in the flow rate storage unit and the registered flow rate in the flow rate registration unit in the appliance flow rate storage unit as an appliance flow rate data group and if the appliance is reused, estimates the appliance flow rate with the appliance flow rate data group in the appliance flow rate storage unit and upon input of a CO gas leakage appliance estimation signal from the appliance estimation unit, the anomaly determination unit limits and sets to the drastically shortened monitor time preferentially rather than the use time in the corresponding flow rate class of the registered flow rate and monitors use and information is reported to the monitor center together with information of the appliance number, etc., and later, if some measure against the gas leakage is delayed and the customer uses the appliance, the appliance estimation unit collates with the previous flow rate pattern group and if it is a predetermined flow rate pattern and falls within a predetermined correlation coefficient, assumes that the leakage appliance is used; the use time is limited from the stage of an alarm signal of an extremely minute amount and whenever the appliance is used, the use time is limited and thus the gas supply is shut off in an extremely minute amount of CO gas leakage and in a short time, so that the danger for the user is extremely low and an alarm is reported to the gas company, which then can take an emergency measure and the safety is high.

The gas shutoff device of the invention calculates the instantaneous flow rate by the flow rate computation unit when use of an appliance is started, classifies the instantaneous flow rate in the flow rate storage unit in sequence as an appliance flow rate pattern and gives the appliance number, etc., for storage, and on the other hand, finds the average flow rate by the average flow rate computation unit to monitor total flow rate shutoff, increment flow rate shutoff, use time shutoff, or the like, and monitors the registered maximum flow rate by the anomaly determination unit, wherein the CO alarm detects CO gas leakage during monitoring and the CO gas leakage determination unit determines CO gas leakage in a low concentration state and outputs an alarm signal to the appliance estimation unit, which then assumes that an appliance involving the possibility of CO gas leakage is used and stores the flow rate pattern in the flow rate storage unit and the registered flow rate in the flow rate registration unit in the appliance flow rate storage unit as an appliance flow rate data group and if the appliance is reused, estimates the appliance flow rate with the appliance flow rate data group in the appliance flow rate storage unit and upon input of a CO gas leakage appliance estimation signal from the appliance estimation unit, concurrently with the monitoring of the anomaly determination unit, the CO anomaly determination unit limits and sets to the drastically shortened monitor time preferentially rather than the use time in the corresponding flow rate class of the registered flow rate and monitors use and information is reported to the monitor center together with information of the appliance number, etc., and later, if some measure against the gas leakage is delayed and the customer uses the appliance, the appliance estimation unit collates with the previous flow rate pattern group and if it is a predetermined flow rate pattern and falls within a predetermined correlation coefficient, assumes that the leakage appliance is used; the use time is limited from the stage of an alarm signal of an extremely minute amount and whenever the appliance is used, the use time is limited and thus the gas supply is shut off in an extremely minute amount of CO gas leakage and in a short time, so that the danger for the user is extremely low and an alarm is reported to the gas company, which then can take an emergency measure and the safety is high.

The gas shutoff device of the invention finds the instantaneous flow rate by the flow rate computation unit when use of an appliance is started, and stores the flow rates in the flow rate storage unit as a flow rate pattern in association with each other in time series and on the other hand, finds the average flow rate by the average flow rate computation unit, registers it in the flow rate registration unit as the flow rate for appliance monitor, and monitors the magnitude of the flow rate, the length of the use time, etc., by the anomaly determination unit, wherein when an appliance enters an incomplete combustion state for some reason during the monitoring and the CO alarm detects CO gas leakage and the CO gas leakage determination unit determines CO alarm signal in a low concentration state, assuming that the appliance involves the possibility of CO gas leakage, the flow rate pattern in the flow rate storage unit and the registered flow rate in the flow rate registration unit are input as a data group to the appliance estimation unit, which then makes an estimation as to whether or not the appliance is an appliance of a flow rate pattern steadily causing CO gas leakage from the past flow rate pattern stored in the appliance flow rate storage unit and the registered flow rate and if the appliance is determined the CO leakage appliance, the limit value of the continuous use time is again set in the shortening direction through the anomaly determination unit and the monitor mode is executed. At the same time, the occurrence frequency measurement unit counts the match frequency between the appliance of the flow rate pattern and the registered flow rate determined CO gas leakage by the appliance estimation mean and CO gas leakage and when the count becomes a predetermined number of times or more, if no signal from the CO gas leakage determination unit exists, the appliance estimation unit executes CO leakage appliance estimation appliance using the flow rate pattern and if the appliance is determined the CO leakage appliance, the limit value of the continuous use time is again set in the shortening direction through the anomaly determination unit and the monitor mode is executed and the fact is reported to the monitor center. Then, if the appliance is used without taking any means against the CO gas leakage, the appliance estimation mean collates with the previous flow rate pattern group and if it falls within a predetermined correlation coefficient, when the flow rate is registered in the flow rate registration unit, in the anomaly determination unit, the use time is limited to a short use time, whereby the use time is limited from the stage of a CO alarm signal of an extremely minute amount and whenever the appliance is used, the use time is limited and thus the gas supply is shut off in an extremely minute amount of CO gas leakage and in a short time, so that the danger for the user is extremely low and appliance information is reported as an alarm to the gas company, which then can easily determine the abnormal appliance and can take a measure as soon as possible.

In the gas shutoff device of the invention, when an alarm detects gas leakage while an appliance is being used and it is detected that the gas leakage determination unit sends an alarm signal, the appliance is being used and when the flow rate detected by the flow rate detection unit is averaged by the average flow rate computation unit and is registered in the flow rate registration unit as the appliance flow rate and is monitored, if an initial-stage signal at a very low concentration is sent, the use time is monitored in the corresponding flow rate class of the registered flow rate in the anomaly determination unit; the use time is changed in the shortening direction of the use time by the use time adjustment unit, monitor is again executed, and the fact is reported to the monitor center, etc., and further when a high-concentration signal is next sent, the use time is further shortened and upon further reception of a high-concentration signal, the gas supply is shut off, whereby the use time is limited from an extremely minute amount stage and as the concentration increases, further the use time is limited, whereby an alarm is reported and on the other hand the use time of the appliance is limited without impairing the usability of the use, so that the number of unnecessary mobilization of times of the gas company is prevented from increasing or an appliance to be essentially used for a long time, such as a heater, is prevented from being used for a long time although the concentration increases, degradation of the usability can be prevented, and the safety is high.

Upon reception of an anomaly detection signal from the CO alarm, the alarm-compatible system meter of the invention determines whether or not the use amount of gas occurs and if the use amount of gas occurs, the alarm-compatible system meter determines that a gas appliance is used, and shuts off the gas supply by a shutoff valve; if the use amount of gas does not occur, the alarm-compatible system meter determines that an appliance with a fuel other than gas, for example, an appliance with oil as a fuel is used, and reports CO occurrence information to the external system through the external communication unit, so that a CO occurrence anomaly of an appliance involving combustion regardless of the fuel can be detected and is reported to the external system and a person staying in the home using the communication function of the CO alarm and the gas meter, whereby a rapid measure can be taken, so that a serious accident cab be prevented and safety can be enhanced.

### BRIEF DESCRIPTION OF THE DRAWINGS

FIG. 1 is a drawing to show an installation mode of a gas shutoff device and gas appliances in Embodiment 1.

FIG. 2 is a control block diagram of the gas shutoff device in Embodiment 1.

FIG. 3 is a control block diagram of a gas shutoff device in Embodiment 2.

FIG. 4 is a drawing to show an installation mode of a gas shutoff device and gas appliances in Embodiment 3.

FIG. 5 is a control block diagram of the gas shutoff device in Embodiment 3.

FIG. 6 is a control block diagram of a gas shutoff device in Embodiment 4.

FIG. 7 is a drawing to show an installation mode of a gas shutoff device and gas appliances in Embodiment 5.

FIG. 8 is a control block diagram of the gas shutoff device in Embodiment 5.

FIG. 9 is a drawing to show an installation mode of a gas shutoff device and gas appliances in Embodiment 6.

FIG. 10 is a control block diagram of the gas shutoff device in Embodiment 6.

FIG. 11 is a control block diagram of a gas shutoff device in Embodiment 7.

FIG. 12 is a configuration drawing of an alarm-compatible system meter in Embodiment 8.

FIG. 13 is a block diagram of the alarm-compatible system meter in Embodiment 8.

FIG. 14 is a block diagram of a CO alarm.

FIG. 15 is a flowchart to show determination processing at the CO occurrence time, of the alarm-compatible system meter in Embodiment 8.

FIG. 16 is a flowchart to show determination processing at the CO occurrence time, of an alarm-compatible system meter in Embodiment 9.

FIG. 17 is a flowchart to show determination processing at the CO occurrence time, of an alarm-compatible system meter in Embodiment 10.

FIG. 18 is a flowchart to show determination processing at the CO occurrence time, of an alarm-compatible system meter in Embodiment 11.

FIG. 19 is an installation location information configuration drawing of alarms for communicating at the operation time of each alarm.

FIG. 20 is a flowchart to show determination processing at the CO occurrence time, of an alarm-compatible system meter in Embodiment 12.

FIG. 21 is a flowchart to show determination processing at the CO occurrence time, of an alarm-compatible system meter in Embodiment 13.

FIG. 22 is block diagrams of a gas appliance including a communication unit and an appliance including a communication unit other than a gas appliance.

FIG. 23 is an installation location information configuration drawing of appliances for communicating with the alarm-compatible system meter.

FIG. 24 is a drawing to show an installation mode of a gas shutoff device and gas appliances in Embodiment 14.

FIG. 25 is a control block diagram of the gas shutoff device in Embodiment 14.

FIG. 26 is a control block diagram of a gas shutoff device in Embodiment 15.

FIG. 27 is a control block diagram of a gas shutoff device in a first conventional example.

FIG. 28 is a control block diagram of an alarm-compatible system meter in a second conventional example.

### DESCRIPTION OF REFERENCE NUMERALS

20, 120, 220, 320, CO alarm
24, 124, 224, 324, 524 Flow rate detection unit
25, 125, 225, 325, 525 Flow rate computation unit
26, 126, 226, 326 Flow rate storage unit
27, 127, 227, 327, 526 Average flow rate computation unit
28, 128, 228, 328, 527 Flow rate registration unit
29, 129, 229, 329, CO gas leakage determination unit
30, 130, 230, 330, Appliance estimation unit
31, 131, 231, 331, Appliance flow rate storage unit
32, 132, 232, 332, 529 Anomaly determination unit
34, 134, 234, 334, 530 Shutoff unit
36, 136, 236, 336, CO occurrence frequency measurement unit
235, 420, 423, 426, 429, 437, 439, 531 Communication unit
417 Flow path
418 Ultrasonic flow rate measurement unit
419 Shutoff valve
421 Gas meter
422, 425, 428 Notification unit
424 Fire alarm
427 Gas alarm
430 CO alarm
431 Identification unit
432 Measure selection unit
433 Gas appliance
434 Appliance other than gas appliance
438 Customer display
440 External communication unit
511 Gas supply pipe
512 Gas shutoff device
513 Gas piping
514 Gas water heater
515 Hot water tap
516 Bath
517 Floor heating
518 Gas table
519 Gas heater with fan for combustion air and circulating
520 Alarm
521 Gas sensor
522 Amplification unit
523 CPU
528 Gas leakage determination unit
532 Use time adjustment unit
533 Wireless transmission unit
534 Wireless communication unit

### DETAILED DESCRIPTION OF THE PREFERRED EMBODIMENTS

Embodiments of the invention will be discussed below with reference to the accompanying drawings:

According to a first aspect of the invention, a gas shutoff device for monitoring the use state of a gas appliance connected to piping after passing through a gas meter and limiting the use condition of the gas appliance in accordance with a signal from a CO alarm, wherein the gas meter includes a flow rate detection unit for measuring the gas flow rate, a flow rate computation unit for finding an instantaneous flow rate value from the detection value of the flow rate detection unit, a flow rate storage unit for storing the instantaneous flow rate values found by the flow rate computation unit in association with each other in time series as a flow rate pattern, an average flow rate computation unit for averaging the instantaneous flow rate values found by the flow rate computation unit to find an average flow rate value, a flow rate registration unit for registering the flow rate value when it is determined that the flow rate is the appliance flow rate from the average flow rate value found by the average flow rate computation unit, a CO gas leakage determination unit for making a determination in accordance with a detection signal from the CO alarm and outputting a determination signal responsive to the CO concentration level, an appliance estimation unit for reading the flow rate pattern in the flow rate storage unit, estimating a CO leakage appliance, and outputting a signal for setting the limit value of the continuously usable time in a shortening direction when the appliance flow rate is registered in the flow rate registration unit and the CO gas leakage determination unit outputs the determination signal, an appliance flow rate storage unit for storing the data in the flow rate storage unit read by the appliance estimation unit together with the appliance flow rate, an anomaly determination unit for changing the limit value of the continuously usable time of the appliance and determining whether or not an anomaly exists according to the signals from the flow rate registration unit, the appliance estimation unit, and the CO gas leakage determination unit, a shutoff unit for shutting off gas supply when an anomaly occurs, and a communication unit for reporting various pieces of appliance information, and wherein the gas shutoff device has a monitor mode of limiting the use condition of the appliance and monitoring and a shutoff mode of outputting a shutoff signal in an instant in response to the determination signal of the CO gas leakage determination unit.

When use of an appliance is started, the instantaneous flow rate is found by the flow rate computation unit and is input in sequence to the flow rate storage unit and is stored as a flow rate pattern in association with each other in time series and on the other hand, the average flow rate is found by the average flow rate computation unit and is registered in the flow rate registration unit as the flow rate for appliance monitor, and the flow rate, the length of the use time, etc., is monitored by the anomaly determination unit, wherein when an appliance enters an incomplete combustion state for some reason during the monitoring and the CO alarm detects CO gas leakage and the CO gas leakage determination unit determines alarm signal in a low concentration state, assuming that the appliance involves the possibility of CO gas leakage, from the flow rate pattern in the flow rate storage unit and the registered flow rate in the flow rate registration unit, the appliance estimation unit makes an estimation as to whether or not the appliance is an appliance of a flow rate pattern steadily causing CO gas leakage from the past flow rate pattern stored in the appliance flow rate storage unit and the registered flow rate and stores in the appliance flow rate storage unit, and the use time is monitored in the corresponding flow rate class of the registered flow rate in the anomaly determination unit; when the flow rate pattern group estimated to be the CO leakage target appliance is input to the appliance estimation unit, the monitored use time is shortened, the remaining time is changed to a short time, monitoring is again performed, the fact is reported to the monitor center, and then if the appliance is used without taking any means against the CO gas leakage, the appliance estimation mean collates with the previous flow rate pattern group and if it falls within a predetermined correlation coefficient, for example, when the flow rate is registered in the flow rate registration unit, in the anomaly determination unit, the use time is limited to a short use time, whereby the use time is limited from the stage of a CO gas alarm signal of an extremely minute amount and whenever the appliance is used, the use time is limited and thus the gas supply is shut off in an extremely minute amount of CO gas leakage and in a short time, so that the danger for the user is extremely low and appliance information is reported as an alarm to the gas company, which then can easily determine the abnormal appliance and can take a measure as soon as possible.

According to a second aspect of the invention, in the gas shutoff device described above, when a CO gas leakage signal is first detected, unconditionally the appliance estimation unit executes the monitor mode and stores various pieces of data in the appliance flow rate storage unit.

According to a third aspect of the invention, in the gas shutoff device described above, the appliance estimation unit sets the limit value of the continuously usable time of the appliance in the shortening direction in response to the determination signal output as the CO concentration increases from a first-stage signal where the CO concentration is low to the maximum nth-stage signal where the CO concentration is high, output by the CO gas leakage determination unit.

According to a fourth aspect of the invention, in the gas shutoff device described above, when the maximum nth-stage determination signal where the CO concentration is high is output from the CO gas leakage determination unit, the appliance estimation unit outputs a signal for closing the shutoff unit through the anomaly determination unit.

According to a fifth aspect of the invention, in the gas shutoff device described above, if the CO leakage appliance repeats use and stop, the appliance estimation unit sets the limit value of the continuously usable time of the appliance in the shortening direction in response to the number of repetitions.

According to a sixth aspect of the invention, a gas shutoff device including a CO alarm for monitoring the presence or absence of carbon monoxide gas occurrence, a flow rate detection unit for measuring the gas flow rate, a flow rate computation unit for computing the flow rate value from the detection value of the flow rate detection unit, a flow rate storage unit for classifying the flow rates found by the flow rate computation unit and storing the flow rates, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a CO gas leakage determination unit for inputting an output signal responsive to the concentration level of carbon monoxide gas from the CO alarm, an appliance estimation unit for storing a signal output by the CO gas leakage determination unit for storing a flow rate pattern group stored in the flow rate storage unit when the flow rate is registered in the flow rate registration unit and the registered flow rate and for estimating a CO gas leakage appliance, an appliance flow rate storage unit for storing the output signal of the CO gas leakage determination unit when the appliance estimation unit determines that the appliance is a CO gas leakage appliance and the flow rate pattern group stored in the flow rate storage unit when the flow rate is registered in the flow rate registration unit, an anomaly determination unit for monitoring an abnormal state of the use appliance and determining whether or not an anomaly exists according to the registered flow rate from the flow rate registration unit and the signal from the CO gas leakage determination unit, a use time adjustment unit, upon reception of an alarm signal responsive to the concentration from the CO alarm, for changing the use time limit time corresponding to the registered flow rate and outputting to the anomaly determination unit for monitoring, a shutoff unit for shutting off gas supply when the anomaly determination unit determines that an anomaly exists, and a communication unit for reporting appliance information if the appliance estimation unit determines the CO leakage appliance.

When use of an appliance is started, the instantaneous flow rate is found by the flow rate computation unit and is stored in sequence in the flow rate storage unit and on the other hand, the average flow rate is found by the average flow rate computation unit and is registered in the flow rate registration unit as the flow rate for appliance monitor, and the flow rate, the length of the use time, etc., is monitored by the anomaly determination unit, wherein when an appliance enters an incomplete combustion state for some reason during the monitoring and the CO alarm detects CO gas leakage and the CO gas leakage determination unit determines alarm signal in a low concentration state, assuming that the appliance involves the possibility of CO gas leakage, from the flow rate pattern in the flow rate storage unit and the registered flow rate in the flow rate registration unit, the appliance estimation unit makes an estimation as to whether or not the appliance is an appliance of a flow rate pattern steadily causing CO gas leakage from the past flow rate pattern stored in the appliance flow rate storage unit and the registered flow rate and stores in the appliance flow rate storage unit, and the use time is monitored in the corresponding flow rate class of the registered flow rate in the anomaly determination unit; when the flow rate pattern group estimated to be the CO leakage target appliance is input to the appliance estimation unit, the monitored use time is shortened, the remaining time is changed to a short time, monitoring is again performed, the fact is reported to the monitor center, and then if the appliance is used without taking any means against the CO gas leakage, the appliance estimation mean collates with the previous flow rate pattern group and if it falls within a predetermined correlation coefficient, for example, when the flow rate is registered in the flow rate registration unit, in the anomaly determination unit, the use time is limited to a short use time, whereby the use time is limited from the stage of a CO gas alarm signal of an extremely minute amount and whenever the appliance is used, the use time is limited and thus the gas supply is shut off in an extremely minute amount of CO gas leakage and in a short time, so that the danger for the user is extremely low and appliance information is reported as an alarm to the gas company, which then can easily determine the abnormal appliance and can take a measure as soon as possible.

According to a seventh aspect of the invention, a gas shutoff device includes a CO alarm for monitoring the presence or absence of carbon monoxide gas occurrence, a flow rate detection unit for measuring the gas flow rate, a flow rate computation unit for computing the flow rate value from the detection value of the flow rate detection unit, a flow rate storage unit for storing the flow rates found by the flow rate computation unit, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a CO gas leakage determination unit for inputting an output signal responsive to the concentration level of carbon monoxide gas from the CO alarm, an appliance estimation unit for storing a signal output by the CO gas leakage determination unit, a flow rate pattern group stored in the flow rate storage unit when the flow rate is registered in the flow rate registration unit and the registered flow rate, estimating a CO gas leakage appliance, and outputting a signal for shortening and setting the use time limit time, an occurrence frequency measurement unit for measuring the occurrence frequency of a flow rate data group corresponding to the appliance estimated by the appliance estimation unit, determining the CO gas leakage appliance, and outputting, an appliance flow rate storage unit for storing the output signal of the CO gas leakage determination unit when the appliance estimation unit determines that the appliance is a CO gas leakage appliance and the flow rate pattern group stored in the flow rate storage unit when the flow rate is registered in the flow rate registration unit, an anomaly determination unit for monitoring an abnormal state of the use appliance and determining whether or not an anomaly exists according to the registered flow rate from the flow rate registration unit and the signal from the CO gas leakage determination unit, a shutoff unit for shutting off gas supply when the anomaly determination unit determines that an anomaly exists, and a communication unit for reporting appliance information if the appliance estimation unit determines the CO leakage appliance.

When use of an appliance is started, the instantaneous flow rate is found by the flow rate computation unit and is stored in sequence in the flow rate storage unit and on the other hand, the average flow rate is found by the average flow rate computation unit and is registered in the flow rate registration unit as the flow rate for appliance monitor, and the flow rate, the length of the use time, etc., is monitored by the anomaly determination unit, wherein when an appliance enters an incomplete combustion state for some reason during the monitoring and the CO alarm detects CO gas leakage and the CO gas leakage determination unit determines CO alarm signal in a low concentration state, assuming that the appliance involves the possibility of CO gas leakage, from the flow rate pattern in the flow rate storage unit and the registered flow rate in the flow rate registration unit, the appliance estimation unit makes an estimation as to whether or not the appliance is an appliance of a flow rate pattern steadily causing CO gas leakage from the past flow rate pattern stored in the appliance flow rate storage unit and the registered flow rate, the occurrence frequency measurement unit counts the match frequency between the appliance of the flow rate pattern and the registered flow rate determined CO gas leakage by the appliance estimation mean and CO gas leakage and when the count becomes a predetermined number of times or more, if no signal from the CO gas leakage determination unit exists, the use time is monitored in the corresponding flow rate class of the registered flow rate in the anomaly determination unit; the use time is shortened, the remaining time is changed to a short time, monitoring is again performed, the fact is reported to the monitor center, and then if the appliance is used without taking any means against the CO gas leakage, the appliance estimation mean collates with the previous flow rate pattern group and if it falls within a predetermined correlation coefficient, when the flow rate is registered in the flow rate registration unit, in the anomaly determination unit, the use time is limited to a short use time, whereby the use time is limited from the stage of a CO gas alarm signal of an extremely minute amount and whenever the appliance is used, the use time is limited and thus the gas supply is shut off in an extremely minute amount of CO gas leakage and in a short time, so that the danger for the user is extremely low and appliance information is reported as an alarm to the gas company, which then can easily determine the abnormal appliance and can take a measure as soon as possible.

According to an eighth aspect of the invention, a gas shutoff device includes a CO alarm for monitoring the presence or absence of carbon monoxide gas occurrence, flow rate detection unit for measuring the gas flow rate, a flow rate computation unit for computing the flow rate value from the detection value of the flow rate detection unit, a flow rate storage unit for classifying the flow rates found by the flow rate computation unit and storing the flow rates, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, an anomaly determination unit for monitoring the use time of the flow rate registered in the flow rate registration unit and the total flow rate, a CO gas leakage determination unit for inputting an output signal responsive to the concentration level of carbon monoxide gas from the CO alarm, an appliance estimation unit for storing a signal output by the CO gas leakage determination unit, a flow rate pattern group stored in the flow rate storage unit when the flow rate is registered in the flow rate registration unit and the registered flow rate, and for outputting a signal for shortening and setting the use time limit time estimating a CO gas leakage appliance, an appliance flow rate storage unit for storing the output signal of the CO gas leakage determination unit when the appliance estimation unit determines that the appliance is a CO leakage appliance and the flow rate pattern group stored in the flow rate storage unit when the flow rate is registered in the flow rate registration unit, a CO anomaly determination unit for monitoring an abnormal state of the use appliance and determining whether or not an anomaly exists according to the registered flow rate from the flow rate registration unit and the signal from the CO gas leakage determination unit concurrently with the anomaly determination unit, a shutoff unit for shutting off gas supply when the anomaly determination unit and the CO anomaly determination unit determines that an anomaly exists, and a communication unit for reporting appliance information if the appliance estimation unit determines the CO leakage appliance.

The instantaneous flow rate is found by the flow rate computation unit and is stored in sequence in the flow rate storage unit with the appliance number given for each flow rate area and on the other hand, the average flow rate is found by the average flow rate computation unit and is registered in the flow rate registration unit as the flow rate for monitor, and the total flow rate, the use time after registration, etc., is monitored by the anomaly determination unit and when an appliance enters an incomplete combustion state for some reason during the monitoring and the CO alarm detects CO gas leakage and the CO gas leakage determination unit determines alarm signal in a low concentration state, assuming that the appliance involves the possibility of CO gas leakage, from the flow rate pattern in the flow rate storage unit and the registered flow rate in the flow rate registration unit, the appliance estimation unit makes an estimation as to whether or not the appliance is an appliance of a flow rate pattern steadily causing CO gas leakage from the past flow rate pattern stored in the appliance flow rate storage unit and the registered flow rate and stores in the appliance flow rate storage unit, the CO anomaly determination unit separate from the anomaly determination unit monitors the use time and usually monitors the use time in the corresponding flow rate class; when the flow rate pattern group estimated to be the CO leakage target appliance is input to the appliance estimation unit, the monitored use time is shortened, the remaining time is changed to a short time, monitoring is again performed, the fact is reported to the monitor center, and then if the appliance is used without taking any means against the CO gas leakage, the appliance estimation mean collates with the previous flow rate pattern group and if it falls within a predetermined correlation coefficient, for example, in the CO anomaly determination unit, the use time is limited to a short use time and is monitored and thus if a large flow rate appliance of a water heater, etc., is used concurrently, the use time is monitored separately, so that the use time is limited from the stage of a CO gas alarm signal of an extremely minute amount and whenever the appliance is used, the use time is limited and thus concurrent monitoring is performed without giving a lower priority to the use time monitor as the large flow rate appliance is used, so that the gas supply is shut off in an extremely minute amount of CO gas leakage and in a short time, so that the danger for the user is extremely low and appliance information is reported as an alarm to the gas company, which then can easily determine the abnormal appliance and can take a measure as soon as possible.

According to a ninth aspect of the invention, a gas shutoff device for monitoring the use state of a gas appliance connected to piping after passing through a gas meter and limiting the use condition of the gas appliance in accordance with a signal from a CO alarm, wherein the gas meter includes flow rate detection unit for measuring the gas flow rate, a flow rate computation unit for finding an instantaneous flow rate value from the detection value of the flow rate detection unit, a flow rate storage unit for storing the instantaneous flow rate values found by the flow rate computation unit in association with each other in time series as a flow rate pattern, an average flow rate computation unit for averaging the instantaneous flow rate values found by the flow rate computation unit to find an average flow rate value, a flow rate registration unit for registering the flow rate value when it is determined that the flow rate is the appliance flow rate from the average flow rate value found by the average flow rate computation unit, a CO gas leakage determination unit for making a determination in accordance with a detection signal from the CO alarm and outputting a determination signal responsive to the CO concentration level, an appliance estimation unit for reading the flow rate pattern in the flow rate storage unit, estimating a CO leakage appliance, and outputting a signal for setting the limit value of the continuously usable time in a shortening direction when the appliance flow rate is registered in the flow rate registration unit and the CO gas leakage determination unit outputs the determination signal, an occurrence frequency measurement unit for counting the number of estimation processing times of a CO leakage appliance executed when a CO gas leakage determination signal is output, and issuing a command for executing estimation processing of a CO leakage appliance using a flow rate pattern regardless of whether or not the CO gas leakage determination signal exists when the number of estimation processing times exceeds a predetermined number of times, an appliance flow rate storage unit for storing the data in the flow rate storage unit read by the appliance estimation unit together with the appliance flow rate, an anomaly determination unit for changing the limit value of the continuously usable time of the appliance and determining whether or not an anomaly exists according to the signals from the flow rate registration unit, the appliance estimation unit, and the CO gas leakage determination unit, a shutoff unit for shutting off gas supply when an anomaly occurs, and a communication unit for reporting various pieces of appliance information, and wherein the gas shutoff device changes a condition when the CO leakage appliance is determined in response to the presence or absence of a signal from the occurrence frequency measurement unit, executes estimating processing of a CO leakage appliance in response to the determination signal of the CO gas leakage determination unit when a signal from the occurrence frequency measurement unit does not exist, executes estimating processing of a CO leakage appliance regardless of the determination signal of the CO gas leakage determination unit when a signal from the occurrence frequency measurement unit exists, and when the CO leakage appliance is determined, executes a monitor mode of limiting the use condition of the appliance and monitoring.

When use of an appliance is started, the instantaneous flow rate is found by the flow rate computation unit and is stored as a flow rate pattern in association with each other in time series and on the other hand, the average flow rate is found by the average flow rate computation unit and is registered in the flow rate registration unit as the flow rate for appliance monitor, and the magnitude of the flow rate, the length of the use time, etc., is monitored by the anomaly determination unit, wherein when an appliance enters an incomplete combustion state for some reason during the monitoring and the CO alarm detects CO gas leakage and the CO gas leakage determination unit determines CO alarm signal in a low concentration state, assuming that the appliance involves the possibility of CO gas leakage, the flow rate pattern in the flow rate storage unit and the registered flow rate in the flow rate registration unit are input to the appliance estimation unit as a data group and an estimation is made as to whether or not the appliance is an appliance of a flow rate pattern steadily causing CO gas leakage from the past flow rate pattern stored in the appliance flow rate storage unit and the registered flow rate and if the appliance is determined the CO leakage appliance, the limit value of the continuous use time is again set in the shortening direction through the anomaly determination unit and the monitor mode is executed. At the same time, the occurrence frequency measurement unit counts the match frequency between the appliance of the flow rate pattern and the registered flow rate determined CO gas leakage by the appliance estimation mean and CO gas leakage and when the count becomes a predetermined number of times or more, if no signal from the CO gas leakage determination unit exists, the appliance estimation unit executes estimation processing of a CO leakage appliance using the flow rate pattern and if the appliance is determined the CO leakage appliance, the limit value of the continuous use time is again set in the shortening direction through the anomaly determination unit, the monitor mode is executed, the fact is reported to the monitor center. Then, if the appliance is used without taking any means against the CO gas leakage, the appliance estimation mean collates with the previous flow rate pattern group and if it falls within a predetermined correlation coefficient, when the flow rate is registered in the flow rate registration unit, in the anomaly determination unit, the use time is limited to a short use time, whereby the use time is limited from the stage of a CO gas alarm signal of an extremely minute amount and whenever the appliance is used, the use time is limited and thus the gas supply is shut off in an extremely minute amount of CO gas leakage and in a short time, so that the danger for the user is extremely low and appliance information is reported as an alarm to the gas company, which then can easily determine the abnormal appliance and can take a measure as soon as possible.

In the gas shutoff device described above, the appliance estimation unit executes the monitor mode unconditionally when a CO gas leakage signal is first detected, and stores various pieces of data in the appliance flow rate storage unit.

When a CO gas leakage signal is detected in a state in which no data is stored in the appliance flow rate storage unit and flow rate pattern comparison cannot be made, the use appliance is determined the CO leakage appliance, the limit value of the use time is again set in the shortening direction, the monitoring is performed, so that safety of appliance use can be secured.

In the gas shutoff device described above, from a first-stage signal where the CO concentration is low to the maximum nth-stage signal where the CO concentration is high, output by the CO gas leakage determination unit, the appliance estimation unit sets the limit value of the continuously usable time of the appliance in the shortening direction in response to the determination signal output as the CO concentration increases.

As the occurrence CO concentration increases, the limit value of the continuously usable time is changed in a strictly monitoring direction, so that safety of appliance use can be further enhanced.

In the gas shutoff device described above, when the maximum nth-stage determination signal where the CO concentration is high is output from the CO gas leakage determination unit, the appliance estimation unit outputs a signal for closing the shutoff unit through the anomaly determination unit.

When the appliance use continues if the CO concentration enters an unstable state, the shutoff value is closed for stopping the gas supply, so that safety of appliance use can be further enhanced.

In the gas shutoff device described above, if the CO leakage appliance repeats use and stop, the appliance estimation unit sets the limit value of the continuously usable time of the appliance in the shortening direction in response to the number of repetitions.

If the CO leakage appliance frequently repeats use and stop, the continuously usable time is changed to a short use time and the monitoring is performed, so that safety of appliance use can be secured.

Because of a program, a part or all of the gas shutoff device of the invention can be easily implemented using a microcomputer, etc. The program is recorded on a record medium or is distributed using a communication line, so that the program can be easily distributed and installed.

According to a tenth aspect of the invention, an alarm-compatible system meter including a communication unit for conducting information communications with at least any one or more alarms of a fire alarm, a gas alarm, and a CO alarm, a gas meter including an external communication unit capable of communicating with an external system, an identification unit for identifying a signal of the alarm, and a measure selection unit for selecting a measure by the gas meter in response to the identification result from the identification unit, wherein upon reception of a signal from the CO alarm, the measure selection unit determines the presence or absence of gas use amount and when no gas is used, outputs to the external communication unit for communicating with the external system.

Accordingly, the external system is informed of CO occurrence caused by any other appliance than a gas appliance, whereby a rapid measure can be taken, so that a serial accident can be prevented and safety can be enhanced.

According to an eleventh aspect of the invention, particularly, upon reception of a signal from the CO alarm, the measure selection unit according to the tenth aspect of the invention determines the presence or absence of gas use amount and when no gas is used, outputs a signal for displaying CO occurrence on a customer display.

Accordingly, a person staying in the home is informed of CO occurrence caused by any other appliance than a gas appliance, whereby a rapid measure can be taken, so that a serial accident can be prevented and safety can be enhanced.

According to a twelfth aspect of the invention, particularly, upon reception of a signal from the CO alarm, the measure selection unit according to the tenth aspect of the invention determines the presence or absence of gas use amount and when no gas is used, outputs a signal for producing a special notification sound different from an alarm at the anomaly detecting time to at least any one or more alarms of the fire alarm, the gas alarm, and the CO alarm.

Accordingly, a person staying in the home can be reliably informed of CO occurrence caused by any other appliance than a gas appliance from a large number of alarms and a rapid measure can be taken, so that a serial accident can be prevented and safety can be enhanced.

According to a thirteenth aspect of the invention, particularly, the measure selection unit according to the tenth aspect of the invention outputs installation location information of the alarm contained in the identification result from the identification unit to the external system when a measure is taken.

Accordingly, the location where CO occurrence is caused by any other appliance than a gas appliance can be determined and it is made possible to reliably inform the external system and an appropriate measure can be taken, so that a serial accident can be prevented and safety can be enhanced.

According to a fourteenth aspect of the invention, particularly, the measure selection unit according to the tenth aspect of the invention outputs a signal for displaying the installation location information of the alarm contained in the identification result from the identification unit on the customer display when a measure is taken.

Accordingly, the location where CO occurrence is caused by any other appliance than a gas appliance can be determined and it is made possible to reliably inform a person staying in the home of the occurrence location and an appropriate measure can be taken, so that a serial accident can be prevented and safety can be enhanced.

According to a fifteenth aspect of the invention, particularly, the measure selection unit according to the tenth aspect of the invention adds appliance installation location information from an appliance including a communication unit to a signal to be output when a measure is taken, and outputs.

Accordingly, which appliance causes CO occurrence can be determined, whereby a reliable measure method can be known, so that a serious accident cab be prevented and safety can be enhanced.

According to a sixteenth aspect of the invention, there is provided a program for causing a computer to function as all or a part of the alarm-compatible system meter according to any one of the tenth to sixteenth aspects of the invention. Because of a program, at least a part of the program of the invention can be easily implemented using a general-purpose computer or a server. The program is recorded on a record medium or is distributed using a communication line, so that the program can be easily distributed and installed.

According to a seventeenth aspect of the invention, there is provided a gas shutoff device connected to an alarm for monitoring the presence or absence of gas leakage, the gas shutoff device for monitoring the use state of more than one gas appliance and shutting off gas supply when an anomaly occurs, characterized in that the gas shutoff device includes a flow rate detection unit for measuring the gas flow rate, a flow rate computation unit for computing the flow rate value from the detection value of the flow rate detection unit, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a gas leakage determination unit for inputting an output signal responsive to the concentration level of gas leakage from the alarm, an anomaly determination unit for monitoring an abnormal state of the use appliance and determining whether or not an anomaly exists according to the flow rate from the average computation unit, the registered flow rate from the flow rate registration unit and the signal from the gas leakage determination unit, a use time adjustment unit, upon reception of an alarm signal responsive to the concentration from the alarm, for changing the use time limit time corresponding to the registered flow rate and outputting to the anomaly determination unit for monitoring, and a shutoff unit for shutting off gas supply when the anomaly determination unit determines that an anomaly exists.

When an appliance is being used, the use flow rate is detected by the flow rate detection unit and is averaged by the average flow rate computation unit, and is registered in the flow rate registration unit as the appliance flow rate and is monitored. At this time, when the alarm detects gas leakage and it is detected that the gas leakage determination unit sends an alarm signal, if an initial-stage signal at a very low concentration is sent, the use time is monitored in the corresponding flow rate class of the registered flow rate in the anomaly determination unit; the use time is changed in the shortening direction of the use time by the use time adjustment unit, monitor is again executed, and the fact is reported to the monitor center, etc., and further when a high-concentration signal is next sent, the use time is further shortened and upon further reception of a high-concentration signal, the gas supply is shut off, whereby the use time is limited from an extremely minute amount stage and as the concentration increases, further the use time is limited, whereby an alarm is reported and on the other hand the use time of the appliance is limited without impairing the usability of the use, so that the number of unnecessary mobilization of times of the gas company is prevented from increasing or an appliance to be essentially used for a long time, such as a heater, is prevented from being used for a long time although the concentration increases, degradation of the usability can be prevented, and the safety is high.

According to an eighteenth aspect of the invention, there is provided a gas shutoff device connected to an alarm for monitoring the presence or absence of gas leakage and transmitting a signal through a wireless transmission unit, the gas shutoff device for monitoring the use state of more than one gas appliance and shutting off gas supply when an anomaly occurs, characterized in that the gas shutoff device including a flow rate detection unit for measuring the gas flow rate, a flow rate computation unit for computing the flow rate value from the detection value of the flow rate detection unit, an average flow rate computation unit for averaging the instantaneous flow rate values found by the flow rate computation unit to find an average flow rate value, a flow rate registration unit for registering the flow rate when it is determined that the flow rate is the appliance flow rate from the average flow rate found by the average flow rate computation unit, a gas leakage determination unit for inputting an output signal responsive to the concentration level of gas leakage from the alarm, an anomaly determination unit for monitoring an abnormal state of the use appliance and determining whether or not an anomaly exists according to the flow rate from the average computation unit, the registered flow rate from the flow rate registration unit and the signal from the gas leakage determination unit, a wireless unit for receiving the alarm signal from the alarm, a use time adjustment unit, upon reception of the alarm signal responsive to the concentration from the alarm through the wireless unit, for changing the use time limit time corresponding to the registered flow rate and outputting to the anomaly determination unit for monitoring, and a shutoff unit for shutting off gas supply when the anomaly determination unit determines that an anomaly exists.

When an appliance is being used, an alarm detects gas leakage and the wireless transmission unit transmits an alarm signal to the gas shutoff device, the wireless unit detects the signal, and further the gas leakage determination unit detects an alarm leakage state. At this time, the appliance is being used and when the use flow rate is detected by the flow rate detection unit and is averaged by the average flow rate computation unit and is registered in the flow rate registration unit as the appliance flow rate and is monitored, if an initial-stage signal at a very low concentration is sent, the use time is monitored in the corresponding flow rate class of the registered flow rate in the anomaly determination unit; the use time is changed in the shortening direction of the use time by the use time adjustment unit, monitor is again executed, and the fact is reported to the monitor center, etc., and further when a high-concentration signal is next sent, the use time is further shortened and upon further reception of a high-concentration signal, the gas supply is shut off, whereby the use time is limited from an extremely minute amount stage and as the concentration increases, further the use time is limited, whereby an alarm is reported and on the other hand the use time of the appliance is limited without impairing the usability of the use, so that the number of unnecessary mobilization of times of the gas company is prevented from increasing or an appliance to be essentially used for a long time, such as a heater, is prevented from being used for a long time although the concentration increases, degradation of the usability can be prevented, and the safety is high.

Because of a program, a part or all of the gas shutoff device of the invention can be easily implemented using a microcomputer, etc. The program is recorded on a record medium or is distributed using a communication line, so that the program can be easily distributed and installed.

### Embodiment 1

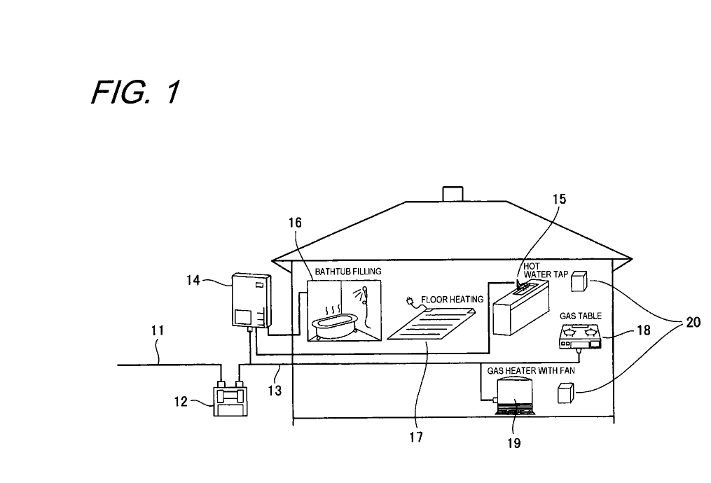

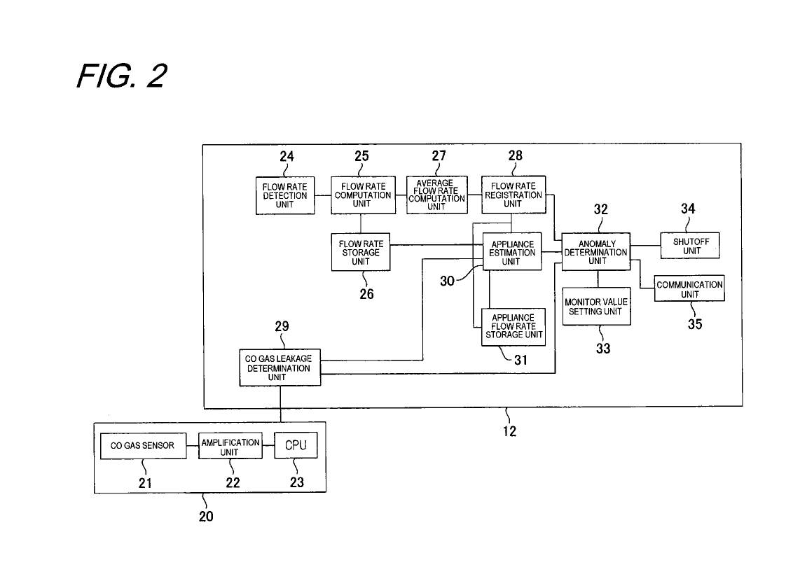

FIG. 1 is a drawing to show an installation mode of a gas shutoff device and gas appliances in Embodiment 1 of the invention, and FIG. 2 is a control block diagram of the gas shutoff device.

A gas shutoff device 12 is installed in the entry portion of a gas supply pipe 11 of each home and a branch is made from gas piping 13 after passing through the gas shutoff device 12 to places where various gas appliances used in the home are installed for supplying gas. For example, a gas water heater 14 is installed outdoors and warm water generated by the gas water heater 14 is supplied through water piping to a hot water tap 15 in a kitchen, a bath 16 where a bathtub and a shower are installed, and floor heating 17 installed in a living, etc., to form various use modes. Indoors, gas is supplied to a gas table 18 installed in a kitchen and a gas heater with fan for combustion air and circulating 19 installed in a living, a bedroom, etc., and a CO alarm 20 is installed in the kitchen, the living, the bedroom, etc., for monitoring CO (carbon monoxide) gas leakage.

When each installed gas appliance is used and consumption of gas occurs, the gas shutoff device 12 measures the use amount and cumulatively stores the data every predetermined time period. The data stored in the gas shutoff device 12 undergoes predetermined information processing based on a periodic data request command from a gas company and then is transmitted to the customer and the gas company as information of the gas rate, the gas use amount, or discount service, etc., provided by the gas company.

FIG. 2 is a control block diagram of the CO alarm 20 connected to the gas shutoff device 12. By way of example, the CO alarm 20 is made up of a CO gas sensor 21 for detecting CO gas and changing in the signal level in response to the CO concentration level, an amplification unit 22 for amplifying the signal, and a CPU 23 for processing the amplified signal. The CO alarm 20 is connected through a terminal block, etc., of the gas shutoff device 12. The CO alarm 20 outputs a code signal and an analog signal to the gas shutoff device 12 in response to a rise in the CO gas concentration level.

In the gas shutoff device 12, numeral 24 denotes a flow rate detection unit for measuring the gas flow rate. Various types of flow rate detection units 24 are available; as means shown in the embodiment, one of a pair of ultrasonic sensors installed in a flow path emits an ultrasonic signal to the other and the use gas flow rate is detected according to the propagation time; means provided with a hot wire sensor in a flow path for finding the flow rate according to the impedance changing according to a flow is available; and further means for detecting the gas amount using a measuring membrane and converting the mechanical operation of the measuring membrane into an electric pulse signal by a magnet and a lead switch or a magnetoresistive element, etc., for detecting the flow rate is available.

For example, in the flow rate detection unit 24 using the ultrasonic sensors, although not shown, a first transceiver for transmitting or receiving an ultrasonic wave and a second transceiver for receiving or transmitting an ultrasonic wave are opposed in the flowing direction and an ultrasonic signal is transmitted from upstream to downstream or from downstream to upstream every predetermined period for measuring the propagation time. The cross-sectional area of the flow path and the flow state of a fluid are considered from the propagation time difference of the ultrasonic wave between the first transceiver and the second transceiver and a flow rate computation unit 25 finds an instantaneous flow rate value.

A flow rate storage unit 26 determines that a flow rate value of a predetermined flow rate or more is the appliance flow rate and stores the instantaneous flow rates of the appliance flow rate or more in association with each other in time series. The flow rates are stored as a flow rate pattern group and are classified into a large flow rate area, a medium flow rate area, and a small flow rate area, and are given serial appliance numbers for storage.

An average flow rate computation unit 27 inputs an instantaneous flow rate value found in a predetermined period and gathers and averages a predetermined number of instantaneous flow rate values for calculating as an average flow rate value.

If the found average flow rate value is equal to or greater than a predetermined flow rate, a flow rate registration unit 28 registers as continuous use time monitor target as the appliance flow rate. Ordinarily, if the flow rate change width is equal to or greater than a predetermined flow rate with respect to the previous or N-times before flow rate value, the increment flow rate is registered as the appliance flow rate. If the flow rate decreases, it is determined that the appliance stops, and the flow rate registration value is deleted or changed.

A signal responsive to the CO gas concentration level in a room is output from the CO alarm 20, and a CO gas leakage determination unit 29 determines what concentration level the leakage signal is at. The CO gas leakage determination unit 29 receives and processes an analog signal, receives the signal as a communication signal, or receives the signal as a digital signal provided by coding the concentration level.

An appliance estimation unit 30 estimates an appliance flow rate pattern of a gas leakage possibility from the flow rate pattern group stored in the flow rate storage unit 26, the signal of the CO gas leakage determination unit 29, and the past appliance flow rate pattern group and flow rate registration value stored in an appliance flow rate storage unit 31. If only one flow rate registration exists in the flow rate registration unit 28, the appliance of the flow rate pattern in the flow rate storage unit 26 is estimated to be a CO gas leakage appliance and is registered internally. If more than one flow rate registration exists, a determination is made by whether or not the degree close to the flow rate is within a predetermined degree using a correlation coefficient, covariance, etc., for example, about change in the flow rate value of a predetermined flow rate or more, the peak flow rate, and flow rate change after the peak flow rate.

Whenever a signal is output from the CO gas leakage determination unit 29, information of the flow rate pattern group in the flow rate storage unit 26, the flow rate registration value in the flow rate registration unit 28, etc., is stored in sequence in an appliance flow rate storage unit 31.

An anomaly determination unit 32 monitors each use appliance based on a predetermined monitor condition.

A monitor value setting unit 33 stores the appliance continuous use limit time corresponding to each flow rate area according to the registration flow rate in the flow rate registration unit 28 or the monitor determination value of the use maximum flow rate, etc. For example, when a hose for supplying gas to a stove, etc., is detached for some reason, an abnormally large flow rate occurs. A total flow rate shutoff value to monitor such a state and the use time shutoff limit time stipulating the limit time of the use time corresponding to the case where the appliance has been used far longer than the maximum use time of the ordinary use of the appliance are set. The anomaly determination unit 32 makes a comparison determination of the setup value and the registration flow rate value in the flow rate registration unit 28, thereby determining whether or not the registration flow rate value exceeds the use maximum flow rate value, whether or not the appliance use time exceeds the appliance continuous use limit time corresponding to the registration flow rate value, or the like.

When a CO gas leakage appliance determination signal is output from the appliance estimation unit 30 to the anomaly determination unit 32, a far short continuous use limit time is set taking precedence over the essential continuous use limit time of the monitor value setting unit 33. If an alarm signal at the highest CO gas concentration level is output from the CO gas leakage determination unit 29, the alarm signal is output to the anomaly determination unit 32 and immediately a shutoff unit 34 is operated for shutting off.

When an anomaly is determined in the anomaly determination unit 32, a shutoff signal is sent to the shutoff unit 34 for stopping the gas supply. The shutoff state and the shutoff description are displayed on a liquid crystal device, etc., and are also sent to a center for conducting gas safety monitor through a communication unit 35.

When the appliance estimation unit 30 estimates that the appliance is a CO gas leakage appliance, the anomaly determination unit 32 monitors the use time of the registration flow rate and drastically shortens the use time for adjustment.

When the appliance flow rate is registered in the flow rate registration unit 28 and the anomaly determination unit 32 monitors the use time, if the appliance estimation unit 30 estimates that the appliance is a CO gas leakage appliance, the use time is adjusted.

Whenever the use time is adjusted, the monitor center (not shown) of the gas company is called through the communication unit 35 for providing notification that limit of the use time has been changed. At this time, the flow rate area code of the large flow rate area, the medium flow rate area, or the small flow rate area belonging and the appliance number belonging to the flow rate area are communicated to the center through the communication unit 35.

Next, the operation of the gas shutoff device in Embodiment 1 will be discussed. When a gas appliance possessed by a customer home, for example, such as the gas stove 19 or the gas water heater 14, is used, the flow rate detection unit 24 detects the flow rate. For example, to use the ultrasonic sensors, the propagation time of an ultrasonic signal is measured as a detection value and the signal is sent to the flow rate computation unit 25 for calculating as an instantaneous flow rate value.

If the instantaneous flow rate value calculated by the flow rate computation unit 25 is a flow rate value of a predetermined flow rate or more, the flow rate storage unit 26 determines that the flow rate is the appliance flow rate, inputs the flow rate value in sequence, associates the flow rate values with each other in time series, and stores them as a flow rate pattern. At the same time, it classifies for each flow rate area code of the large flow rate area, the medium flow rate area, or the small flow rate area and for each flow rate area according to the instantaneous flow rate value of the detected flow rate pattern, and gives the appliance number for storage.

The average flow rate computation unit 27 computes the average flow rate according to a predetermined number of flow rates and compares the found average flow rate with the average flow rate N times (n=1−) before and if flow rate change of a predetermined flow rate or more exists, determines that some appliance is used, and registers the increment flow rate in the flow rate registration unit 28.

The anomaly determination unit 32 references the monitor value stored in the monitor value setting unit 33, namely, the limit value of the continuous usable time according to the flow rate classification to which the registration flow rate belongs, and counts and monitors the continuous use time of the use appliance. On the other hand, concurrently, it also checks whether or not the flow rate value found by the average flow rate computation unit 27 before registered in the flow rate registration unit 28 exceeds the abnormal flow rate caused to occur by a hose detachment, etc.

When the gas table 18, the gas heater with fan for combustion air and circulating 19, etc., is used in a living or a kitchen, if an incomplete combustion state occurs for some reason and CO gas leakage occurs, the CO gas sensor 21 of the CO alarm 20 detects it and the CPU 23 outputs a CO gas leakage signal to the gas shutoff device 12 as an alarm signal at an extremely low stage of the CO gas concentration level, for example, as a first-stage alarm signal.

When the CO gas leakage determination unit 29 detects the first-stage signal, the appliance estimation unit 30 compares the flow rate registration value, the flow rate pattern group stored in the flow rate storage unit 26, and the flow rate data group, the flow rate pattern group, and the registered flow rate in the appliance flow rate storage unit 31, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected.

If the CO gas leakage signal is first detected, unconditionally the flow rate pattern group and the registration flow rate are stored in the appliance flow rate storage unit 31 and for safety, a signal is output to the anomaly determination unit 32 as CO gas leakage appliance detection, the use time is measured, and the monitor time is shortened. For example, while the gas table 18 or the gas heater with fan for combustion air and circulating 19 is being used, the initial monitor time of 720 minutes can be shortened to 20 minutes, for example. The appliance number classified for each of the large flow rate area, the medium flow rate area, or the small flow rate area stored in the flow rate storage unit 26 is stored together. While the gas appliance is used, if the CO gas leakage determination unit 29 inputs the maximum nth-stage alarm signal of high CO gas concentration from the CO alarm 20, when the appliance estimation unit 30 outputs estimation output of use of CO gas leakage appliance to the anomaly determination unit, immediately the anomaly determination unit 32 outputs a shutoff signal to the shutoff unit 34.

When the appliance is stopped and is again used and likewise the CO gas leakage determination unit 29 detects a CO gas leakage signal, the appliance estimation unit 30 makes an estimation as to whether or not the gas appliance is a CO gas leakage appliance according to the data in the appliance flow rate storage unit 31 and, for example, correlation coefficient, etc., outputs a CO gas leakage appliance detection signal to the anomaly determination unit 32, and drastically limits the use time. When the appliance estimation unit 30 outputs the CO gas leakage appliance detection signal to the anomaly determination unit 32, a far short use time limit time is set taking precedence over the essential limit time of the monitor value setting unit 33. That is, if the gas leakage appliance repeats use and stop, the limit value of the continuously usable time of the appliance is set shorter in response to the number of repetitions.

At the same time, the center of the gas company is called through the communication unit 35 for providing notification that limit of the continuous use time has been executed because of CO gas leakage detection. In ordinary call, the code signal indicating the anomaly description and the flow rate classification are sent; in CO gas leakage, however, the CO gas leakage code indicating the CO gas leakage state, the appliance code, the CO alarm description (the concentration level of the first stage, the second stage, etc., is coded), the limit time, and the like are further sent. Ordinarily, the alarm signal at the concentration level of the first stage is a signal at an extremely low level having no effect on a human body.

When the CO gas concentration detected by the CO alarm 20 gradually rises, the signal changes to the second-stage, the third-stage alarm and is sent. When the signal is detected, the determination width of the correlation coefficient of the appliance flow rate pattern in the appliance estimation unit 30 is widened and estimation of the gas leakage appliance is facilitated and the monitor value of the continuous use time is further shortened for gradually shortening the remaining time. At the same time, the center is called for communications. If the gas concentration level rises in a stroke and an extremely dangerous alarm signal of the maximum concentration is input to the CO gas leakage determination unit 29, which then outputs the signal to the anomaly determination unit 32, which immediately outputs a shutoff signal to the shutoff unit 34 for stopping the gas supply and securing safety.

The numeric limits used in the embodiment are given by way of example and the use mode is not limited to the embodiment.

As described above, when the CO alarm 20 detects CO gas leakage and the CO gas leakage determination unit 29 of the gas shutoff device 12 determines that it is a first-stage alarm signal at a low CO gas concentration level, an estimation is made as to whether or not the appliance is a CO gas leakage appliance from the appliance flow rate registered in the appliance estimation unit 30, a time series signal of the appliance flow rate of the predetermined flow rate or more stored in the flow rate storage unit 26, and the data stored in the appliance flow rate storage unit 31; when it is estimated that the appliance is a CO gas leakage appliance, the use time counted and monitored by the anomaly determination unit 32 is limited and the classified and stored appliance number is reported to the center through the communication unit 35, whereby the gas company can be notified which appliance causes trouble to occur, safety of the gas appliance user is secured, danger to the life such as carbon monoxide poisoning caused by CO gas leakage is prevented, the appliance is easy to determine by reporting information of the appliance number, etc., to the center of the gas company, a safety measure can be taken at an early stage when the CO gas concentration level is low, and an extremely safe and highly reliable gas appliance use environment can be provided.

Next, as another embodiment, a configuration wherein if a gas leakage determination signal from the CO gas leakage determination unit 29 does not exist, the use start of a gas leakage appliance is estimated by determining a flow rate pattern and a signal for again setting the limit value of the continuous use time in the shortening direction is output to the anomaly determination unit 32 will be discussed below as Embodiment 2:

### Embodiment 2

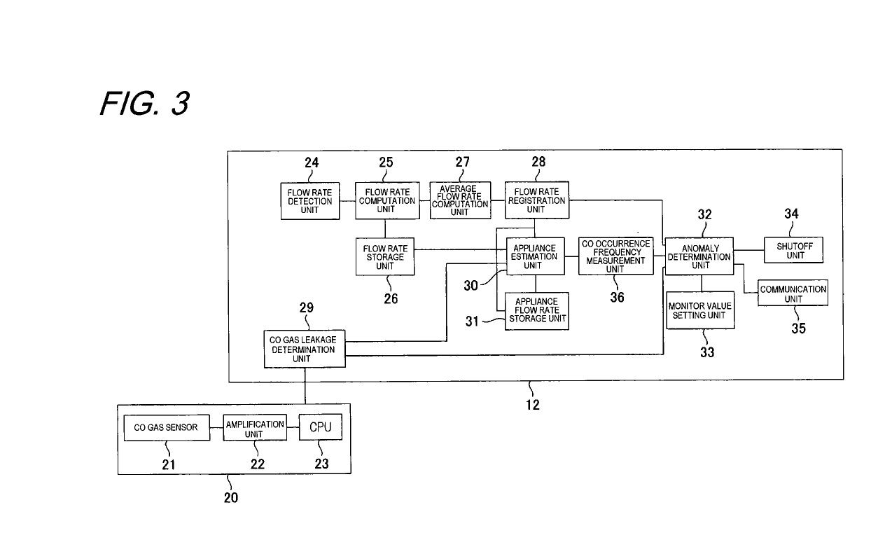

FIG. 3 is a control block diagram of a gas shutoff device in Embodiment 2 of the invention. Units that perform the same function as those in FIGS. 1 and 2 are denoted by the same numbers in FIG. 3.

In FIG. 3, in each home, gas is supplied to a gas table 18 installed in a kitchen and a gas heater with fan for combustion air and circulating 19 installed in a living, a bedroom, etc., and a CO alarm 20 is installed in the kitchen, the living, the bedroom, etc., for monitoring CO gas leakage.

In FIG. 3, when a CO gas leakage determination unit 29 determines a CO gas leakage signal from the CO alarm 20, an appliance estimation unit 30 counts as gas leakage frequency presence as an integrated flow rate data group from the flow rate pattern stored in a flow rate storage unit 26 and the registration flow rate in a flow rate registration unit 28 and when the count reaches the predetermined number of times, later, if a gas leakage determination signal from the CO gas leakage determination unit 29 does not exist, the appliance estimation unit 30 estimates the use start of gas leakage appliance by determining the flow rate pattern in the flow rate storage unit 26 and an appliance flow rate storage unit 31 and when it is estimated that the gas appliance is the gas leakage appliance, a CO occurrence frequency measurement unit 36 outputs a signal for again setting the limit value of the continuous use time in the shortening direction to an anomaly determination unit 32.

Next, the operation of the gas shutoff device configured as described above will be discussed.

When a gas appliance possessed by a customer home, for example, such as the gas stove 19 or a gas water heater 14, is used, a flow rate detection unit 24 detects the flow rate. For example, to use ultrasonic sensors, the propagation time of an ultrasonic signal is measured as a detection value and the signal is sent to a flow rate computation unit 25 for calculating as an instantaneous flow rate value.

The flow rate storage unit 26 determines that the flow rate value of a predetermined flow rate or more is the appliance flow rate and associates the instantaneous flow rates of the appliance flow rate or more with each other in time series for storage. It stores them as a flow rate pattern group and also classifies the flow rate patterns for each flow rate area and gives the appliance number for storage.

The average flow rate computation unit 27 inputs an instantaneous flow rate value found in a predetermined period and gathers and averages a predetermined number of instantaneous flow rate values for calculating as an average flow rate value.

If the found average flow rate value is equal to or greater than a predetermined flow rate, a flow rate registration unit 28 registers as continuous use time monitor target as the appliance flow rate. Ordinarily, if the flow rate change width is equal to or greater than a predetermined flow rate with respect to the previous or N-times before flow rate value, the increment flow rate is registered as the appliance flow rate. If the flow rate decreases, it is determined that the appliance stops, and the flow rate registration value is deleted or changed.

The anomaly determination unit 32 references the monitor value stored in a monitor value setting unit 33, namely, the limit time value of the use time according to the flow rate classification to which the registration flow rate belongs, and counts and monitors the use time of the use appliance. On the other hand, concurrently, it also checks whether or not the flow rate value found by the average flow rate computation unit 27 before registered in the flow rate registration unit 28 exceeds the abnormal flow rate caused to occur by a hose detachment, etc.

When the gas table 18, the gas heater with fan for combustion air and circulating 19, etc., is used in a living or a kitchen, if an incomplete combustion state occurs for some reason and CO gas leakage occurs, a CO gas sensor 21 of the CO alarm 20 detects it and a CPU 23 outputs a CO gas leakage signal to the gas shutoff device 12 as an alarm signal at an extremely low stage of the CO gas concentration level, for example, as a first-stage alarm signal.

When the CO gas leakage determination unit 29 determines the first-stage signal, the appliance estimation unit 30 compares the flow rate registration value, the flow rate pattern group stored in the flow rate storage unit 26, and the flow rate data group, the flow rate pattern group, and the registered flow rate in the appliance flow rate storage unit 31, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected.

The appliance is used and whenever the CO gas leakage is detected, the CO occurrence frequency measurement unit 36 measures the number of CO gas leakage occurrence times as the occurrence frequency in the flow rate pattern appliance estimated to be the CO gas leakage appliance by the appliance estimation unit 30.

If the CO gas leakage signal is first detected, the flow rate pattern group and the registration flow rate are stored in the appliance flow rate storage unit 31 and for safety, a signal is output to the anomaly determination unit 32 as gas leakage appliance detection, the use time is measured, and the monitor time is shortened. For example, while the gas table 18 or the gas heater with fan for combustion air and circulating 19 is being used, the initial monitor time of 720 minutes is shortened to 60 minutes, etc., for example, for shortening the remaining time.

When the appliance is stopped and is again used and likewise the CO gas leakage determination unit 29 detects a CO gas leakage signal, whenever the appliance estimation unit 30 makes an estimation as to whether or not the gas appliance is a gas leakage appliance according to the data in the appliance flow rate storage unit 31 and, for example, correlation coefficient, etc., the CO occurrence frequency measurement unit 36 measures the number of times. When the number of occurrence times becomes equal to or greater than a predetermined number of times, if a gas leakage signal from the gas leakage determination unit 29 does not exist, a gas leakage appliance detection signal is output to the anomaly determination unit 32 and the use time is drastically limited.

At the same time, the center of the gas company is called through a communication unit 35 to limit the use time because of gas leakage detection and appliance information of the appliance number of the appliance where an anomaly occurs or the like is also reported to the center. When the CO alarm 20 operates, the gas customer is warned using sound notification, etc., although not shown; if the warn is repeated, the customer may draw out the power supply line of the CO alarm 20 and consequently if leakage from a gas appliance occurs, the accident may be unable to be reported, but it can already be estimated as a flow rate pattern of the gas leakage appliance according to the gas flow rate data and the use time of the appliance can be limited drastically.

The alarm signal at the concentration level of the first stage is a signal at an extremely low level having no effect on a human body and at the early stage, the use time is limited, whereby safety can be secured.

The numeric limits used in the embodiment are given by way of example and the use mode is not limited to the embodiment.

As described above, when the CO alarm 20 detects CO gas leakage and the CO gas leakage determination unit 29 of the gas shutoff device 12 detects that it is a first-stage alarm signal at a low gas concentration level, an estimation is made as to whether or not the appliance is a gas leakage appliance from the appliance flow rate registered in the appliance estimation unit 30, a time series signal of the flow rate of the predetermined flow rate or more stored in the flow rate storage unit 26, and the data stored in the appliance flow rate storage unit 31, and the CO occurrence frequency measurement unit 36 counts the number of occurrence times; when the count reaches the predetermined number of times, if a gas leakage signal from the gas leakage determination unit 29 does not exist, it is estimated that the appliance is a gas leakage appliance according to a signal from the appliance estimation unit 30 and the continuous use time counted and monitored by the anomaly determination unit 32 is limited.

Accordingly, safety of the gas appliance user is secured, danger to a fire or the life caused by gas leakage is prevented, appliance information of the appliance number of the appliance determined to be abnormal by the appliance estimation unit 30 or the like can also be reported to the center of the gas company, the CO occurrence appliance is easy to determine, a safety measure can be taken at an early stage when the gas concentration level is low, and an extremely safe and highly reliable gas appliance use environment can be provided.

### Embodiment 3

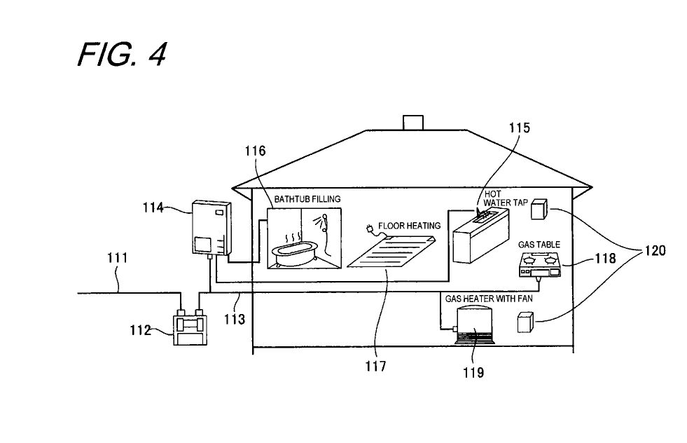

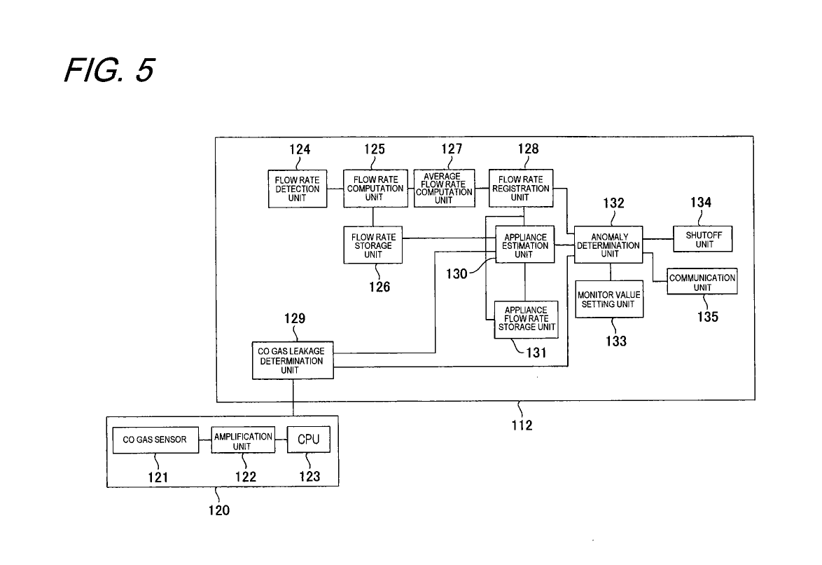

FIG. 4 is a drawing to show an installation mode of a gas shutoff device and gas appliances in Embodiment 3 of the invention, and FIG. 5 is a control block diagram of the gas shutoff device.

In FIG. 4, a gas shutoff device 112 is installed in the entry portion of a gas supply pipe 111 of each home and a branch is made from gas piping 113 after passing through the gas shutoff device 112 to places where various gas appliances used in the home are installed for supplying gas. For example, a gas water heater 114 is installed outdoors and warm water generated by the gas water heater 114 is supplied through water piping to a hot water tap 115 in a kitchen, a bath 116 where a bathtub and a shower are installed, and floor heating 117 installed in a living, etc., to form various use modes. Indoors, gas is supplied to a gas table 118 installed in a kitchen and a gas heater with fan for combustion air and circulating 119 installed in a living, a bedroom, etc., and a CO alarm 120 is installed in the kitchen, the living, the bedroom, etc., for monitoring CO (carbon monoxide) gas leakage.

When each installed gas appliance is used and consumption of gas occurs, the gas shutoff device 112 measures the use amount and cumulatively stores the data every predetermined time period. The data stored in the gas shutoff device 112 undergoes predetermined information processing based on a periodic data request command from a gas company and then is transmitted to the customer and the gas company as information of the gas rate, the gas use amount, or discount service, etc., provided by the gas company.

FIG. 5 is a control block diagram of the CO alarm 120 connected to the gas shutoff device 112. By way of example, the CO alarm 120 is made up of a CO gas sensor 121 for detecting CO gas and changing in the signal level in response to the CO concentration level, an amplification unit 122 for amplifying the signal, and a CPU 123 for processing the amplified signal. The CO alarm 120 is connected through a terminal block, etc., of the gas shutoff device 112. The CO alarm 120 outputs a code signal and an analog signal to the gas shutoff device 112 in response to a rise in the CO gas concentration level.

In the gas shutoff device 112, numeral 124 denotes a flow rate detection unit for measuring the gas flow rate. Various types of flow rate detection units 124 are available; as means shown in the embodiment, one of a pair of ultrasonic sensors installed in a flow path emits an ultrasonic signal to the other and the use gas flow rate is detected according to the propagation time; means provided with a hot wire sensor in a flow path for finding the flow rate according to the impedance changing according to a flow is available; and further means for detecting the gas amount using a measuring membrane and converting the mechanical operation of the measuring membrane into an electric pulse signal by a magnet and a lead switch or a magnetoresistive element, etc., for detecting the flow rate is available.

For example, in the flow rate detection unit 124 using the ultrasonic sensors, although not shown, a first transceiver for transmitting or receiving an ultrasonic wave and a second transceiver for receiving or transmitting an ultrasonic wave are opposed in the flowing direction and an ultrasonic signal is transmitted from upstream to downstream or from downstream to upstream every predetermined period for measuring the propagation time. The cross-sectional area of the flow path and the flow state of a fluid are considered from the propagation time difference of the ultrasonic wave between the first transceiver and the second transceiver and a flow rate computation unit 125 finds an instantaneous flow rate value.

Numeral 126 denotes a flow rate storage unit for storing the detected instantaneous flow rates of the flow rate or more determined to be the appliance flow rate of a predetermined flow rate or more. The flow rates are stored as a flow rate pattern group and are classified into a large flow rate area, a medium flow rate area, and a small flow rate area, and are given serial appliance numbers for storage. Numeral 127 denotes an average flow rate computation unit for inputting an instantaneous flow rate value found in a predetermined period and gathering and averaging a predetermined number of instantaneous flow rate values for calculating as an average flow rate value. Numeral 128 denotes a flow rate registration unit and if the found average flow rate value is equal to or greater than a predetermined flow rate, the flow rate registration unit 128 registers as continuous use time monitor target as the appliance flow rate. Ordinarily, if the flow rate change width is equal to or greater than a predetermined flow rate with respect to the previous or N-times before flow rate value, the increment flow rate is registered as the appliance flow rate. If the flow rate decreases, it is determined that the appliance stops, and the flow rate registration value is deleted or changed.

Numeral 129 denotes a CO gas leakage determination unit; a signal responsive to the CO gas concentration level in a room is output from the CO alarm 120, and the CO gas leakage determination unit 129 determines what concentration level the leakage signal is at. The CO gas leakage determination unit 128 receives and processes an analog signal, receives the signal as a communication signal, or receives the signal as a digital signal provided by coding the concentration level. Numeral 130 denotes an appliance estimation unit for estimating an appliance flow rate pattern of a gas leakage possibility from the flow rate pattern group stored in the flow rate storage unit 126, the signal of the CO gas leakage determination unit 129, and the past appliance flow rate pattern group and flow rate registration value stored in an appliance flow rate storage unit 131. If only one flow rate registration exists in the flow rate registration unit 128, the appliance of the flow rate pattern in the flow rate storage unit 126 is estimated to be a CO gas leakage appliance and is registered internally. If more than one flow rate registration exists, a determination is made by whether or not the degree close to the flow rate is within a predetermined degree using a correlation coefficient, covariance, etc., for example, about change in the flow rate value of a predetermined flow rate or more, the peak flow rate, and flow rate change after the peak flow rate. Whenever a signal is output in sequence from the CO gas leakage determination unit 129, information of the flow rate pattern group in the flow rate storage unit 126, the flow rate registration value in the flow rate registration unit 128, etc., is stored in an appliance flow rate storage unit 131.

Numeral 132 denotes an anomaly determination unit for monitoring each use appliance. A monitor value setting unit 133 stores the appliance continuous use limit time corresponding to each flow rate area according to the registration flow rate in the flow rate registration unit 128 or the monitor determination value of the use maximum flow rate, etc. For example, when a hose for supplying gas to a stove, etc., is detached for some reason, an abnormally large flow rate occurs. A total flow rate shutoff value to monitor such a state and the use time shutoff limit time stipulating the limit time of the use time corresponding to the case where the appliance has been used far longer than the maximum use time of the ordinary use of the appliance are set. The anomaly determination unit 132 makes a comparison determination of the setup value and the registration flow rate value in the flow rate registration unit 127, thereby determining whether or not the registration flow rate value exceeds the use maximum flow rate value, whether or not the appliance use time exceeds the appliance continuous use limit time corresponding to the registration flow rate value, or the like. When a CO leakage appliance determination signal is output from the appliance estimation unit 130 to the anomaly determination unit 132, a far short continuous use limit time is set taking precedence over the essential continuous use limit time of the monitor value setting unit 133. If an alarm signal at the highest CO gas concentration level is output from the CO gas leakage determination unit 128, the alarm signal is output to the anomaly determination unit 132 and immediately a shutoff unit 134 is operated for shutting off.

When an anomaly is determined in the anomaly determination unit 132, a shutoff signal is sent to the shutoff unit 134 for stopping the gas supply. The shutoff state and the shutoff description are displayed on a liquid crystal device, etc., and are also sent to a center for conducting gas safety monitor through a communication unit 135.

When the appliance estimation unit 130 estimates that the appliance is a CO gas leakage appliance, the anomaly determination unit 132 monitors the use time of the registration flow rate and drastically shortens the use time for adjustment. When the appliance flow rate is registered in the flow rate registration unit 127 and the anomaly determination unit 129 monitors the use time, when the appliance estimation unit 130 estimates that the appliance is a CO gas leakage appliance, the use time is adjusted. Whenever the use time is adjusted, the monitor center (not shown) of the gas company is called through the communication unit 35 for providing notification that limit of the use time has been changed. At this time, the flow rate area code of the large flow rate area, the medium flow rate area, or the small flow rate area belonging and the appliance number belonging to the flow rate area are communicated to the center through the communication unit 135.

Next, the operation of the gas shutoff device of Embodiment 3 will be discussed. When a gas appliance possessed by a customer home, for example, such as the gas stove 119 or the gas water heater 114, is used, the flow rate detection unit 124 detects the flow rate. For example, to use the ultrasonic sensors, the propagation time of an ultrasonic signal is measured as a detection value and the signal is sent to the flow rate computation unit 125 for calculating as an instantaneous flow rate value, and in the flow rate storage unit 126, a flow rate value of a predetermined flow rate or more is detected, it is determined that the flow rate is the appliance flow rate, and the time-series flow rate values are stored as a flow rate pattern. At the same time, the flow rate storage unit 126 classifies for each flow rate area code of the large flow rate area, the medium flow rate area, or the small flow rate area and for each flow rate area according to the instantaneous flow rate value of the detected flow rate pattern, and gives the appliance number for storage. The average flow rate computation unit 127 computes the average flow rate according to a predetermined number of flow rates and compares the found average flow rate with the average flow rate N times (n=1−) before and if flow rate change of a predetermined flow rate or more exists, determines that some appliance is used, and registers the increment flow rate in the flow rate registration unit 128.

The anomaly determination unit 132 references the monitor value stored in the monitor value setting unit 133, namely, the limit value of the continuous usable time according to the flow rate classification to which the registration flow rate belongs, and counts and monitors the continuous use time of the use appliance. On the other hand, concurrently, it also checks whether or not the flow rate value found by the average flow rate computation unit 127 before registered in the flow rate registration unit 128 exceeds the abnormal flow rate caused to occur by a hose detachment, etc.

When the gas table 118, the gas heater with fan for combustion air and circulating 119, etc., is used in a living or a kitchen, if an incomplete combustion state occurs for some reason and carbon monoxide (CO) gas leakage occurs, the CO gas sensor 121 of the CO alarm 120 detects it and the CPU 123 outputs a CO gas leakage signal to the gas shutoff device 112 as an alarm signal at an extremely low stage of the CO gas concentration level, for example, as a first-stage alarm signal. When the CO gas leakage determination unit 129 detects the first-stage signal, the appliance estimation unit 130 compares the flow rate registration value, the flow rate pattern group stored in the flow rate storage unit 126, and the flow rate data group, the flow rate pattern group, and the registered flow rate in the appliance flow rate storage unit 131, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected.

If the CO gas leakage signal is first detected, the flow rate pattern group and the registration flow rate are stored in the appliance flow rate storage unit 131 and for safety, a signal is output to the anomaly determination unit 132 as CO gas leakage appliance detection, the use time is measured, and the monitor time is shortened. For example, while the gas table 118 or the gas heater with fan for combustion air and circulating 119 is being used, the initial monitor time of 720 minutes can be shortened to 20 minutes, for example. The appliance number classified for each of the large flow rate area, the medium flow rate area, or the small flow rate area stored in the flow rate storage unit 126 is stored together. While the gas appliance is used, if the CO gas leakage determination unit 129 inputs the maximum nth-stage alarm signal of high CO gas concentration from the CO alarm 120, when the appliance estimation unit 130 outputs estimation output of use of CO leakage appliance to the anomaly determination unit, immediately the anomaly determination unit 132 outputs a shutoff signal to the shutoff unit 134.

When the appliance is stopped and is again used and likewise the CO gas leakage determination unit 129 detects a CO gas leakage signal, the appliance estimation unit 130 makes an estimation as to whether or not the gas appliance is a CO gas leakage appliance according to the data in the appliance flow rate storage unit 131 and, for example, correlation coefficient, etc., outputs a CO gas leakage appliance detection signal to the anomaly determination unit 132, and drastically limits the use time. When the appliance estimation unit 130 outputs the CO leakage appliance detection signal to the anomaly determination unit 132, a far short use time limit time is set taking precedence over the essential limit time of the monitor value setting unit 133. At the same time, the center of the gas company is called through the communication unit 131 for providing notification that limit of the continuous use time has been executed because of CO gas leakage detection. In ordinary call, the code signal indicating the anomaly description and the flow rate classification are sent; in CO leakage, however, the CO leakage code indicating the CO leakage state, the appliance code the CO alarm description (the concentration level of the first stage, the second stage, etc., is coded), the limit time, and the like are further sent. Ordinarily, the alarm signal at the concentration level of the first stage is a signal at an extremely low level having no effect on a human body.

When the CO gas concentration detected by the CO alarm 120 gradually rises, the signal changes to the second-stage, the third-stage alarm and is sent. When the signal is detected, the determination width of the correlation coefficient of the appliance flow rate pattern in the appliance estimation unit 130 is widened and estimation of the gas leakage appliance is facilitated and the monitor value of the use time is further shortened for gradually shortening the remaining time. At the same time, the center is called for communications. If the gas concentration level rises in a stroke and an extremely dangerous alarm signal of the maximum concentration is input to the CO gas leakage determination unit 129, which then outputs the signal to the anomaly determination unit 132, which immediately outputs a shutoff signal to the shutoff unit 133 for stopping the gas supply and securing safety.

The numeric limits used in the embodiment are given by way of example and the use mode is not limited to the embodiment.

As described above, when the CO alarm 20 detects CO gas leakage and the CO gas leakage determination unit 129 of the gas shutoff device 112 determines that it is a first-stage alarm signal at a low CO gas concentration level, an estimation is made as to whether or not the appliance is a CO gas leakage appliance from the appliance flow rate registered in the appliance estimation unit 130, a time series signal of the flow rate stored the predetermined flow rate or more in the flow rate storage unit 126, and the data stored in the appliance flow rate storage unit 131; when it is estimated that the appliance is a CO gas leakage appliance, the use time counted and monitored by the anomaly determination unit 132 is limited and the classified and stored appliance number is reported to the center through the communication unit, whereby the gas company can be notified which appliance causes trouble to occur, safety of the gas appliance user is secured, danger to the life such as carbon monoxide poisoning caused by CO gas leakage is prevented, the appliance is easy to determine by reporting information of the appliance number, etc., to the center of the gas company, the gas company or the gas customer can be allowed to take a safety measure at an early stage when the CO gas concentration level is low, and an extremely safe and highly reliable environment is provided.

### Embodiment 4

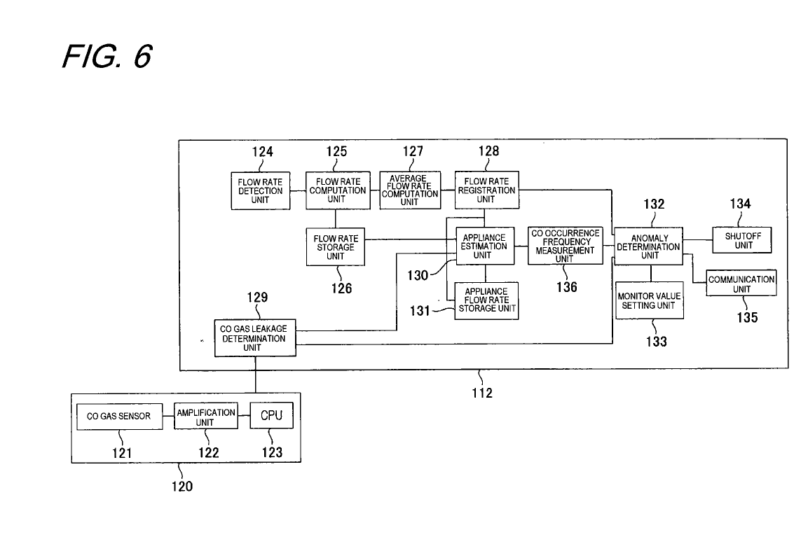

FIG. 6 is a control block diagram of a gas shutoff device in Embodiment 4 of the invention. Units that perform the same function as those in FIGS. 4 and 5 are denoted by the same numbers in FIG. 6.

In FIG. 6, in each home, gas is supplied to a gas table 118 installed in a kitchen and a gas heater with fan for combustion air and circulating 119 installed in a living, a bedroom, etc., and a CO alarm 120 is installed in the kitchen, the living, the bedroom, etc., for monitoring CO gas leakage.

Numeral 136 denotes an occurrence frequency measurement unit and when a CO gas leakage determination unit 129 determines a CO gas leakage signal from the CO alarm 120, an appliance estimation unit 130 counts as gas leakage frequency presence as an integrated flow rate data group from the flow rate pattern stored in a flow rate storage unit 126 and the registration flow rate in a flow rate registration unit 128 and when the count reaches the predetermined number of times, later, if a gas leakage signal from the CO gas leakage determination unit 129 does not exist, the use start of gas leakage appliance is estimated only by determining the flow rate pattern and a use time shortening setting signal is output to an anomaly determination unit 132.

Next, the operation of the gas shutoff device configured as described above will be discussed. When a gas appliance possessed by a customer home, for example, such as the gas stove 119 or a gas water heater 114, is used, a flow rate detection unit 124 detects the flow rate. For example, to use ultrasonic sensors, the propagation time of an ultrasonic signal is measured as a detection value and the signal is sent to a flow rate computation unit 125 for calculating as an instantaneous flow rate value and when detecting the flow rate value of a predetermined flow rate or more, the flow rate storage unit 126 determines that it is the appliance flow rate, stores the time-series flow rate values as a flow rate pattern, classifies the flow rate patterns for each flow rate area, and gives the appliance number for storage. The average flow rate computation unit 127 computes an average flow rate from a predetermined number of flow rates and compares the found average flow rate with the average flow rate N times before; if flow rate change of a predetermined flow rate or more exists, the average flow rate computation unit 127 determines some appliance use and registers the increment flow rate in a flow rate registration unit 128.

The anomaly determination unit 132 references the monitor value stored in a monitor value setting unit 133, namely, the limit time value of the use time according to the flow rate classification to which the registration flow rate belongs, and counts and monitors the use time of the use appliance. On the other hand, concurrently, it also checks whether or not the flow rate value found by the average flow rate computation unit 126 before registered in the flow rate registration unit 127 exceeds the abnormal flow rate caused to occur by a hose detachment, etc.

When the gas table 118, the gas heater with fan for combustion air and circulating 119, etc., is used in a living or a kitchen, if an incomplete combustion state occurs for some reason and CO gas leakage occurs, a CO gas sensor 121 of the CO alarm 120 detects it and a CPU 123 outputs a CO gas leakage signal to the gas shutoff device 112 as an alarm signal at an extremely low stage of the CO gas concentration level, for example, as a first-stage alarm signal. When the CO gas leakage determination unit 129 determines the first-stage signal, the appliance estimation unit 130 compares the flow rate registration value, the flow rate pattern group stored in the flow rate storage unit 126, and the flow rate data group, the flow rate pattern group, and the registered flow rate in the appliance flow rate storage unit 131, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected. The appliance is used and whenever the CO gas leakage is detected, the CO occurrence frequency measurement unit 136 measures the number of CO gas leakage occurrence times as the occurrence frequency in the flow rate pattern appliance estimated to be the CO gas leakage appliance by the appliance estimation unit 130.

If the CO gas leakage signal is first detected, the flow rate pattern group and the registration flow rate are stored in the appliance flow rate storage unit 131 and for safety, a signal is output to the anomaly determination unit 132 as gas leakage appliance detection, the use time is measured, and the monitor time is shortened. For example, while the gas table 118 or the gas heater with fan for combustion air and circulating 119 is being used, the initial monitor time of 720 minutes is shortened to 60 minutes, etc., for example, for shortening the remaining time.

When the appliance is stopped and is again used and likewise the CO gas leakage determination unit 129 detects a CO gas leakage signal, whenever the appliance estimation unit 130 makes an estimation as to whether or not the gas appliance is a gas leakage appliance according to the data in the appliance flow rate storage unit 131 and, for example, correlation coefficient, etc., the occurrence frequency measurement unit 135 measures the number of times. When the number of occurrence times becomes equal to or greater than a predetermined number of times, if a gas leakage signal from the gas leakage determination unit 129 does not exist, a gas leakage appliance detection signal is output to the anomaly determination unit 132 and the use time is drastically limited. At the same time, the center of the gas company is called through a communication unit 131 to limit the use time because of gas leakage detection and appliance information of the appliance number of the appliance where an anomaly occurs or the like is also reported to the center. When the CO alarm 120 operates, the gas customer is warned using sound notification, etc., although not shown; if the warn is repeated, the customer may draw out the power supply line of the CO alarm 120 and consequently if leakage from a gas appliance occurs, the accident may be unable to be reported, but it can already be estimated as a flow rate pattern of the gas leakage appliance according to the gas flow rate data and the use time of the appliance can be limited drastically. The alarm signal at the concentration level of the first stage is a signal at an extremely low level having no effect on a human body and at the early stage, the use time is limited, whereby safety can be secured.

The numeric limits used in the embodiment are given by way of example and the use mode is not limited to the embodiment.

As described above, when the CO alarm 120 detects CO gas leakage and the CO gas leakage determination unit 129 of the gas shutoff device 112 detects that it is a first-stage alarm signal at a low gas concentration level, an estimation is made as to whether or not the appliance is a gas leakage appliance from the appliance flow rate registered in the appliance estimation unit 130, a time series signal of the flow rate of the predetermined flow rate or more stored in the flow rate storage unit 126, and the data stored in the appliance flow rate storage unit 131, and the CO occurrence frequency measurement unit 136 counts the number of occurrence times; when the count reaches the predetermined number of times, if a gas leakage signal from the gas leakage determination unit 129 does not exist, it is estimated that the appliance is a gas leakage appliance according to a signal from the appliance estimation unit 30 and the use time counted and monitored by the anomaly determination unit 132 is limited, whereby safety of the gas appliance user is secured, danger to a fire or the life caused by gas leakage is prevented, and appliance information of the appliance number of the appliance determined to be abnormal by the appliance estimation unit 130 or the like is reported to the center of the gas company, so that the CO occurrence appliance is easy to determine, the gas company or the gas customer can be allowed to take a safety measure at an early stage when the gas concentration level is low, and an extremely safe and highly reliable environment is provided.

### Embodiment 5

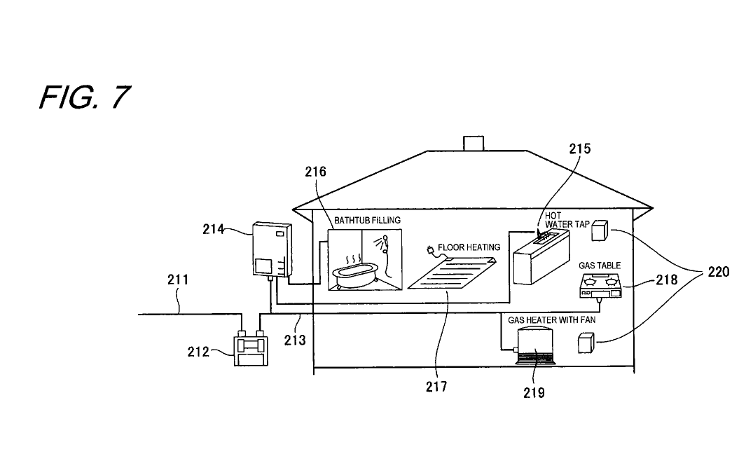

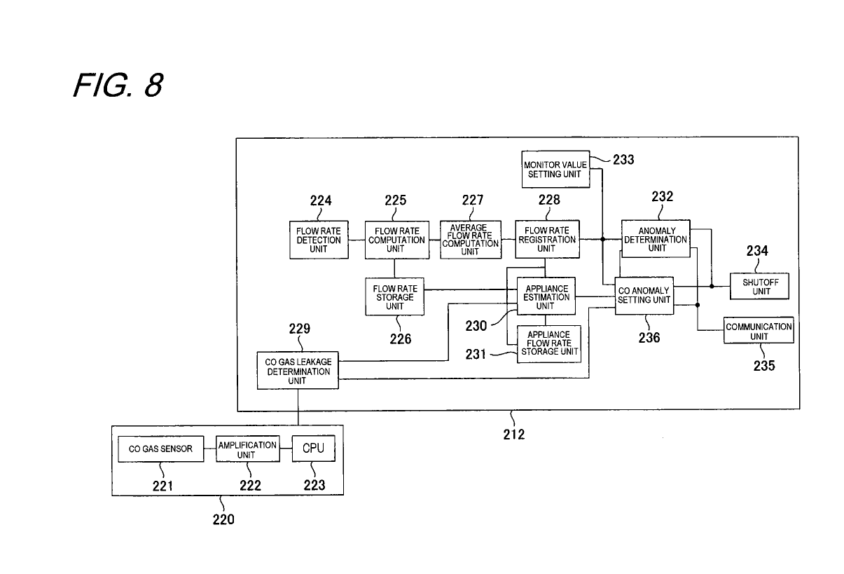

FIG. 7 is a drawing to show an installation mode of a gas shutoff device and gas appliances in Embodiment 5 of the invention and FIG. 8 is a control block diagram of the gas shutoff device in Embodiment 5.

FIG. 8 is a control block diagram of the gas shutoff device in Embodiment 5 of the invention. Units that perform the same function as those in FIG. 7 are denoted by the same numbers in FIG. 8.

In FIG. 8, numeral 236 denotes a CO anomaly determination unit and when a CO gas leakage determination unit 29 detects a CO gas leakage signal from a CO alarm 20, an appliance estimation unit 230 makes a CO gas leakage presence determination as an integrated flow rate data group from the flow rate pattern stored in a flow rate storage unit 226 and the registration flow rate in a flow rate registration unit 228 and monitors the use time concurrently with the flow rate registration unit 228. If an anomaly determination unit 232 monitors the use time of a gas appliance at a larger flow rate than a CO occurrence appliance, the CO anomaly determination unit 236 monitors the use time concurrently. If a gas leakage signal from the CO gas leakage determination unit 229 does not exist, the use start of gas leakage appliance is estimated only by determining the flow rate pattern and a use time shortening setting signal is output to the CO anomaly determination unit 236.

In FIG. 7, a gas shutoff device 212 is installed in the entry portion of a gas supply pipe 211 of each home and a branch is made from gas piping 213 after passing through the gas shutoff device 212 to places where various gas appliances used in the home are installed for supplying gas. For example, a gas water heater 214 is installed outdoors and warm water generated by the gas water heater 214 is supplied through water piping to a hot water tap 215 in a kitchen, a bath 216 where a bathtub and a shower are installed, and floor heating 217 installed in a living, etc., to form various use modes. Indoors, gas is supplied to a gas table 218 installed in a kitchen and a gas heater with fan for combustion air and circulating 219 installed in a living, a bedroom, etc., and the CO alarm 220 is installed in the kitchen, the living, the bedroom, etc., for monitoring CO (carbon monoxide) gas leakage.

When each installed gas appliance is used and consumption of gas occurs, the gas shutoff device 212 measures the use amount and cumulatively stores the data every predetermined time period. The data stored in the gas shutoff device 212 undergoes predetermined information processing based on a periodic data request command from a gas company and then is transmitted to the customer and the gas company as information of the gas rate, the gas use amount, or discount service, etc., provided by the gas company.

FIG. 8 is a control block diagram of the CO alarm 220 connected to the gas shutoff device 212. By way of example, the CO alarm 220 is made up of a CO gas sensor 221 for detecting CO gas and changing in the signal level in response to the CO concentration level, an amplification unit 222 for amplifying the signal, and a CPU 223 for processing the amplified signal. The CO alarm 220 is connected through a terminal block, etc., of the gas shutoff device 212. The CO alarm 220 outputs a code signal and an analog signal to the gas shutoff device 212 in response to a rise in the CO gas concentration level.

In the gas shutoff device 212, numeral 224 denotes a flow rate detection unit for measuring the gas flow rate. Various types of flow rate detection units 224 are available; as means shown in the embodiment, one of a pair of ultrasonic sensors installed in a flow path emits an ultrasonic signal to the other and the use gas flow rate is detected according to the propagation time; means provided with a hot wire sensor in a flow path for finding the flow rate according to the impedance changing according to a flow is available; and further means for detecting the gas amount using a measuring membrane and converting the mechanical operation of the measuring membrane into an electric pulse signal by a magnet and a lead switch or a magnetoresistive element, etc., for detecting the flow rate is available.

For example, in the flow rate detection unit 224 using the ultrasonic sensors, although not shown, a first transceiver for transmitting or receiving an ultrasonic wave and a second transceiver for receiving or transmitting an ultrasonic wave are opposed in the flowing direction and an ultrasonic signal is transmitted from upstream to downstream or from downstream to upstream every predetermined period for measuring the propagation time. The cross-sectional area of the flow path and the flow state of a fluid are considered from the propagation time difference of the ultrasonic wave between the first transceiver and the second transceiver and a flow rate computation unit 225 finds an instantaneous flow rate value.

Numeral 226 denotes a flow rate storage unit for storing the detected instantaneous flow rates of the flow rate or more determined to be the appliance flow rate of a predetermined flow rate or more. The flow rates are stored as a flow rate pattern group and are classified into a large flow rate area, a medium flow rate area, and a small flow rate area, and are given serial appliance numbers for storage. Numeral 227 denotes an average flow rate computation unit for inputting an instantaneous flow rate value found in a predetermined period and gathering and averaging a predetermined number of instantaneous flow rate values for calculating as an average flow rate value. Numeral 228 denotes a flow rate registration unit and if the found average flow rate value is equal to or greater than a predetermined flow rate, the flow rate registration unit 228 registers as continuous use time monitor target as the appliance flow rate. Ordinarily, if the flow rate change width is equal to or greater than a predetermined flow rate with respect to the previous or N-times before flow rate value, the increment flow rate is registered as the appliance flow rate. If the flow rate decreases, it is determined that the appliance stops, and the flow rate registration value is deleted or changed. They are registered in the descending order of the appliance flow rate.

Numeral 229 denotes a CO gas leakage determination unit; a signal responsive to the CO gas concentration level in a room is output from the CO alarm 220, and the CO gas leakage determination unit 229 determines what concentration level the leakage signal is at. The CO gas leakage determination unit 228 receives and processes an analog signal, receives the signal as a communication signal, or receives the signal as a digital signal provided by coding the concentration level. Numeral 230 denotes an appliance estimation unit for estimating an appliance flow rate pattern of a gas leakage possibility from the flow rate pattern group stored in the flow rate storage unit 226, the signal of the CO gas leakage determination unit 229, and the past appliance flow rate pattern group and flow rate registration value stored in an appliance flow rate storage unit 231. If only one flow rate registration exists in the flow rate registration unit 228, the appliance of the flow rate pattern in the flow rate storage unit 226 is estimated to be a CO gas leakage appliance and is registered internally. If more than one flow rate registration exists, a determination is made by whether or not the degree close to the flow rate is within a predetermined degree using a correlation coefficient, covariance, etc., for example, about change in the flow rate value of a predetermined flow rate or more, the peak flow rate, and flow rate change after the peak flow rate. Whenever a signal is output in sequence from the CO gas leakage determination unit 229, information of the flow rate pattern group in the flow rate storage unit 226, the flow rate registration value in the flow rate registration unit 228, etc., is stored in an appliance flow rate storage unit 231.

Numeral 232 denotes an anomaly determination unit for monitoring each use appliance. A monitor value setting unit 133 stores the appliance continuous use limit time corresponding to each flow rate area according to the registration flow rate in the flow rate registration unit 228 or the monitor determination value of the use maximum flow rate, etc. For example, when a hose for supplying gas to a stove, etc., is detached for some reason, an abnormally large flow rate occurs. A total flow rate shutoff value to monitor such a state and the use time shutoff limit time stipulating the limit time of the use time corresponding to the case where the appliance has been used far longer than the maximum use time of the ordinary use of the appliance are set. The anomaly determination unit 232 makes a comparison determination of the setup value and the registration flow rate value in the flow rate registration unit 228, thereby determining whether or not the registration flow rate value exceeds the use maximum flow rate value, whether or not the appliance use time exceeds the appliance continuous use limit time corresponding to the registration flow rate value, or the like.

When an anomaly is determined in the anomaly determination unit 232, a shutoff signal is sent to the shutoff unit 234 for stopping the gas supply. The shutoff state and the shutoff description are displayed on a liquid crystal device, etc., and are also sent to a center for conducting gas safety monitor through a communication unit 235.

On the other hand, numeral 236 denotes a CO anomaly determination unit and when the CO gas leakage determination unit 229 detects a CO gas leakage signal from the CO alarm 220, the appliance estimation unit 230 makes a CO gas leakage presence determination as an integrated flow rate data group from the flow rate pattern stored in the flow rate storage unit 226 and the registration flow rate in the flow rate registration unit 228 and monitors the use time concurrently with the flow rate registration unit 228. If the anomaly determination unit 232 monitors the use time of a gas appliance at a larger flow rate than a CO occurrence appliance, the CO anomaly determination unit 236 monitors the use time concurrently. If a gas leakage signal from the CO gas leakage determination unit 229 does not exist, the use start of gas leakage appliance is estimated only by determining the flow rate pattern and a use time shortening setting signal is output to the CO anomaly determination unit 236. That is, when the appliance estimation unit 230 outputs a CO leakage appliance determination signal to the anomaly determination unit 232, a far short use time limit time is set taking precedence over the essential limit time of the monitor setting unit 233. If an alarm signal at the highest CO gas concentration level is output from the CO gas leakage determination unit 228, the alarm signal is output to the anomaly determination unit 236 and immediately a shutoff unit 234 is operated for shutting off.

Once the appliance estimation unit 230 estimates that the appliance is a CO gas leakage appliance, the CO anomaly determination unit 236 drastically shortens the use time of the CO occurrence appliance flow rate and monitors. Then, when the appliance flow rate is registered in the flow rate registration unit 228 and the anomaly determination unit 232 monitors the use time, if the power supply voltage of the CO alarm 220 lowers or the 100-V power supply is drawn out and the essential CO detection signal is not transmitted, when the appliance estimation unit 230 estimates that the appliance is a CO gas leakage appliance, the use time is adjusted automatically. Whenever the use time is adjusted, the monitor center (not shown) of the gas company is called through the communication unit 235 for providing notification that limit of the use time has been changed. At this time, the flow rate area code of the large flow rate area, the medium flow rate area, or the small flow rate area belonging and the appliance number belonging to the flow rate area are communicated to the center through the communication unit 235.

Next, the operation of the gas shutoff device of Embodiment 5 configured as described above will be discussed. When a gas appliance possessed by a customer home, for example, such as the gas stove 219 or the gas water heater 214, is used, the flow rate detection unit 224 detects the flow rate. For example, to use the ultrasonic sensors, the propagation time of an ultrasonic signal is measured as a detection value and the signal is sent to the flow rate computation unit 225 for calculating as an instantaneous flow rate value, and in the flow rate storage unit 226, a flow rate value of a predetermined flow rate or more is detected, it is determined that the flow rate is the appliance flow rate, and the time-series flow rate values are stored as a flow rate pattern. At the same time, the flow rate storage unit 226 classifies for each flow rate area code of the large flow rate area, the medium flow rate area, or the small flow rate area and for each flow rate area according to the instantaneous flow rate value of the detected flow rate pattern, and gives the appliance number for storage. The average flow rate computation unit 227 computes the average flow rate according to a predetermined number of flow rates and compares the found average flow rate with the average flow rate N times (n=1−) before and if flow rate change of a predetermined flow rate or more exists, determines that some appliance is used, and registers the increment flow rate in the flow rate registration unit 228.

The anomaly determination unit 232 references the monitor value stored in the monitor value setting unit 233, namely, the limit value of the continuous usable time according to the flow rate classification to which the registration flow rate belongs, and counts and monitors the continuous use time of the use appliance and always monitors exceeding of the abnormal flow rate caused to occur by a hose detachment, etc. Whenever each appliance is used, they are registered in the descending order of the flow rate values found by the average flow rate computation unit 227, and the anomaly determination unit 232 monitors the use time and counts the use time with priority given to the appliance of the maximum appliance flow rate registered in the flow rate registration unit 228.

When the gas table 218, the gas heater with fan for combustion air and circulating 219, etc., is used in a living or a kitchen, if an incomplete combustion state occurs for some reason and carbon monoxide (CO) gas leakage occurs, the CO gas sensor 221 of the CO alarm 220 detects it and the CPU 223 outputs a CO gas leakage signal to the gas shutoff device 212 as an alarm signal at an extremely low stage of the CO gas concentration level, for example, as a first-stage alarm signal. When the CO gas leakage determination unit 229 detects the first-stage signal, the appliance estimation unit 230 compares the flow rate registration value, the flow rate pattern group stored in the flow rate storage unit 226, the appliance number, the flow rate data group, the flow rate pattern group, and the registered flow rate in the appliance flow rate storage unit 231, and the appliance number, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected.

If the CO gas leakage signal is first detected, the flow rate pattern group and the registration flow rate are stored in the appliance flow rate storage unit 231 and a signal is output to the CO anomaly determination unit 236 as CO gas leakage appliance detection, the use time is measured, and monitor is started. At this time, the monitor determination time is set to a drastically shorter time than the usable time at the normal time from the appliance flow rate. For example, while the gas table 218 or the gas heater with fan for combustion air and circulating 219 is being used, the initial monitor time of 720 minutes can be shortened to 20 minutes, for example. The appliance number classified for each of the large flow rate area, the medium flow rate area, or the small flow rate area stored in the flow rate storage unit 226 is stored together. While the gas appliance is used, if the CO gas leakage determination unit 229 inputs the maximum nth-stage alarm signal of high CO gas concentration from the CO alarm 220, when the appliance estimation unit 230 outputs estimation output of use of CO leakage appliance to the anomaly determination unit, immediately the CO anomaly determination unit 236 outputs a shutoff signal to the shutoff unit 234.

Ordinarily, they are registered in the descending order of the appliance flow rates detected by the flow rate registration unit 228, and the anomaly determination unit 232 monitors the use time with priority in the descending order of the appliance flow rates. When use of the CO leakage appliance is started and the gas water heater 214 is used to fill the bathtub with water at the same time, the use time monitor of the gas water heater takes precedence over the use time monitor of the CO leakage appliance. If the flow rate of the CO leakage appliance is registered in the flow rate registration unit 228, as the appliance estimation unit 230 identifies and determines the CO leakage appliance, the CO anomaly determination unit 236 monitors the use time concurrently with the anomaly determination unit 232. When the appliance has been used for a long time simultaneously with the gas water heater 214, if the use time in the anomaly determination unit 232 does not reach the determination value, the CO anomaly determination unit 236 monitors the use time of the CO leakage appliance and when the use limit time is reached, immediately a shutoff signal is output to the shutoff unit 234 for stopping the gas use.

If the appliance is again used, when the CO gas leakage determination unit 229 likewise detects a CO gas leakage signal, the appliance estimation unit 230 makes an estimation as to whether or not the gas appliance is a CO gas leakage appliance according to the data in the appliance flow rate storage unit 231 and, for example, correlation coefficient, etc., outputs a CO gas leakage appliance detection signal to the CO anomaly determination unit 236, and drastically limits the use time. When the appliance estimation unit 230 outputs the CO leakage appliance detection signal to the CO anomaly determination unit 236, a far short use time limit time is set taking precedence over the essential limit time of the monitor value setting unit 233. At the same time, the center of the gas company is called through the communication unit 234 for providing notification that limit of the continuous use time has been executed because of CO gas leakage detection, and appliance information of the appliance number, etc., of the appliance where CO leakage is detected is also reported to the center together. In ordinary call, the code signal indicating the anomaly description and the flow rate classification are sent; in CO leakage, however, the CO leakage code indicating the CO leakage state, the appliance code the CO alarm description (the concentration level of the first stage, the second stage, etc., is coded), the limit time, and the like are further sent. Ordinarily, the alarm signal at the concentration level of the first stage is a signal at an extremely low level having no effect on a human body.

When the CO gas concentration detected by the CO alarm 220 gradually rises, the signal changes to the second-stage, the third-stage alarm and is sent. When the signal is detected, the determination width of the correlation coefficient of the appliance flow rate pattern in the appliance estimation unit 230 is widened and estimation of the gas leakage appliance is facilitated and the monitor value of the use time is further shortened for gradually shortening the remaining time. At the same time, the center is called for communications. If the gas concentration level rises in a stroke and an extremely dangerous alarm signal of the maximum concentration is input to the CO gas leakage determination unit 229, which then outputs the signal to the CO anomaly determination unit 236, which immediately outputs a shutoff signal to the shutoff unit 234 for stopping the gas supply and securing safety.

The numeric limits used in the embodiment are given by way of example and the use mode is not limited to the embodiment.

As described above, when the CO alarm 220 detects CO gas leakage and the CO gas leakage determination unit 229 of the gas shutoff device 212 determines that it is a first-stage alarm signal at a low CO gas concentration level, an estimation is made as to whether or not the appliance is a CO gas leakage appliance from the appliance flow rate registered in the appliance estimation unit 230, a time series signal of the flow rate stored the predetermined flow rate or more in the flow rate storage unit 226, and the data stored in the appliance flow rate storage unit 231; when it is estimated that the appliance is a CO gas leakage appliance, the CO anomaly determination unit 236 monitors the use time independently without being affected by any other large flow rate appliance and the counted and monitored use time is limited drastically and the classified and stored appliance number is reported to the center through the communication unit, whereby the gas company can be notified which appliance causes trouble to occur, safety of the gas appliance user is secured, danger to the life such as carbon monoxide poisoning caused by CO gas leakage is prevented, the appliance is easy to determine by reporting information of the appliance number, etc., to the center of the gas company, the gas company or the gas customer can be allowed to take a safety measure at an early stage when the CO gas concentration level is low, and an extremely safe and highly reliable environment is provided.

### Embodiment 6

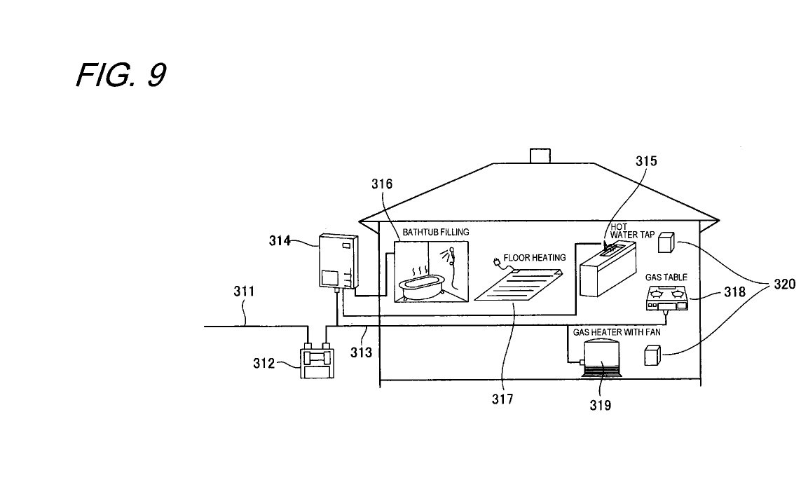

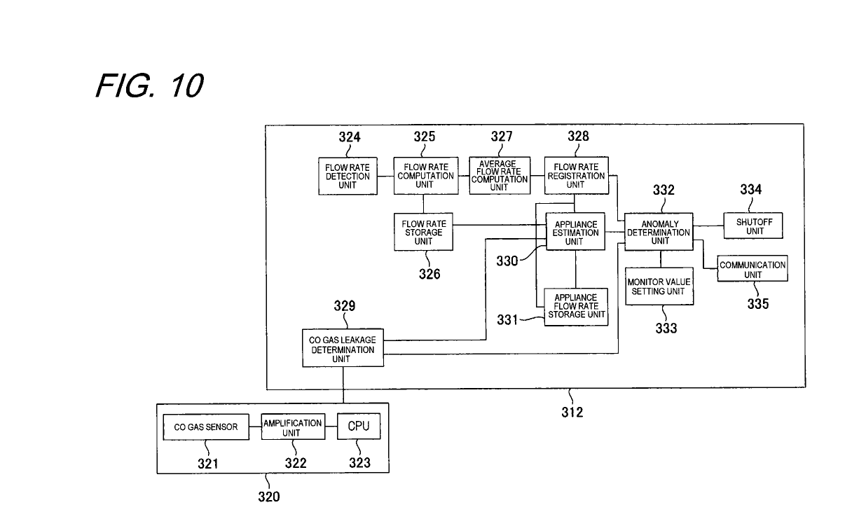

FIG. 9 is a drawing to show an installation mode of a gas shutoff device and gas appliances in Embodiment 6 of the invention, and FIG. 10 is a control block diagram of the gas shutoff device.

To begin with, the configuration for executing estimation processing of a CO leakage appliance in response to a determination signal of CO gas leakage determination unit will be discussed as Embodiment 6 of the invention.

In FIG. 9, a gas shutoff device 312 is installed in the entry portion of a gas supply pipe 311 of each home and a branch is made from gas piping 313 after passing through the gas shutoff device 312 to places where various gas appliances used in the home are installed for supplying gas. For example, a gas water heater 314 is installed outdoors and warm water generated by the gas water heater 314 is supplied through water piping to a hot water tap 315 in a kitchen, a bath 316 where a bathtub and a shower are installed, and floor heating 317 installed in a living, etc., to form various use modes. Indoors, gas is supplied to a gas table 318 installed in a kitchen and a gas heater with fan for combustion air and circulating 319 installed in a living, a bedroom, etc., and a CO alarm 320 is installed in the kitchen, the living, the bedroom, etc., for monitoring CO (carbon monoxide) gas leakage.

When each installed gas appliance is used and consumption of gas occurs, the gas shutoff device 312 measures the use amount and cumulatively stores the data every predetermined time period. The data stored in the gas shutoff device 312 undergoes predetermined information processing based on a periodic data request command from a gas company and then is transmitted to the customer and the gas company as information of the gas rate, the gas use amount, or discount service, etc., provided by the gas company.

FIG. 10 is a control block diagram of the CO alarm 320 connected to the gas shutoff device 312. By way of example, the CO alarm 320 is made up of a CO gas sensor 321 for detecting CO gas and changing in the signal level in response to the CO concentration level, an amplification unit 322 for amplifying the signal, and a CPU 323 for processing the amplified signal. The CO alarm 320 is connected through a terminal block, etc., of the gas shutoff device 312. The CO alarm 320 outputs a code signal and an analog signal to the gas shutoff device 312 in response to a rise in the CO gas concentration level.

In the gas shutoff device 312, numeral 324 denotes a flow rate detection unit for measuring the gas flow rate. Various types of flow rate detection units 324 are available; as means shown in the embodiment, one of a pair of ultrasonic sensors installed in a flow path emits an ultrasonic signal to the other and the use gas flow rate is detected according to the propagation time; means provided with a hot wire sensor in a flow path for finding the flow rate according to the impedance changing according to a flow is available; and further means for detecting the gas amount using a measuring membrane and converting the mechanical operation of the measuring membrane into an electric pulse signal by a magnet and a lead switch or a magnetoresistive element, etc., for detecting the flow rate is available.

For example, in the flow rate detection unit 324 using the ultrasonic sensors, although not shown, a first transceiver for transmitting or receiving an ultrasonic wave and a second transceiver for receiving or transmitting an ultrasonic wave are opposed in the flowing direction and an ultrasonic signal is transmitted from upstream to downstream or from downstream to upstream every predetermined period for measuring the propagation time. The cross-sectional area of the flow path and the flow state of a fluid are considered from the propagation time difference of the ultrasonic wave between the first transceiver and the second transceiver and a flow rate computation unit 325 finds an instantaneous flow rate value.

A flow rate storage unit 326 determines that a flow rate value of a predetermined flow rate or more is the appliance flow rate and stores the instantaneous flow rates of the appliance flow rate or more in association with each other in time series. The flow rates are stored as a flow rate pattern group and are classified into a large flow rate area, a medium flow rate area, and a small flow rate area, and are given serial appliance numbers for storage.

An average flow rate computation unit 327 inputs an instantaneous flow rate value found in a predetermined period and gathers and averages a predetermined number of instantaneous flow rate values for calculating as an average flow rate value.

If the found average flow rate value is equal to or greater than a predetermined flow rate, a flow rate registration unit 328 registers as continuous use time monitor target as the appliance flow rate. Ordinarily, if the flow rate change width is equal to or greater than a predetermined flow rate with respect to the previous or N-times before flow rate value, the increment flow rate is registered as the appliance flow rate. If the flow rate decreases, it is determined that the appliance stops, and the flow rate registration value is deleted or changed.

A signal responsive to the CO gas concentration level in a room is output from the CO alarm 320, and a CO gas leakage determination unit 329 determines what concentration level the leakage signal is at. The CO gas leakage determination unit 329 receives and processes an analog signal, receives the signal as a communication signal, or receives the signal as a digital signal provided by coding the concentration level.

An appliance estimation unit 330 estimates an appliance flow rate pattern of a gas leakage possibility from the flow rate pattern group stored in the flow rate storage unit 326, the signal of the CO gas leakage determination unit 329, and the past appliance flow rate pattern group and flow rate registration value stored in an appliance flow rate storage unit 331. If only one flow rate registration exists in the flow rate registration unit 328, the appliance of the flow rate pattern in the flow rate storage unit 326 is estimated to be a CO gas leakage appliance and is registered internally. If more than one flow rate registration exists, a determination is made by whether or not the degree close to the flow rate is within a predetermined degree using a correlation coefficient, covariance, etc., for example, about change in the flow rate value of a predetermined flow rate or more, the peak flow rate, and flow rate change after the peak flow rate.

Whenever a signal is output from the CO gas leakage determination unit 329, information of the flow rate pattern group in the flow rate storage unit 326, the flow rate registration value in the flow rate registration unit 328, etc., is stored in sequence in an appliance flow rate storage unit 331.

An anomaly determination unit 332 monitors each use appliance based on a predetermined monitor condition.

A monitor value setting unit 333 stores the appliance continuous use limit time corresponding to each flow rate area according to the registration flow rate in the flow rate registration unit 328 or the monitor determination value of the use maximum flow rate, etc. For example, when a hose for supplying gas to a stove, etc., is detached for some reason, an abnormally large flow rate occurs. A total flow rate shutoff value to monitor such a state and the use time shutoff limit time stipulating the limit time of the use time corresponding to the case where the appliance has been used far longer than the maximum use time of the ordinary use of the appliance are set. The anomaly determination unit 332 makes a comparison determination of the setup value and the registration flow rate value in the flow rate registration unit 328, thereby determining whether or not the registration flow rate value exceeds the use maximum flow rate value, whether or not the appliance use time exceeds the appliance continuous use limit time corresponding to the registration flow rate value, or the like.

When a CO leakage appliance determination signal is output from the appliance estimation unit 330 to the anomaly determination unit 332, a far short continuous use limit time is set taking precedence over the essential continuous use limit time of the monitor value setting unit 333. If an alarm signal at the highest CO gas concentration level is output from the CO gas leakage determination unit 329, the alarm signal is output to the anomaly determination unit 332 and immediately a shutoff unit 34 is operated for shutting off.

When an anomaly is determined in the anomaly determination unit 332, a shutoff signal is sent to the shutoff unit 334 for stopping the gas supply. The shutoff state and the shutoff description are displayed on a liquid crystal device, etc., and are also sent to a center for conducting gas safety monitor through a communication unit 335.

When the appliance estimation unit 330 estimates that the appliance is a CO gas leakage appliance, the anomaly determination unit 332 monitors the use time of the registration flow rate and drastically shortens the use time for adjustment.

When the appliance flow rate is registered in the flow rate registration unit 328 and the anomaly determination unit 332 monitors the use time, if the appliance estimation unit 330 estimates that the appliance is a CO gas leakage appliance, the use time is adjusted.

Whenever the use time is adjusted, the monitor center (not shown) of the gas company is called through the communication unit 335 for providing notification that limit of the use time has been changed. At this time, the flow rate area code of the large flow rate area, the medium flow rate area, or the small flow rate area belonging and the appliance number belonging to the flow rate area are communicated to the center through the communication unit 335.

Next, the operation of the gas shutoff device of the invention will be discussed. When a gas appliance possessed by a customer home, for example, such as the gas stove 319 or the gas water heater 314, is used, the flow rate detection unit 324 detects the flow rate. For example, to use the ultrasonic sensors, the propagation time of an ultrasonic signal is measured as a detection value and the signal is sent to the flow rate computation unit 325 for calculating as an instantaneous flow rate value.

If the instantaneous flow rate value calculated by the flow rate computation unit 325 is a flow rate value of a predetermined flow rate or more, the flow rate storage unit 326 determines that the flow rate is the appliance flow rate, inputs the flow rate value in sequence, associates the flow rate values with each other in time series, and stores them as a flow rate pattern. At the same time, it classifies for each flow rate area code of the large flow rate area, the medium flow rate area, or the small flow rate area and for each flow rate area according to the instantaneous flow rate value of the detected flow rate pattern, and gives the appliance number for storage.

The average flow rate computation unit 327 computes the average flow rate according to a predetermined number of flow rates and compares the found average flow rate with the average flow rate N times (n=1−) before and if flow rate change of a predetermined flow rate or more exists, determines that some appliance is used, and registers the increment flow rate in the flow rate registration unit 328.

The anomaly determination unit 332 references the monitor value stored in the monitor value setting unit 333, namely, the limit value of the continuous usable time according to the flow rate classification to which the registration flow rate belongs, and counts and monitors the continuous use time of the use appliance. On the other hand, concurrently, it also checks whether or not the flow rate value found by the average flow rate computation unit 327 before registered in the flow rate registration unit 328 exceeds the abnormal flow rate caused to occur by a hose detachment, etc.

When the gas table 318, the gas heater with fan for combustion air and circulating 319, etc., is used in a living or a kitchen, if an incomplete combustion state occurs for some reason and CO gas leakage occurs, the CO gas sensor 321 of the CO alarm 20 detects it and the CPU 323 outputs a CO gas leakage signal to the gas shutoff device 312 as an alarm signal at an extremely low stage of the CO gas concentration level, for example, as a first-stage alarm signal.

When the CO gas leakage determination unit 329 detects the first-stage signal, the appliance estimation unit 330 compares the flow rate registration value, the flow rate pattern group stored in the flow rate storage unit 326, and the flow rate data group, the flow rate pattern group, and the registered flow rate in the appliance flow rate storage unit 331, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected.

If the CO gas leakage signal is first detected, unconditionally the flow rate pattern group and the registration flow rate are stored in the appliance flow rate storage unit 331 and for safety, a signal is output to the anomaly determination unit 332 as CO gas leakage appliance detection, the use time is measured, and the monitor time is shortened. For example, while the gas table 318 or the gas heater with fan for combustion air and circulating 319 is being used, the initial monitor time of 720 minutes can be shortened to 20 minutes, for example. The appliance number classified for each of the large flow rate area, the medium flow rate area, or the small flow rate area stored in the flow rate storage unit 326 is stored together. While the gas appliance is used, if the CO gas leakage determination unit 329 inputs the maximum nth-stage alarm signal of high CO concentration from the CO alarm, when the appliance estimation unit 330 outputs estimation output of use of CO gas leakage appliance to the anomaly determination unit, immediately the anomaly determination unit 332 outputs a shutoff signal to the shutoff unit 334.

When the appliance is stopped and is again used and likewise the CO gas leakage determination unit 329 detects a CO gas leakage signal, the appliance estimation unit 330 makes an estimation as to whether or not the gas appliance is a CO gas leakage appliance according to the data in the appliance flow rate storage unit 331 and, for example, correlation coefficient, etc., outputs a CO gas leakage appliance detection signal to the anomaly determination unit 332, and drastically limits the use time. When the appliance estimation unit 330 outputs the CO leakage appliance detection signal to the anomaly determination unit 332, a far short use time limit time is set taking precedence over the essential limit time of the monitor value setting unit 333. That is, if the gas leakage appliance repeats use and stop, the limit value of the continuously usable time of the appliance is set shorter in response to the number of repetitions.

At the same time, the center of the gas company is called through the communication unit 335 for providing notification that limit of the continuous use time has been executed because of CO gas leakage detection. In ordinary call, the code signal indicating the anomaly description and the flow rate classification are sent; in CO leakage, however, the CO leakage code indicating the CO leakage state, the appliance code, the CO alarm description (the concentration level of the first stage, the second stage, etc., is coded), the limit time, and the like are further sent. Ordinarily, the alarm signal at the concentration level of the first stage is a signal at an extremely low level having no effect on a human body.

When the CO gas concentration detected by the CO alarm 320 gradually rises, the signal changes to the second-stage, the third-stage alarm and is sent. When the signal is detected, the determination width of the correlation coefficient of the appliance flow rate pattern in the appliance estimation unit 330 is widened and estimation of the gas leakage appliance is facilitated and the monitor value of the continuous use time is further shortened for gradually shortening the remaining time. At the same time, the center is called for communications. If the gas concentration level rises in a stroke and an extremely dangerous alarm signal of the maximum concentration is input to the CO gas leakage determination unit 329, which then outputs the signal to the anomaly determination unit 332, which immediately outputs a shutoff signal to the shutoff unit 334 for stopping the gas supply and securing safety.

The numeric limits used in the embodiment are given by way of example and the use mode is not limited to the embodiment.

As described above, when the CO alarm 320 detects CO gas leakage and the CO gas leakage determination unit 329 of the gas shutoff device 312 determines that it is a first-stage alarm signal at a low CO gas concentration level, an estimation is made as to whether or not the appliance is a CO gas leakage appliance from the appliance flow rate registered in the appliance estimation unit 330, a time series signal of the appliance flow rate of the predetermined flow rate or more stored in the flow rate storage unit 326, and the data stored in the appliance flow rate storage unit 331; when it is estimated that the appliance is a CO gas leakage appliance, the use time counted and monitored by the anomaly determination unit 332 is limited and the classified and stored appliance number is reported to the center through the communication unit 335, whereby the gas company can be notified which appliance causes trouble to occur, safety of the gas appliance user is secured, danger to the life such as carbon monoxide poisoning caused by CO gas leakage is prevented, the appliance is easy to determine by reporting information of the appliance number, etc., to the center of the gas company, a safety measure can be taken at an early stage when the CO gas concentration level is low, and an extremely safe and highly reliable gas appliance use environment can be provided.

Next, a configuration wherein if a gas leakage determination signal from the CO gas leakage determination unit 29 does not exist, the use start of a gas leakage appliance is estimated by determining a flow rate pattern and a signal for again setting the limit value of the continuous use time in the shortening direction is output to the anomaly determination unit 32, a characteristic configuration of the invention, will be discussed below as Embodiment 7:

### Embodiment 7

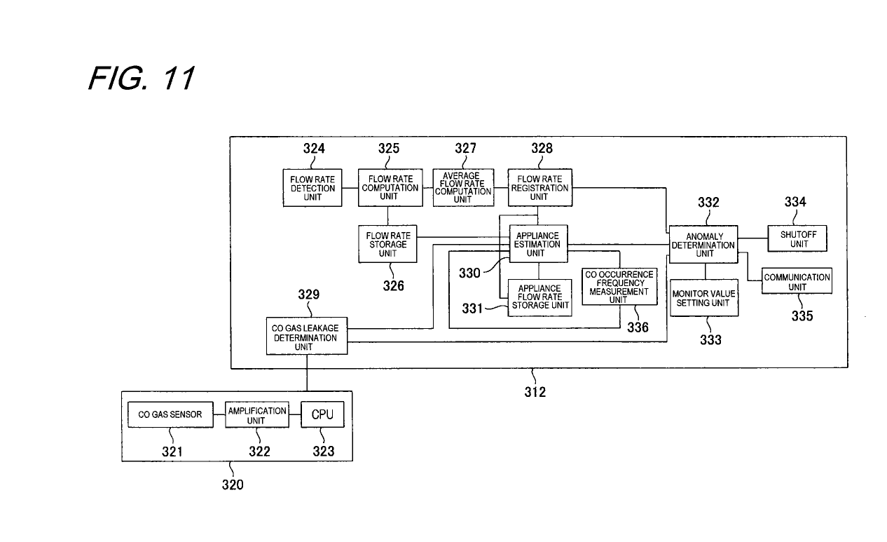

FIG. 11 is a control block diagram of a gas shutoff device in Embodiment 7 of the invention. Units that performs the same function as those in FIGS. 9 and 10 are denoted by the same numbers in FIG. 11.

In FIG. 11, in each home, gas is supplied to a gas table 318 installed in a kitchen and a gas heater with fan for combustion air and circulating 319 installed in a living, a bedroom, etc., and a CO alarm 320 is installed in the kitchen, the living, the bedroom, etc., for monitoring CO gas leakage.

In FIG. 11, when a CO gas leakage determination unit 329 determines a CO gas leakage signal from the CO alarm 320, an appliance estimation unit 330 counts as gas leakage frequency presence as an integrated flow rate data group from the flow rate pattern stored in flow rate storage unit 326 and the registration flow rate in flow rate registration unit 328 and when the count reaches the predetermined number of times, later, if a gas leakage determination signal from the CO gas leakage determination unit 329 does not exist, the appliance estimation unit 330 estimates the use start of gas leakage appliance by determining the flow rate pattern in the flow rate storage unit 326 and an appliance flow rate storage unit 331 and when it is estimated that the gas appliance is the gas leakage appliance, a CO occurrence frequency measurement unit 336 outputs a signal for again setting the limit value of the continuous use time in the shortening direction to an anomaly determination unit 332.

Next, the operation of the gas shutoff device of Embodiment 7 configured as described above will be discussed.

When a gas appliance possessed by a customer home, for example, such as the gas stove 319 or a gas water heater 314, is used, a flow rate detection unit 324 detects the flow rate. For example, to use ultrasonic sensors, the propagation time of an ultrasonic signal is measured as a detection value and the signal is sent to a flow rate computation unit 325 for calculating as an instantaneous flow rate value.

The flow rate storage unit 326 determines that the flow rate value of a predetermined flow rate or more is the appliance flow rate and associates the instantaneous flow rates of the appliance flow rate or more with each other in time series for storage. It stores them as a flow rate pattern group and also classifies the flow rate patterns for each flow rate area and gives the appliance number for storage.

The average flow rate computation unit 327 inputs an instantaneous flow rate value found in a predetermined period and gathers and averages a predetermined number of instantaneous flow rate values for calculating as an average flow rate value.

If the found average flow rate value is equal to or greater than a predetermined flow rate, a flow rate registration unit 328 registers as continuous use time monitor target as the appliance flow rate. Ordinarily, if the flow rate change width is equal to or greater than a predetermined flow rate with respect to the previous or N-times before flow rate value, the increment flow rate is registered as the appliance flow rate. If the flow rate decreases, it is determined that the appliance stops, and the flow rate registration value is deleted or changed.

The anomaly determination unit 332 references the monitor value stored in a monitor value setting unit 333, namely, the limit time value of the use time according to the flow rate classification to which the registration flow rate belongs, and counts and monitors the use time of the use appliance. On the other hand, concurrently, it also checks whether or not the flow rate value found by the average flow rate computation unit 327 before registered in the flow rate registration unit 328 exceeds the abnormal flow rate caused to occur by a hose detachment, etc.

When the gas table 318, the gas heater with fan for combustion air and circulating 319, etc., is used in a living or a kitchen, if an incomplete combustion state occurs for some reason and CO gas leakage occurs, a CO gas sensor 321 of the CO alarm 320 detects it and a CPU 323 outputs a CO gas leakage signal to the gas shutoff device 312 as an alarm signal at an extremely low stage of the CO gas concentration level, for example, as a first-stage alarm signal.

When the CO gas leakage determination unit 329 determines the first-stage signal, the appliance estimation unit 330 compares the flow rate registration value, the flow rate pattern group stored in the flow rate storage unit 326, and the flow rate data group, the flow rate pattern group, and the registered flow rate in the appliance flow rate storage unit 331, separates into blocks of flow rate patterns, and examines the correlation. It determines according to the flow rate rise, the peak flow rate, the flow rate value in a stable state, change flow rate gradient when the flow rate changes, etc., and makes an estimation as to whether or not it is the appliance flow rate when the CO gas leakage signal is detected.

The appliance is used and whenever the CO gas leakage is detected, the CO occurrence frequency measurement unit 336 measures the number of CO gas leakage occurrence times as the occurrence frequency in the flow rate pattern appliance estimated to be the CO gas leakage appliance by the appliance estimation unit 330.

If the CO gas leakage signal is first detected, the flow rate pattern group and the registration flow rate are stored in the appliance flow rate storage unit 331 and for safety, a signal is output to the anomaly determination unit 332 as gas leakage appliance detection, the use time is measured, and the monitor time is shortened. For example, while the gas table 318 or the gas heater with fan for combustion air and circulating 319 is being used, the initial monitor time of 720 minutes is shortened to 60 minutes, etc., for example, for shortening the remaining time.

When the appliance is stopped and is again used and likewise the CO gas leakage determination unit 329 detects a CO gas leakage signal, whenever the appliance estimation unit 330 makes an estimation as to whether or not the gas appliance is a gas leakage appliance according to the data in the appliance flow rate storage unit 331 and, for example, correlation coefficient, etc., the CO occurrence frequency measurement unit 336 measures the number of times. When the number of occurrence times becomes equal to or greater than a predetermined number of times, if a gas leakage signal from the gas leakage determination unit 329 does not exist, a gas leakage appliance detection signal is output to the anomaly determination unit 332 and the use time is drastically limited.

At the same time, the center of the gas company is called through a communication unit 335 to limit the use time because of gas leakage detection and appliance information of the appliance number of the appliance where an anomaly occurs or the like is also reported to the center. When the CO alarm 320 operates, the gas customer is warned using sound notification, etc., although not shown; if the warn is repeated, the customer may draw out the power supply line of the CO alarm 320 and consequently if leakage from a gas appliance occurs, the accident may be unable to be reported, but it can already be estimated as a flow rate pattern of the gas leakage appliance according to the gas flow rate data and the use time of the appliance can be limited drastically.

The alarm signal at the concentration level of the first stage is a signal at an extremely low level having no effect on a human body and at the early stage, the use time is limited, whereby safety can be secured.

The numeric limits used in the embodiment are given by way of example and the use mode is not limited to the embodiment.

As described above, when the CO alarm 320 detects CO gas leakage and the CO gas leakage determination unit 329 of the gas shutoff device 312 detects that it is a first-stage alarm signal at a low gas concentration level, an estimation is made as to whether or not the appliance is a gas leakage appliance from the appliance flow rate registered in the appliance estimation unit 330, a time series signal of the flow rate of the predetermined flow rate or more stored in the flow rate storage unit 326, and the data stored in the appliance flow rate storage unit 331, and the CO occurrence frequency measurement unit 336 counts the number of occurrence times; when the count reaches the predetermined number of times, if a gas leakage signal from the gas leakage determination unit 329 does not exist, it is estimated that the appliance is a gas leakage appliance according to a signal from the appliance estimation unit 330 and the continuous use time counted and monitored by the anomaly determination unit 332 is limited.

Accordingly, safety of the gas appliance user is secured, danger to a fire or the life caused by gas leakage is prevented, appliance information of the appliance number of the appliance determined to be abnormal by the appliance estimation unit 330 or the like can also be reported to the center of the gas company, the CO occurrence appliance is easy to determine, a safety measure can be taken at an early stage when the gas concentration level is low, and an extremely safe and highly reliable gas appliance use environment can be provided.

### Embodiment 8

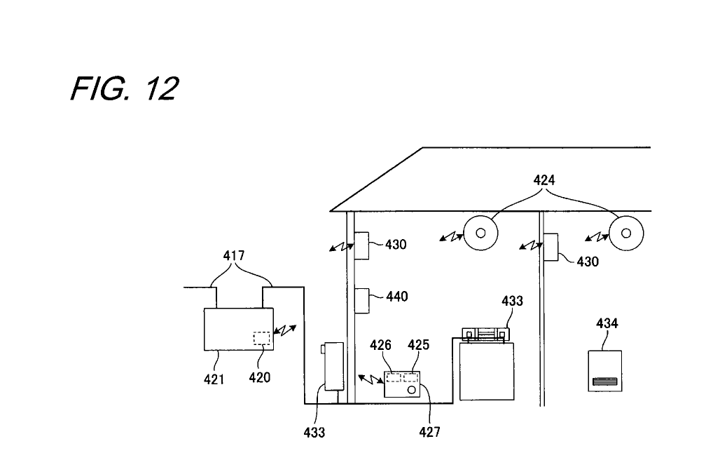

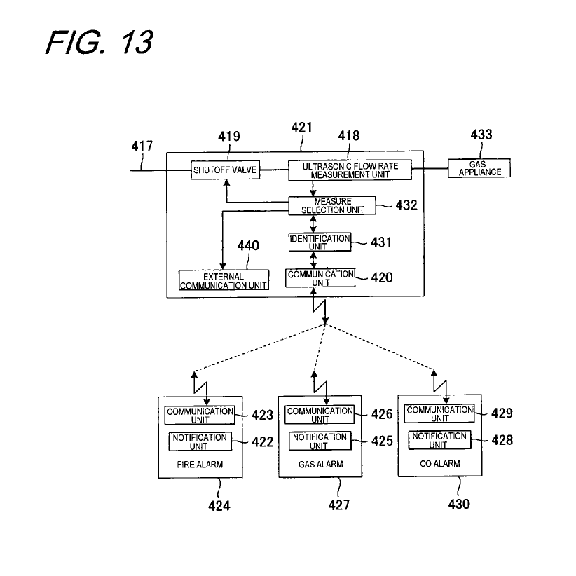

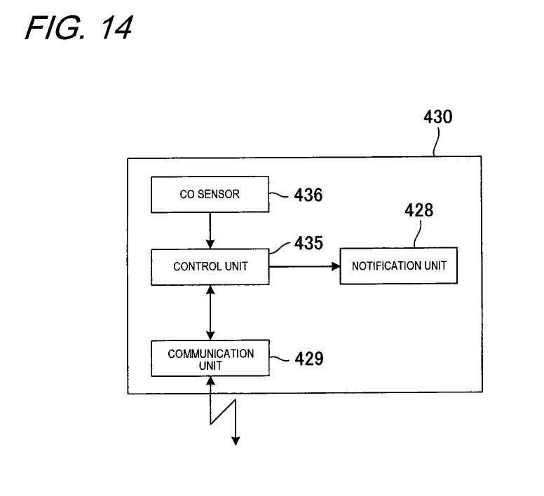

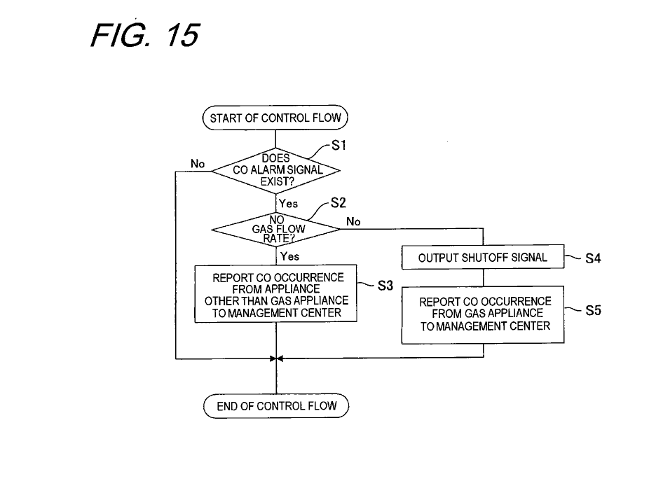

FIG. 12 is a configuration drawing of an alarm-compatible system meter in Embodiment 8 of the invention, FIG. 13 is a block diagram of the alarm-compatible system meter, FIG. 14 is a block diagram of a CO alarm, and FIG. 15 is a flowchart to show determination processing at the CO occurrence time, of the alarm-compatible system meter.

In FIGS. 12 and 13, the alarm-compatible system meter includes a gas meter 421 including an ultrasonic flow rate measurement unit 418 as flow rate measurement unit for measuring the flow rate of gas flowing into a flow path 417, a shutoff valve 419 as a gas shutoff unit for shutting off gas if an anomaly is detected, a communication unit 420 for conducting information communications with an external information detection unit, and an external communication unit 440 for conducting information communications with a remote management center, a fire alarm 424 including a notification unit 422 for detecting a fire and providing notification and a communication unit 423, a gas alarm 427 including a notification unit 425 for detecting a combustible fluid or a poisonous fluid and providing notification and a communication unit 426, and a CO alarm 430 including a notification unit 428 for detecting the concentration of carbon monoxide (hereinafter, described as CO) and providing notification and a communication unit 429, wherein the gas meter conducts information communications with at least any one or more alarms of the fire alarm 424, the gas alarm 427, and the CO alarm 430, identifies the alarm by an identification unit 431, and includes a measure selection unit 432 for selecting a measure by the gas meter 421 in response to the identification result. Numeral 433 denotes a gas appliance such as a gas water heater, a gas cooker, or a gas heater with fan for combustion air and circulating connected to the flow path 417, numeral 434 denotes an appliance other than a gas appliance, such as an FF-type oil burning space heater or an oil heater with fan for combustion air and circulating, and numeral 438 denotes a customer display for display various pieces of information.

If the gas meter 421 receives a signal from the CO alarm 430 shown in FIG. 14, the ultrasonic flow rate measurement unit 418 of the gas meter 421 determines the presence or absence of the gas use amount in an instant; if it is determined that gas is used, instantly the gas is shut off, whereby the gas can be shut off immediately and safety treatment with safety enhanced can be conducted. Using the ultrasonic flow rate measurement unit 418, if low-flow-rate gas is used, it can be determined in an instant and the gas can be shut off rapidly. Numeral 436 denotes a CO sensor.

The operation of the alarm-compatible system meter configured as described above will be discussed below as for determination at the CO occurrence time:

In FIG. 15, the measure selection unit 432 determines whether or not a signal from the CO alarm 430 exists at step (S) 1; if a signal exists, determines whether or not a gas flow rate exists according to a signal from the ultrasonic flow rate measurement unit 418 (S2) and if a gas flow rate exists, the process goes to S4. If a gas flow rate does not exist at S2, the measure selection unit 432 determines that CO occurs from any other appliance than a gas appliance, and reports information indicating CO occurrence from any other appliance than a gas appliance to the management center through the external communication unit 440 (S3). If a gas flow rate exists at S2, the measure selection unit 432 outputs a shutoff signal to the shutoff valve 419 (S4) for shutting off the gas, and reports information indicating CO occurrence from a gas appliance to the management center (S5).

As described above, in the embodiment, the external system is informed of CO occurrence of any other appliance than a gas appliance, whereby a rapid measure can be taken, so that a serious accident cab be prevented and safety can be enhanced.

### Embodiment 9

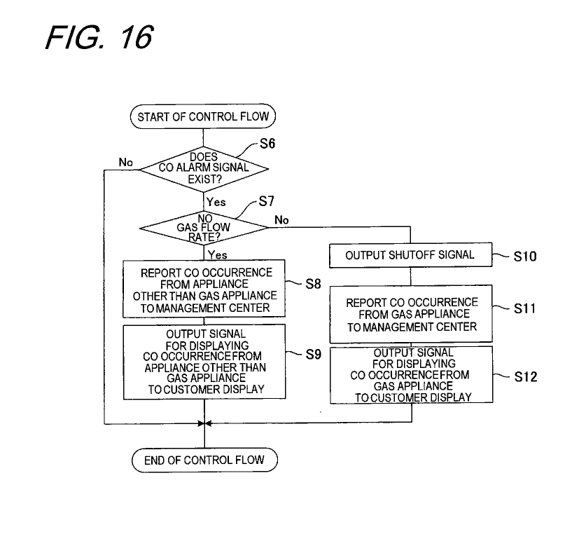

FIG. 16 is a flowchart to show determination processing at the CO occurrence time, of an alarm-compatible system meter in Embodiment 9 of the invention. It differs only in the measure selection unit 432 shown in FIG. 13 in Embodiment 8 and program, and a block diagram of the alarm-compatible system meter is identical with FIG. 13. That is, a measure selection unit 432 stores a program for executing a control flow of S6 to S12 shown in FIG. 16.

In FIG. 16, the measure selection unit 432 determines whether or not a signal from a CO alarm 430 exists at step (S6); if a signal exists, determines whether or not a gas flow rate exists according to a signal from an ultrasonic flow rate measurement unit 418 (S7) and if a gas flow rate exists, the process goes to S10. If a gas flow rate does not exist at S7, the measure selection unit 432 determines that CO occurs from any other appliance than a gas appliance, reports information indicating CO occurrence from any other appliance than a gas appliance to a management center through external communication unit 440 (S8), and outputs a signal for displaying CO occurrence from any other appliance than a gas appliance to a customer display 438 at S9. If a gas flow rate exists at S7, the measure selection unit 432 outputs a shutoff signal to a shutoff valve 419 (S10) for shutting off the gas, reports information indicating CO occurrence from a gas appliance to the management center (S11), and outputs a signal for displaying CO occurrence from a gas appliance to the customer display 438 at S12.

As described above, in the embodiment, a person staying in the home is informed of CO occurrence of any other appliance than a gas appliance, whereby a rapid measure can be taken, so that a serious accident cab be prevented and safety can be enhanced.

### Embodiment 10

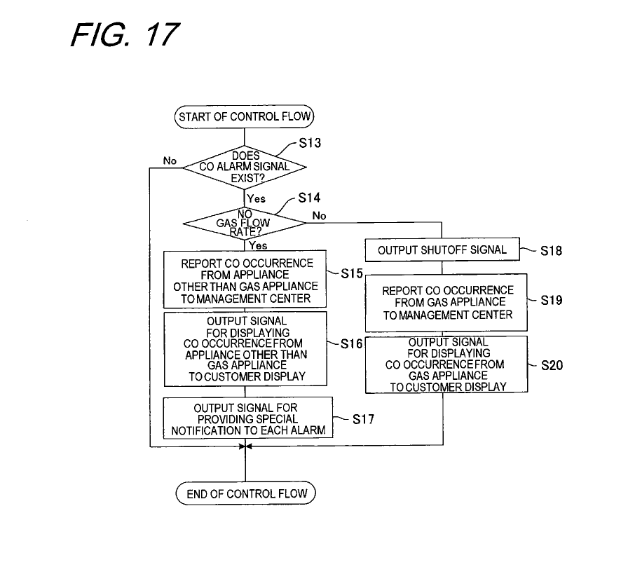

FIG. 17 is a flowchart to show determination processing at the CO occurrence time, of an alarm-compatible system meter in Embodiment 10 of the invention. It differs only in the measure selection unit 432 shown in FIG. 13 in Embodiment 8 and program, and a block diagram of the alarm-compatible system meter is identical with FIG. 13. That is, a measure selection unit 432 stores a program for executing a control flow of S13 to S20 shown in FIG. 17.

In FIG. 17, the measure selection unit 432 determines whether or not a signal from a CO alarm 30 exists at step (S13); if a signal exists, determines whether or not a gas flow rate exists according to a signal from an ultrasonic flow rate measurement unit 418 (S14) and if a gas flow rate exists, the process goes to S18. If a gas flow rate does not exist at S14, the measure selection unit 432 determines that CO occurs from any other appliance than a gas appliance, reports information indicating CO occurrence from any other appliance than a gas appliance to a management center through an external communication unit 440 (S15), outputs a signal for displaying CO occurrence from any other appliance than a gas appliance to a customer display 438 at S16, and outputs a signal for providing special notification to each alarm (S17). If a gas flow rate exists at S14, the measure selection unit 432 outputs a shutoff signal to a shutoff valve 419 (S18) for shutting off the gas, reports information indicating CO occurrence from a gas appliance to the management center (S19), and outputs a signal for displaying CO occurrence from a gas appliance to the customer display 438 at S20.

As described above, in the embodiment, a person staying in the home can be reliably informed of CO occurrence of any other appliance than a gas appliance from a large number of alarms and a rapid measure can be taken, so that a serious accident cab be prevented and safety can be enhanced.

### Embodiment 11

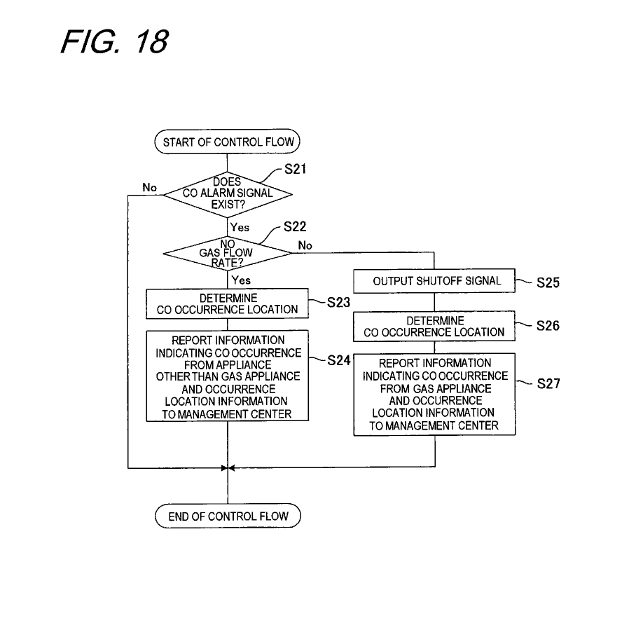

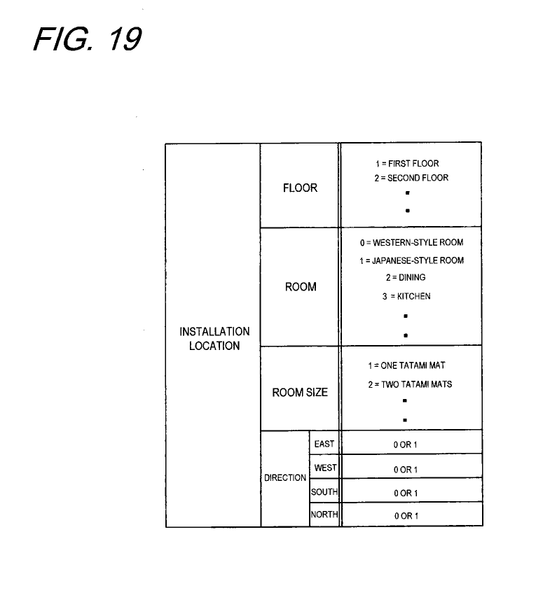

FIG. 18 is a flowchart to show determination processing at the CO occurrence time, of an alarm-compatible system meter in Embodiment 11 of the invention, and FIG. 19 is an installation location information configuration drawing of alarms for communicating at the operation time of each alarm. It differs only in the measure selection unit 432 shown in FIG. 13 in Embodiment 8 and program, and a block diagram of the alarm-compatible system meter is identical with FIG. 13. That is, a measure selection unit 432 stores a program for executing a control flow of S21 to S27 shown in FIG. 18.

In FIG. 18, the measure selection unit 432 determines whether or not a signal from a CO alarm 430 exists at step (S21); if a signal exists, determines whether or not a gas flow rate exists according to a signal from an ultrasonic flow rate measurement unit 418 (S22) and if a gas flow rate exists, the process goes to S25. If a gas flow rate does not exist at S22, the measure selection unit 432 determines that CO occurs from any other appliance than a gas appliance, and determines the CO occurrence location from the installation location information of the alarm contained in the signal from the CO alarm 430 (S23). It reports information indicating CO occurrence from any other appliance than a gas appliance and the CO occurrence location information to a management center through an external communication unit 440 (S24). If a gas flow rate exists at S22, the measure selection unit 432 outputs a shutoff signal to a shutoff valve 419 (S25) for shutting off the gas, and determines the CO occurrence location from the installation location information of the alarm contained in the signal from the CO alarm 430 (S26). It reports information indicating CO occurrence from a gas appliance and the CO occurrence location information to the management center (S27).

In the embodiment, the operation at the CO occurrence time has been described, but it is also made possible to determine the occurrence location more reliably using the alarm installation location information at the operation time of a fire alarm 424 or at the operation time of a gas alarm 427. As for information concerning the directions of the alarm installation location information in FIG. 19, not only four directions of north, south, east, and west, but also eight directions can be represented without increasing information by setting information of north and east to 1 for northeast, for example, and the location can be determined further finely.

As described above, in the embodiment, where CO of any other appliance than a gas appliance occurs can be determined and it is also made possible to reliably inform the external system of the fact and an appropriate measure can be taken, so that a serious accident cab be prevented and safety can be enhanced.

### Embodiment 12

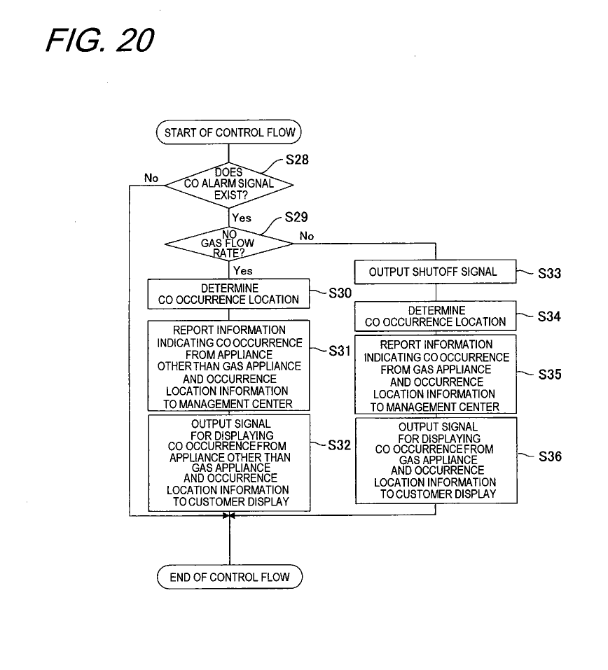

FIG. 20 is a flowchart to show determination processing at the CO occurrence time, of an alarm-compatible system meter in Embodiment 12 of the invention. It differs only in the measure selection unit 432 shown in FIG. 13 in Embodiment 8 and program, and a block diagram of the alarm-compatible system meter is identical with FIG. 13. That is, a measure selection unit 432 stores a program for executing a control flow of S28 to S36 shown in FIG. 20.

In FIG. 20, the measure selection unit 432 determines whether or not a signal from a CO alarm 430 exists at step (S28); if a signal exists, determines whether or not a gas flow rate exists according to a signal from an ultrasonic flow rate measurement unit 418 (S29) and if a gas flow rate exists, the process goes to S33. If a gas flow rate does not exist at S29, the measure selection unit 432 determines that CO occurs from any other appliance than a gas appliance, and determines the CO occurrence location from the installation location information of the alarm contained in the signal from the CO alarm 30 (S30). It reports information indicating CO occurrence from any other appliance than a gas appliance and the CO occurrence location information to a management center through an external communication unit 440 (S31), and outputs a signal for displaying CO occurrence from any other appliance than a gas appliance and CO occurrence location to a customer display 438 at S32. If a gas flow rate exists at S29, the measure selection unit 432 outputs a shutoff signal to a shutoff valve 419 (S33) for shutting off the gas, and determines the CO occurrence location from the installation location information of the alarm contained in the signal from the CO alarm 430 (S34). It reports information indicating CO occurrence from a gas appliance and the CO occurrence location information to the management center (S35), and outputs a signal for displaying CO occurrence from a gas appliance and CO occurrence location to a customer display 438 at S36.

As described above, in the embodiment, where CO of any other appliance than a gas appliance occurs can be determined and it is also made possible to reliably inform a person staying in the home of the occurrence location and an appropriate measure can be taken, so that a serious accident cab be prevented and safety can be enhanced.

### Embodiment 13

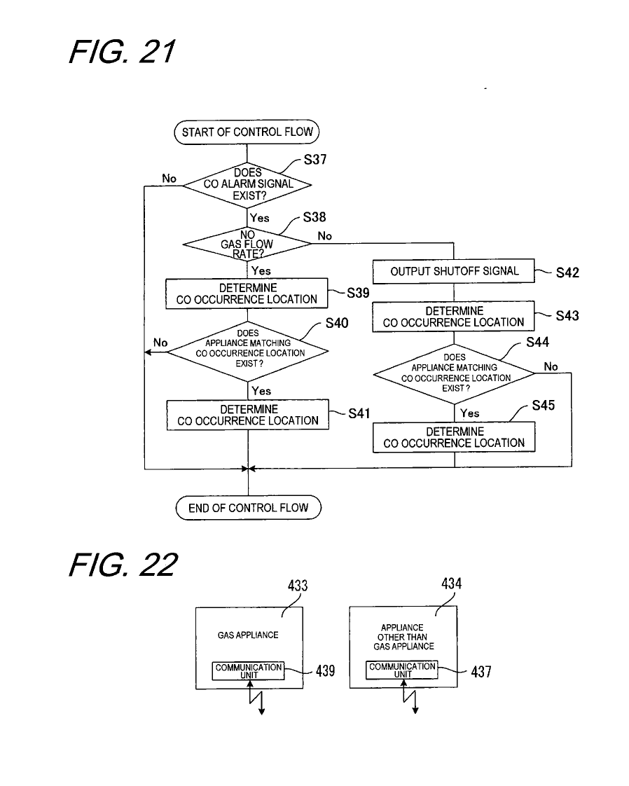

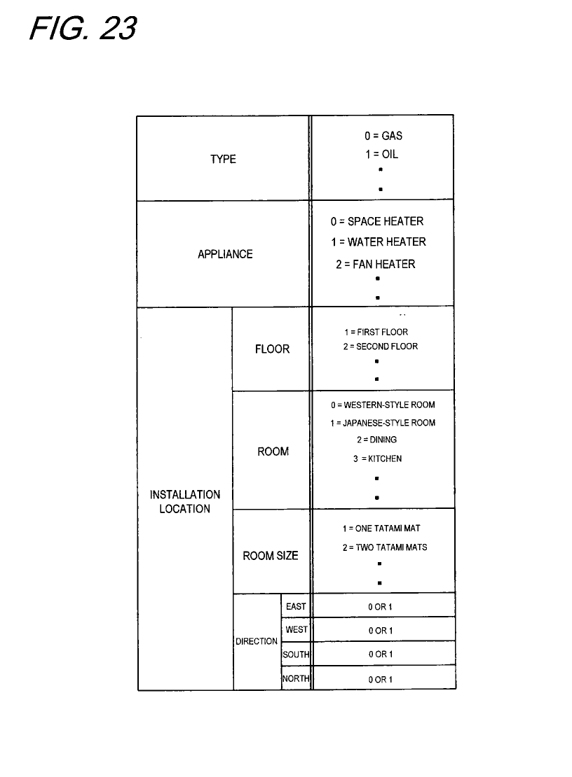

FIG. 21 is a flowchart to show determination processing at the CO occurrence time, of an alarm-compatible system meter in Embodiment 13 of the invention, FIG. 22 is block diagrams of a gas appliance including a communication unit and an appliance including a communication unit other than a gas appliance, and FIG. 23 is an installation location information configuration drawing of appliances for communicating with the alarm-compatible system meter. It differs only in the measure selection unit 432 shown in FIG. 13 in Embodiment 8 and program, and a block diagram of the alarm-compatible system meter is identical with FIG. 13. That is, a measure selection unit 432 stores a program for executing a control flow of S37 to S45 shown in FIG. 21.

In FIG. 21, the measure selection unit 432 determines whether or not a signal from a CO alarm 430 exists at step (S37); if a signal exists, determines whether or not a gas flow rate exists according to a signal from an ultrasonic flow rate measurement unit 418 (S38) and if a gas flow rate exists, the process goes to S42. If a gas flow rate does not exist at S38, the measure selection unit 432 determines that CO occurs from an appliance 434 other than a gas appliance shown in FIG. 22, and determines the CO occurrence location from the installation location information of the alarm (see FIG. 23) contained in the signal from the CO alarm 430 (S39). At S40, a comparison is made between the appliance installation location information (see FIG. 23) from a gas appliance 433 shown in FIG. 22 and the appliance 434 other than a gas appliance and the CO occurrence location determined at S39 to determine whether or not there is a match appliance, and it is determined that the match appliance is the CO occurrence appliance (S41). If a gas flow rate exists at S38, the measure selection unit 432 outputs a shutoff signal to a shutoff valve 419 (S42) for shutting off the gas, and determines the CO occurrence location from the installation location information of the alarm (see FIG. 23) contained in the signal from the CO alarm 430 (S43). At S44, a comparison is made between the appliance installation location information (see FIG. 23) from the gas appliance 433 and the appliance 434 other than a gas appliance and the CO occurrence location determined at S43 to determine whether or not there is a match appliance, and it is determined that the match appliance is the CO occurrence appliance (S45).

In the embodiment, determination of the CO occurrence appliance has been described; however, if the CO occurrence appliance cannot be determined, namely, if no appliance exists in the CO occurrence location, a movable appliance such as an oil heater with fan for combustion air and circulating also exists and thus processing of reporting the CO occurrence location information to the management center, displaying on a customer display, etc., is executed, so that safety equal to or more than the conventional safety can be secured. Appliance operation information is added to the appliance installation location information, whereby it is made possible to determine the CO occurrence appliance more precisely.

As described above, in the embodiment, which appliance CO occurrence is caused to occur by can be determined, whereby a reliable measure method can be known, so that a serious accident cab be prevented and safety can be enhanced.

### Embodiment 14

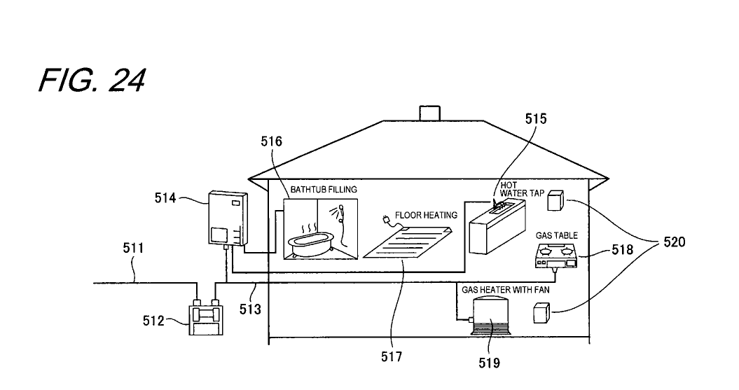

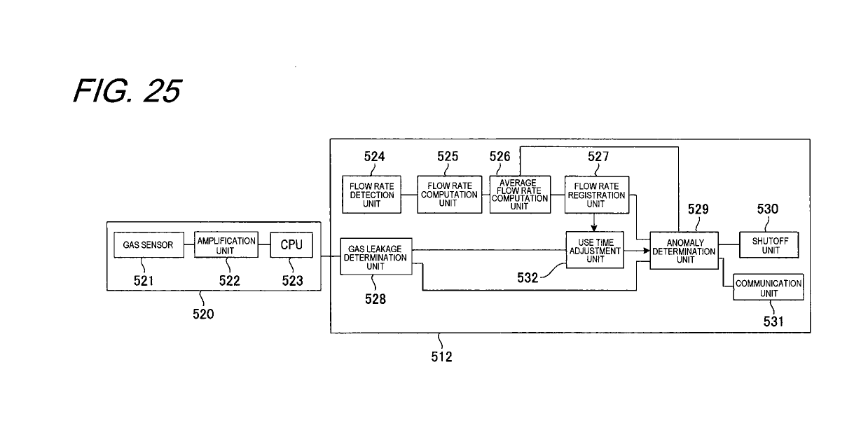

FIG. 24 is a drawing to show an installation mode of a gas shutoff device and gas appliances in Embodiment 14 of the invention, and FIG. 25 is a control block diagram of the gas shutoff device.

A gas shutoff device 512 is installed in the entry portion of a gas supply pipe 511 of each home and a branch is made from gas piping 513 after passing through the gas shutoff device 512 to places where various gas appliances used in the home are installed for supplying gas. For example, a gas water heater 514 is installed outdoors and warm water generated by the gas water heater 514 is supplied through water piping to a hot water tap 515 in a kitchen, a bath 516 where a bathtub and a shower are installed, and floor heating 517 installed in a living, etc., to form various use modes.

Indoors, gas is supplied to a gas table 518 installed in a kitchen and a gas heater with fan for combustion air and circulating 519 installed in a living, a bedroom, etc., and a CO alarm 520 is installed in the kitchen, the living, the bedroom, etc., for monitoring gas leakage.

When each installed gas appliance is used and consumption of gas occurs, the gas shutoff device 512 measures the use amount and cumulatively stores the data every predetermined time period. The data stored in the gas shutoff device 512 undergoes predetermined information processing based on a periodic data request command from a gas company and then is transmitted to the customer and the gas company as information of the gas rate, the gas use amount, or discount service, etc., provided by the gas company.

FIG. 25 is a control block diagram of the alarm 520 connected to the gas shutoff device 512. By way of example, the alarm 520 is made up of a gas sensor 521 for detecting gas and changing in the signal level in response to the concentration level, an amplification unit 522 for amplifying the signal, and a CPU 523 for processing the amplified signal. The alarm 520 is connected through a terminal block, etc., of the gas shutoff device 512. The alarm 520 outputs a code signal and an analog signal to the gas shutoff device 512 in response to a rise in the gas concentration level.

The gas shutoff device 512 is one configuration example to accomplish an object of the invention. Numeral 524 denotes a flow rate detection unit for measuring the gas flow rate. Various types of flow rate detection units 524 are available; as means shown in the embodiment, one of a pair of ultrasonic sensors installed in a flow path emits an ultrasonic signal to the other and the use gas flow rate is detected according to the propagation time; means provided with a hot wire sensor in a flow path for finding the flow rate according to the impedance changing according to a flow is available; and further means for detecting the gas amount using a measuring membrane and converting the mechanical operation of the measuring membrane into an electric pulse signal by a magnet and a lead switch or a magnetoresistive element, etc., for detecting the flow rate is available.

For example, the flow rate detection unit 524 using the ultrasonic sensors will be discussed briefly. A first transceiver for transmitting or receiving an ultrasonic wave and a second transceiver for receiving or transmitting an ultrasonic wave are opposed in the flowing direction and an ultrasonic signal is transmitted from upstream to downstream or from downstream to upstream every predetermined period for measuring the propagation time. The size of the flow path and the flow state of a fluid are considered from the propagation time difference of the ultrasonic wave between the first transceiver and the second transceiver and a flow rate computation unit 525 finds an instantaneous flow rate value.

Numeral 526 denotes an average flow rate computation unit, to which an instantaneous flow rate value found in a predetermined period is input, and a predetermined number of instantaneous flow rate values are gathered and averaged and calculated as an average flow rate value. Numeral 527 denotes a flow rate registration unit; if the found average flow rate value is equal to or greater than a predetermined flow rate, a flow rate registration unit 527 registers as use time monitor target as the appliance flow rate. Ordinarily, if the flow rate change width is equal to or greater than a predetermined flow rate with respect to the previous or N-times before flow rate value, the increment flow rate is registered as the appliance flow rate.

Numeral 528 denotes a gas leakage determination unit for determining a signal responsive to the gas concentration level in a room installed from the alarm 520 and for determining what level the signal is at. The gas leakage determination unit 528 receives and processes an analog signal, receives the signal as a communication signal, or receives the signal as a digital signal provided by coding the concentration level.

Numeral 529 denotes an anomaly determination unit for monitoring each use appliance. The anomaly determination unit 529 stores the appliance continuous use limit time corresponding to each flow rate area according to the registration flow rate in the flow rate registration unit 527 or the monitor determination value of the use maximum flow rate, etc. For example, when a hose for supplying gas to a stove, etc., is detached for some reason, an abnormally large flow rate occurs. A total flow rate shutoff value to monitor such a state and the use time shutoff limit time stipulating the limit time of the use time corresponding to the case where the appliance has been used far longer than the maximum use time of the ordinary use of the appliance are set. The anomaly determination unit 529 makes a comparison determination of the setup value and the registration flow rate value in the flow rate registration unit 527, thereby determining whether or not the registration flow rate value exceeds the use maximum flow rate value, whether or not the appliance use time exceeds the appliance continuous use limit time corresponding to the registration flow rate value, or the like. When an anomaly is determined in the anomaly determination unit 529, a shutoff signal is sent to the shutoff unit 530 for stopping the gas supply. The shutoff state and the shutoff description are displayed on a liquid crystal device, etc., and are also sent to a center for conducting gas safety monitor through a communication unit 531, etc.

Numeral 532 denotes a use time adjustment unit. When the appliance flow rate is registered in the flow rate registration unit 527 and the anomaly determination unit 529 monitors the use time, when a gas leakage signal is input to the gas leakage determination unit 528, the use time is adjusted according to the gas concentration level. Whenever the use time is adjusted, the monitor center (not shown) of the gas company is called through the communication unit 531 for providing notification that limit of the use time has been changed according to the gas leakage signal. If an alarm signal at the highest concentration level is output from the gas leakage determination unit 528, the alarm signal is output to the anomaly determination unit 529 and immediately a shutoff unit 530 is driven.

Next, the operation of the gas shutoff device configured as described above will be discussed. When a gas appliance possessed by a customer home, for example, such as the gas stove 519 or the gas water heater 514, is used, the flow rate detection unit 524 detects the flow rate. For example, to use the ultrasonic sensors, the propagation time of an ultrasonic signal is measured as a detection value and the signal is sent to the flow rate computation unit 525 for calculating as an instantaneous flow rate value, and the average flow rate computation unit 526 computes as an average flow rate value every predetermined number of instantaneous flow rate values, and the found average flow rate is registered in the flow rate registration unit 527 as appliance use is determined if flow rate change of a predetermined flow rate or more occurs.

The anomaly determination unit 529 references the stored monitor value, namely, the limit time value of the use time according to the flow rate classification to which the registration flow rate belongs, and monitors the use appliance. Or, concurrently, it also checks whether or not the flow rate value found by the average flow rate computation unit 526 before registered in the flow rate registration unit 527 exceeds the abnormal flow rate caused to occur by a hose detachment, etc. When the gas table 518, the gas heater with fan for combustion air and circulating 519, etc., is used, if gas leakage occurs because of deterioration of the rubber hose, etc., and the gas sensor 521 of the alarm 520 detects it, the CPU 523 outputs a first-stage signal to the gas shutoff device 512. When the CO gas leakage determination unit 528 detects the first-stage signal, for example, while the gas table 518 or the gas heater with fan for combustion air and circulating 519 is being used, the remaining time of the initial monitor time of 720 minutes is shortened to 30 minutes, etc., for example. At the same time, the center of the gas company is called through the communication unit 531 for providing notification that limit of the use time has been executed because of gas leakage detection. Ordinarily, the alarm signal at the concentration level of the first stage is a signal at an extremely low level having no effect on a human body. When the gas concentration detected by the alarm 20 gradually rises, the signal changes to the second-stage, the third-stage alarm and is sent. Accordingly, the remaining time of the use time is gradually shortened. The alarm signal is input and the use time is shortened and the center is also called for communications. If the gas concentration level rises in a stroke and an extremely dangerous alarm signal of the maximum concentration is input to the gas leakage determination unit 528, the use time adjustment unit 532 restores the adjustment time to 0 and outputs signal to the anomaly determination unit 529, which immediately a shutoff signal to the shutoff unit 530 for stopping the gas supply and securing safety.

The numeric limits used in the embodiment are given by way of example and the use mode is not limited to the embodiment.

As described above, when the alarm 520 detects gas leakage, the gas leakage determination unit 528 of the gas shutoff device 512 shortens the use time of the flow rate registered in the flow rate registration unit 527 as the flow rate and monitored through the use time adjustment unit 532 in response to the signal of the gas concentration level and the fact is reported to the center of the gas company, whereby the gas company or the gas customer can be allowed to take a safety measure at an early stage when the gas concentration level is low, and extreme safety and high ease of use are provided.

### Embodiment 15

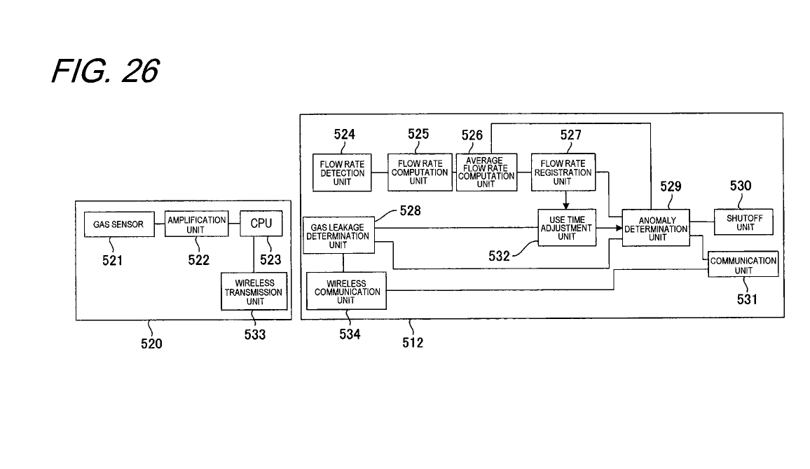

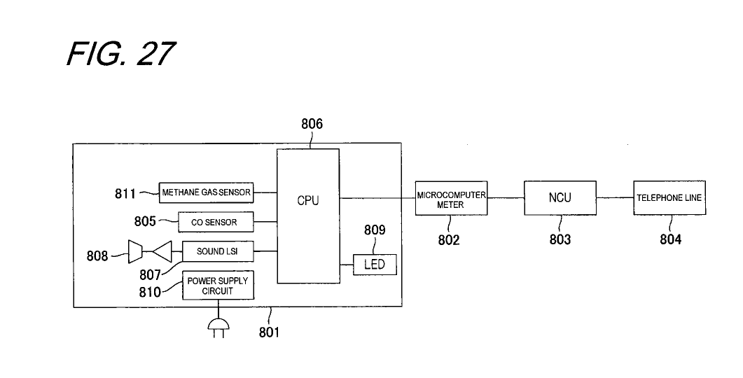

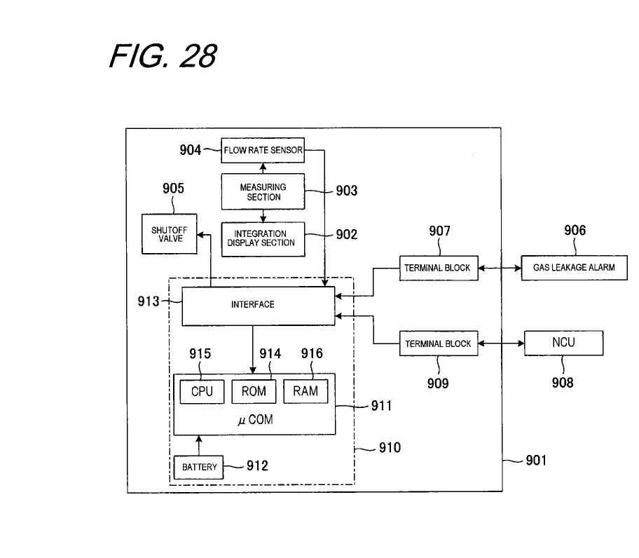

FIG. 26 is a control block diagram of a gas shutoff device in Embodiment 15 of the invention. Units that perform the same function as those in FIGS. 24 and 25 are denoted by the same numbers in FIG. 26.

In FIG. 26, in each home, gas is supplied to a gas table 518 installed in a kitchen and a gas heater with fan for combustion air and circulating 519 installed in a living, a bedroom, etc., and an alarm 520 is installed in the kitchen, the living, the bedroom, etc., for monitoring gas leakage.

In the alarm 520, as an example, numeral 533 denotes a wireless transmission unit and when a gas sensor 521 detects gas and outputs a signal level in response to the concentration level, an amplification unit 522 amplifies the signal and then a CPU 523 performs output signal processing responsive to the concentration level and transmits an alarm signal through the wireless transmission unit 533. Numeral 534 denotes a wireless communication unit, which is installed separately from a gas shutoff device 512, is contained therein, or is integrated. When the wireless communication unit 534 receives a gas leakage alarm signal from the alarm 520, it can output the signal to a gas leakage determination unit 528 or can report the signal to the center of the gas company through communication unit 531 of the gas shutoff device 512.

Next, the operation of the gas shutoff device configured as described above will be discussed. When a gas appliance possessed by a customer home, for example, such as the gas stove 519 or the gas water heater 514, is used, the flow rate detection unit 524 detects the flow rate. For example, to use the ultrasonic sensors, the propagation time of an ultrasonic signal is measured as a detection value and the signal is sent to the flow rate computation unit 525 for calculating as an instantaneous flow rate value, and the average flow rate computation unit 526 computes as an average flow rate value every predetermined number of instantaneous flow rate values, and the found average flow rate is registered in the flow rate registration unit 527 as appliance use is determined if flow rate change of a predetermined flow rate or more occurs.

The anomaly determination unit 529 references the stored monitor value, namely, the limit time value of the use time according to the flow rate classification to which the registration flow rate belongs, and monitors the use appliance. Or, concurrently, it also checks whether or not the flow rate value found by the average flow rate computation unit 526 before registered in the flow rate registration unit 27 exceeds the abnormal flow rate caused to occur by a hose detachment, etc. When the gas table 518, the gas heater with fan for combustion air and circulating 519, etc., is used, if gas leakage occurs because of deterioration of the rubber hose, etc., and the gas sensor 521 of the alarm 520 detects it, the amplification unit 522 amplifies the signal and the CPU 523 processes as gas leakage alarm detection and outputs a first-stage signal to the gas shutoff device 512 through the wireless transmission unit 533. Upon reception of the first-stage signal as the gas leakage alarm, the wireless communication unit 534 of the gas shutoff device 512 outputs the first-stage signal to the CO gas leakage determination unit 528. When the CO gas leakage determination unit 528 detects the gas leakage signal, for example, while the gas table 518 or the gas heater with fan for combustion air and circulating 519 is being used, the remaining time of the initial monitor time of 720 minutes is shortened to 30 minutes, etc., for example. At the same time, the center of the gas company is called through the communication unit 531 for providing notification that limit of the use time has been executed because of gas leakage detection. Ordinarily, the alarm signal at the concentration level of the first stage is a signal at an extremely low level having no effect on a human body. When the gas concentration detected by the alarm 520 gradually rises, the signal changes to the second-stage, the third-stage alarm and is sent. Accordingly, the remaining time of the use time is gradually shortened. The alarm signal is input and the use time is shortened and the center is also called for communications. If the gas concentration level rises in a stroke and an extremely dangerous alarm signal of the maximum concentration is input to the gas leakage determination unit 528, the use time adjustment unit 532 restores the adjustment time to 0 and outputs signal to the anomaly determination unit 529, which immediately a shutoff signal to the shutoff unit 530 for stopping the gas supply and securing safety.

The numeric limits used in the embodiment are given by way of example and the use mode is not limited to the embodiment.

As described above, when the alarm 520 adopting the wireless gas leakage notification system detects gas leakage, a gas leakage communication signal is received at the wireless communication unit 534 of the gas shutoff device 512 and is transmitted to the gas leakage determination unit 528, which then shortens the use time of the flow rate registered in the flow rate registration unit 527 as the flow rate and monitored through the use time adjustment unit 532 in response to the signal of the gas concentration level and the fact is reported to the center of the gas company, whereby the gas company or the gas customer can be allowed to take a safety measure at an early stage when the gas concentration level is low, and extreme safety and high ease of use are provided.

While the invention has been described in detail with reference to the specific embodiments, it will be obvious to those skilled in the art that various changes and modifications can be made without departing from the spirit and the scope of the invention.

This application is based on Japanese Patent Application (No. 2008-044968) filed on Feb. 26, 2008, Japanese Patent Application (No. 2008-044970) filed on Feb. 26, 2008, Japanese Patent Application (No. 2008-044972) filed on Feb. 26, 2008, Japanese Patent Application (No. 2008-044973) filed on Feb. 26, 2008, and Japanese Patent Application (No. 2008-044974) filed on Feb. 26, 2008, which are incorporated herein by reference.

### INDUSTRIAL APPLICABILITY

Upon detection of gas leakage, the gas shutoff device according to the invention determines the gas leakage appliance and can appropriately provide the use limit function of the monitored gas flow rate appliance and can be applied to general appliance monitors.

The alarm-compatible system meter according to the invention can determine the anomaly occurrence location according to installation location information of not only the CO alarm, but also the fire alarm and the gas alarm and thus can also be applied to abnormal state occurrence of smoking, ignition, etc., caused by an electric appliance anomaly.

1. A gas shutoff device for monitoring the use state of a gas appliance connected to piping after passing through a gas meter and limiting the use condition of the gas appliance in accordance with a signal from a CO alarm, wherein
the gas meter comprises a flow rate detection unit for measuring the gas flow rate, a flow rate computation unit for finding an instantaneous flow rate value from the detection value of said flow rate detection unit, a flow rate storage unit for storing the instantaneous flow rate values found by said flow rate computation unit in association with each other in time series as a flow rate pattern, an average flow rate computation unit for averaging the instantaneous flow rate values found by said flow rate computation unit to find an average flow rate value, a flow rate registration unit for registering the flow rate value when it is determined that the flow rate is the appliance flow rate from the average flow rate value found by said average flow rate computation unit, a CO gas leakage determination unit for making a determination in accordance with a detection signal from the CO alarm and outputting a determination signal responsive to the CO concentration level, appliance estimation unit for reading the flow rate pattern in said flow rate storage unit, estimating a CO leakage appliance, and outputting a signal for setting the limit value of the continuously usable time in a shortening direction when the appliance flow rate is registered in said flow rate registration unit and said CO gas leakage determination unit outputs the determination signal, an appliance flow rate storage unit for storing the data in said flow rate storage unit read by said appliance estimation unit together with the appliance flow rate, an anomaly determination unit for changing the limit value of the continuously usable time of the appliance and determining whether or not an anomaly exists according to the signals from said flow rate registration unit, said appliance estimation unit, and said CO gas leakage determination unit, a shutoff unit for shutting off gas supply when an anomaly occurs, and a communication unit for reporting various pieces of appliance information, and wherein
said gas shutoff device has a monitor mode of limiting the use condition of the appliance and monitoring and a shutoff mode of outputting a shutoff signal in an instant in response to the determination signal of said CO gas leakage determination unit.

2. The gas shutoff device as claimed in claim 1 wherein when a CO gas leakage signal is first detected, unconditionally said appliance estimation unit executes the monitor mode and stores various pieces of data in said appliance flow rate storage unit.

3. The gas shutoff device as claimed in claim 1 wherein said appliance estimation unit sets the limit value of the continuously usable time of the appliance in the shortening direction in response to the determination signal output as the CO concentration increases from a first-stage signal where the CO concentration is low to the maximum nth-stage signal where the CO concentration is high, output by said CO gas leakage determination unit.

4. The gas shutoff device as claimed in claim 1 wherein when the maximum nth-stage determination signal where the CO concentration is high is output from said CO gas leakage determination unit, said appliance estimation unit outputs a signal for closing said shutoff unit through said anomaly determination unit.

5. The gas shutoff device as claimed in claim 1 wherein if the CO leakage appliance repeats use and stop, said appliance estimation unit sets the limit value of the continuously usable time of the appliance in the shortening direction in response to the number of repetitions.

6. (canceled)

7. A gas shutoff device comprising a CO alarm for monitoring the presence or absence of carbon monoxide gas occurrence, a flow rate detection unit for measuring the gas flow rate, a flow rate computation unit for computing the flow rate value from the detection value of said flow rate detection unit, a flow rate storage unit for classifying the flow rates found by said flow rate computation unit and storing the flow rates, an average flow rate computation unit for averaging the instantaneous flow rate values found by said flow rate computation unit to find an average flow rate value, a flow rate registration unit for registering the flow rate when it is determined that the flow rate is the appliance flow rate from the average flow rate found by said average flow rate computation unit, a CO gas leakage determination unit for inputting an output signal responsive to the concentration level of carbon monoxide gas from said CO alarm, an appliance estimation unit for storing a signal output by said CO gas leakage determination unit, a flow rate pattern group stored in said flow rate storage unit when a flow rate is registered in said flow rate registration unit and the registered flow rate, and for outputting a signal of shortening and setting the use time limit time by estimating a CO gas leakage appliance, an appliance flow rate storage unit for storing, when said appliance estimation unit determines that the appliance is a CO leakage appliance, the output signal of said CO gas leakage determination unit and the flow rate pattern group stored in said flow rate storage unit when the flow rate is registered in said flow rate registration unit, an anomaly determination unit for monitoring an abnormal state of the use appliance and determining whether or not an anomaly exists according to the registered flow rate from said flow rate registration unit and the signal from said CO gas leakage determination unit, a shutoff unit for shutting off gas supply when said anomaly determination unit determines that an anomaly exists, and a communication unit for reporting appliance information if said appliance estimation unit determines the CO leakage appliance.

8. A gas shutoff device comprising a CO alarm for monitoring the presence or absence of carbon monoxide gas occurrence, a flow rate detection unit for measuring the gas flow rate, a flow rate computation unit for computing the flow rate value from the detection value of said flow rate detection unit, a flow rate storage unit for classifying the flow rates found by said flow rate computation unit and storing the flow rates, an average flow rate computation unit for averaging the instantaneous flow rate values found by said flow rate computation unit to find an average flow rate value, a flow rate registration unit for registering the flow rate when it is determined that the flow rate is the appliance flow rate from the average flow rate found by said average flow rate computation unit, a CO gas leakage determination unit for inputting an output signal responsive to the concentration level of carbon monoxide gas from said CO alarm, an appliance estimation unit, for storing a signal output by said CO gas leakage determination unit, a flow rate pattern group stored in said flow rate storage unit when a flow rate is registered in said flow rate registration unit and the registered flow rate, for outputting a signal for shortening and setting the use time limit time by estimating a CO gas leakage appliance, an occurrence frequency measurement unit for measuring the occurrence frequency of a flow rate data group corresponding to the appliance estimated by said appliance estimation unit, determining the CO gas leakage appliance, and outputting, an appliance flow rate storage unit for storing, when said appliance estimation unit determines that the appliance is a CO leakage appliance, the output signal of said CO gas leakage determination unit and the flow rate pattern group stored in said flow rate storage unit when the flow rate is registered in said flow rate registration unit, an anomaly determination unit for monitoring an abnormal state of the use appliance and determining whether or not an anomaly exists according to the registered flow rate from said flow rate registration unit and the signal from said CO gas leakage determination unit, a shutoff unit for shutting off gas supply when said anomaly determination unit determines that an anomaly exists, and a communication unit for reporting appliance information if said appliance estimation unit determines the CO leakage appliance.

9. (canceled)

10. A gas shutoff device comprising a CO alarm for monitoring the presence or absence of carbon monoxide gas occurrence, a flow rate detection unit for measuring the gas flow rate, a flow rate computation unit for computing the flow rate value from the detection value of said flow rate detection unit, a flow rate storage unit for classifying the flow rates found by said flow rate computation unit and storing the flow rates, an average flow rate computation unit for averaging the instantaneous flow rate values found by said flow rate computation unit to find an average flow rate value, a flow rate registration unit for registering the flow rate when it is determined that the flow rate is the appliance flow rate from the average flow rate found by said average flow rate computation unit, an anomaly determination unit for monitoring the use time of the flow rate registered in said flow rate registration unit and the total flow rate, a CO gas leakage determination unit for inputting an output signal responsive to the concentration level of carbon monoxide gas from said CO alarm, an appliance estimation unit, for storing a signal output by said CO gas leakage determination unit, a flow rate pattern group stored in said flow rate storage unit when the flow rate is registered in said flow rate registration unit and the registered flow rate, and for outputting a signal for shortening and setting the use time limit time by estimating a CO gas leakage appliance, an appliance flow rate storage unit for storing, when said appliance estimation unit determines that the appliance is a CO leakage appliance, the output signal of said CO gas leakage determination unit and the flow rate pattern group stored in said flow rate storage unit when the flow rate is registered in said flow rate registration unit, a CO anomaly determination unit for monitoring an abnormal state of the use appliance and determining whether or not an anomaly exists according to the registered flow rate from said flow rate registration unit and the signal from said CO gas leakage determination unit concurrently with said anomaly determination unit, a shutoff unit for shutting off gas supply when said anomaly determination unit or said CO anomaly determination unit determines that an anomaly exists, and a communication unit for reporting appliance information if said appliance estimation unit determines the CO leakage appliance.

11. (canceled)

12. A gas shutoff device for monitoring the use state of a gas appliance connected to piping after passing through a gas meter and limiting the use condition of the gas appliance in accordance with a signal from a CO alarm, said gas shutoff device comprising:
a flow rate detection unit for measuring the gas flow rate, a flow rate computation unit for finding an instantaneous flow rate value from the detection value of said flow rate detection unit, a flow rate storage unit for storing the instantaneous flow rate values found by said flow rate computation unit in association with each other in time series as a flow rate pattern, an average flow rate computation unit for averaging the instantaneous flow rate values found by said flow rate computation unit to find an average flow rate value, a flow rate registration unit for registering the flow rate value when it is determined that the flow rate is the appliance flow rate from the average flow rate value found by said average flow rate computation unit, a CO gas leakage determination unit for making a determination in accordance with a detection signal from the CO alarm and outputting a determination signal responsive to the CO concentration level, an appliance estimation unit for reading the flow rate pattern in said flow rate storage unit, estimating a CO leakage appliance, and outputting a signal for setting the limit value of the continuously usable time in a shortening direction when the appliance flow rate is registered in said flow rate registration unit and said CO gas leakage determination unit outputs the determination signal, an occurrence frequency measurement unit for counting the number of estimation processing times of a CO leakage appliance executed when a CO gas leakage determination signal is output, and issuing a command for executing estimation processing of a CO leakage appliance using a flow rate pattern regardless of whether or not the CO gas leakage determination signal exists when the number of estimation processing times exceeds a predetermined number of times, an appliance flow rate storage unit for storing the data in said flow rate storage unit read by said appliance estimation unit together with the appliance flow rate, an anomaly determination unit for changing the limit value of the continuously usable time of the appliance and determining whether or not an anomaly exists according to the signals from said flow rate registration unit, said appliance estimation unit, and said CO gas leakage determination unit, a shutoff unit for shutting off gas supply when an anomaly occurs, and a communication unit for reporting various pieces of appliance information, said gas shutoff device for
changing a condition when the CO leakage appliance is determined in response to the presence or absence of a signal from said occurrence frequency measurement unit;
executing estimating processing of a CO leakage appliance in response to the determination signal of said CO gas leakage determination unit when a signal from said occurrence frequency measurement unit does not exist;
executing estimating processing of a CO leakage appliance regardless of the determination signal of said CO gas leakage determination unit when a signal from said occurrence frequency measurement unit exists; and
when the CO leakage appliance is determined, executing a monitor mode of limiting the use condition of the appliance and monitoring.

13. The gas shutoff device as claimed in claim 12, wherein said appliance estimation unit executes the monitor mode unconditionally when a CO gas leakage signal is first detected, and stores various pieces of data in said appliance flow rate storage unit.

14. The gas shutoff device as claimed in claim 12 wherein from a first-stage signal where the CO concentration is low to the maximum nth-stage signal where the CO concentration is high, output by said CO gas leakage determination unit,
said appliance estimation unit sets the limit value of the continuously usable time of the appliance in the shortening direction in response to the determination signal output as the CO concentration increases.

15. The gas shutoff device as claimed in claim 12 wherein when the maximum nth-stage determination signal where the CO concentration is high is output from said CO gas leakage determination unit, said appliance estimation unit outputs a signal for closing said shutoff unit through said anomaly determination unit.

16. The gas shutoff device as claimed in claim 12 wherein if the CO leakage appliance repeats use and stop, said appliance estimation unit sets the limit value of the continuously usable time of the appliance in the shortening direction in response to the number of repetitions.

17. (canceled)

18. A gas shutoff device connected to an alarm for monitoring the presence or absence of gas leakage, said gas shutoff device for monitoring the use state of more than one gas appliance and shutting off gas supply when an anomaly occurs, said gas shutoff device comprising a flow rate detection unit for measuring the gas flow rate, a flow rate computation unit for computing the flow rate value from the detection value of said flow rate detection unit, an average flow rate computation unit for averaging the instantaneous flow rate values found by said flow rate computation unit to find an average flow rate value, a flow rate registration unit for registering the flow rate when it is determined that the flow rate is the appliance flow rate from the average flow rate found by said average flow rate computation unit, a gas leakage determination unit for inputting an output signal responsive to the concentration level of gas leakage from the alarm, an anomaly determination unit for monitoring an abnormal state of the use appliance and determining whether or not an anomaly exists according to the flow rate from said average computation unit, the registered flow rate from said flow rate registration unit and the signal from said gas leakage determination unit, a use time adjustment unit, upon reception of an alarm signal responsive to the concentration from the alarm, for changing the use time limit time corresponding to the registered flow rate and outputting to said anomaly determination unit for monitoring, and a shutoff unit for shutting off gas supply when said anomaly determination unit determines that an anomaly exists.

19. A gas shutoff device connected to an alarm for monitoring the presence or absence of gas leakage and transmitting a signal through wireless transmission unit, said gas shutoff device for monitoring the use state of more than one gas appliance and shutting off gas supply when an anomaly occurs, said gas shutoff device comprising a flow rate detection unit for measuring the gas flow rate, a flow rate computation unit for computing the flow rate value from the detection value of said flow rate detection unit, an average flow rate computation unit for averaging the instantaneous flow rate values found by said flow rate computation unit to find an average flow rate value, a flow rate registration unit for registering the flow rate when it is determined that the flow rate is the appliance flow rate from the average flow rate found by said average flow rate computation unit, a gas leakage determination unit for inputting an output signal responsive to the concentration level of gas leakage from the alarm, an anomaly determination unit for monitoring an abnormal state of the use appliance and determining whether or not an anomaly exists according to the flow rate from said average computation unit, the registered flow rate from said flow rate registration unit and the signal from said gas leakage determination unit, a wireless unit for receiving the alarm signal from the alarm, a use time adjustment unit, upon reception of the alarm signal responsive to the concentration from the alarm through said wireless unit, for changing the use time limit time corresponding to the registered flow rate and outputting to said anomaly determination unit for monitoring, and a shutoff unit for shutting off gas supply when said anomaly determination unit determines that an anomaly exists.

20. A gas supply system using the gas shutoff device as claimed in claim 18.

21. An alarm-compatible system meter comprising a communication unit for conducting information communications with at least any one or more alarms of a fire alarm, a gas alarm, and a CO alarm, a gas meter comprising an external communication unit capable of communicating with an external system, an identification unit for identifying a signal of the alarm, and a measure selection unit for selecting a measure by the gas meter in response to the identification result from the identification unit, wherein upon reception of a signal from the CO alarm, the measure selection unit determines the presence or absence of gas use amount and when no gas is used, outputs to the external communication unit for communicating with the external system.

22. The alarm-compatible system meter as claimed in claim 21, wherein upon reception of the signal from the CO alarm, the measure selection unit determines the presence or absence of gas use amount and when no gas is used, outputs a signal for displaying CO occurrence on a customer display.

23. The alarm-compatible system meter as claimed in claim 21, wherein upon reception of the signal from the CO alarm, the measure selection unit determines the presence or absence of gas use amount and when no gas is used, outputs a signal for producing a special notification sound different from an alarm at the anomaly detecting time to at least any one or more alarms of the fire alarm, the gas alarm, and the CO alarm.

24. The alarm-compatible system meter as claimed in claim 21, wherein the measure selection unit outputs installation location information of the alarm contained in the identification result from the identification unit to the external system when a measure is taken.

25. The alarm-compatible system meter as claimed in claim 21, wherein the measure selection unit outputs a signal for displaying the installation location information of the alarm contained in the identification result from the identification unit on the customer display when a measure is taken.

26. The alarm-compatible system meter as claimed in claim 21, wherein the measure selection unit adds appliance installation location information from an appliance comprising a communication unit to a signal to be output when a measure is taken, and outputs.

27. (canceled)
